(19) United States
(12) Patent Application Publication
(10) Pub. No.: US 2025/0315037 A1
(43) Pub. Date: Oct. 9, 2025

(54) AUTOMATED FRAMEWORKS FOR PROGNOSTICS AND HEALTH MANAGEMENT SYSTEM IMPLEMENTATIONS

(71) Applicant: Schlumberger Technology Corporation, Sugar Land, TX (US)

(72) Inventors: Indranil Roychoudhury, Sunnyvale, CA (US); Prasham Sheth, Sunnyvale, CA (US)

(21) Appl. No.: 19/188,882

(22) Filed: Apr. 24, 2025

Related U.S. Application Data
(63) Continuation-in-part of application No. 18/946,097, filed on Nov. 13, 2024.
(63) Continuation-in-part of application No. 19/073,499, filed on Mar. 7, 2025.
(63) Continuation-in-part of application No. 19/170,560, filed on Apr. 4, 2025.
(63) Continuation-in-part of application No. 19/170,428, filed on Apr. 4, 2025.
(63) Continuation-in-part of application No. 18/946,435, filed on Nov. 13, 2024.
(60) Provisional application No. 63/574,689, filed on Apr. 4, 2024.
(60) Provisional application No. 63/574,942, filed on Apr. 5, 2024.

(51) Int. Cl. G05B 23/02; G06N 3/045

(52) U.S. Cl. CPC G05B 23/0254; G05B 23/0283; G06N 3/045

(57) ABSTRACT

Certain aspects of the disclosure provide systems and methods for AutoPHM. A method includes receiving system of interest data associated with an system of interest to generate a simulation model output; receiving system of interest production data from a production SOI to generate an anomaly detection model output; receiving at least one of the simulation model output, the system of interest production data, a hypothesized future input, or the anomaly detection model output to generate an estimated future output; and determining, a remaining useful life prediction of the production system of interest based on the estimated future output.

### CROSS-REFERENCE TO RELATED APPLICATIONS

This Application is a continuation-in-part under 35 U.S.C. § 120 of U.S. patent application Ser. No. 18/946,097 (referred to herein as Application A), Titled “UNIFIED HYBRID MODELING TOOL FOR SYSTEMS OF INTEREST” filed on Nov. 13, 2024, the entire contents of which are hereby incorporated by reference.

This Application is a continuation-in-part under 35 U.S.C. § 120 of U.S. patent application Ser. No. 19/073,499 (referred to herein as Application B), titled “AUTONOMOUS GENERATION OF ANOMALY DETECTION MODELS”, filed on Mar. 7, 2025, the entire contents of which are hereby incorporated by reference.

This Application is a continuation-in-part under 35 U.S.C. § 120 of U.S. patent application Ser. No. 19/170,560 (referred to herein as Application C), titled “ROBUST ONLINE AND OFFLINE ADAPTATION OF PRE-TRAINED MODELS TO UNSEEN FIELD DATA” filed on Apr. 4, 2025, which claims the benefit of and priority to U.S. Provisional Patent Application No. 63/574,689, titled “ROBUST ONLINE AND OFFLINE ADAPTATION OF PRE-TRAINED MODELS TO UNSEEN FIELD DATA” filed on Apr. 4, 2024, the entire contents of which are hereby incorporated by reference.

This Application is a continuation-in-part under 35 U.S.C. § 120 of U.S. patent application Ser. No. 19/170,428 (referred to herein as Application D), titled “ROBUST REMAINING USEFUL LIFE ESTIMATION BASED ON ADAPTIVE SYSTEM REPRESENTATION USING JACOBIAN FEATURE ADAPTATION”, filed on Apr. 4, 2025, which claims the benefit of and priority to U.S. Provisional Patent Application No. 63/574,942, titled “ROBUST REMAINING USEFUL LIFE ESTIMATION BASED ON ADAPTIVE SYSTEM REPRESENTATION USING JACOBIAN FEATURE ADAPTATION” filed on Apr. 5, 2024, the entire contents of which are hereby incorporated by reference.

This Application is a continuation-in-part under 35 U.S.C. § 120 of U.S. patent application Ser. No. 18/946,435 (referred to herein as Application E), titled “SYSTEMS AND METHODS FOR EVALUATING REMAINING USEFUL LIFE PREDICTION ALGORITHMS” filed on Nov. 13, 2024, the entire contents of which are hereby incorporated by reference.

### BACKGROUND

### Field

Aspects of the present disclosure relate to an end-to-end generalizable and automated prognostics and health management (AutoPHM) framework for automating the implementation of end-to-end prognostics and health management (PHM) systems.

### Description of Related Art

PHM is an advanced approach to minimize maintenance costs while maximizing operational availability, life, and utilization of critical systems. PHM may utilize, for example, sensor data and analysis algorithms to detect anomalies, diagnose faults that cause anomalies, and compute a probability distribution of time to failure. By considering this failure distribution alongside operational constraints and system objectives, maintenance activities can be planned to achieve the best balance of cost and utilization. PHM can be challenging to implement with consistent and reliable results. PHM systems utilizing system models can be complex, slow in execution, and difficult to calibrate, meanwhile those utilizing machine learning (ML) based models can be unreliable due to their heavy dependence on the quality of training data.

ML models and system models represent two distinct approaches to understanding and predicting systems and phenomena, especially in fields like science, engineering, and economics. ML models are primarily data-driven, learning patterns from large datasets without requiring a predefined understanding of the underlying systems. They exhibit flexibility, capable of adapting to complex, and nonlinear relationships, making them well-suited for high-dimensional data. Common types of ML include supervised techniques, unsupervised techniques, and reinforcement learning.

System models are grounded in established scientific principles and equations that explain how the underlying systems that they model operate. These models incorporate physical laws, biological processes, or economic theories, such as differential equations in physics or population dynamics in biology. They offer a high level of predictability, revealing how changes in one part of the system can affect other components based on the underlying mechanisms. Because they are built on known principles, system models are generally more interpretable and easier to explain than ML models that may tend to act like difficult to interpret black boxes. System models are based on fundamental laws of natural sciences, including physical and biochemical principles. For example, an atmospheric model may incorporate scientific principles on the chemical reactions of gases in the atmosphere.

Hybrid modeling refers to the combination of ML models and system models to leverage the strengths of each approach. By integrating data-driven techniques with theory-based frameworks, hybrid models can provide more robust predictions and deeper insights into complex systems. Hybrid modeling is well-suited for the simulation of complex physical processes utilizing relatively simple model structures and low computational complexity.

### SUMMARY

One aspect provides a method for end-to-end PHM, the method comprising receiving by a simulation model (SM) associated with a system of interest (SOI), SOI data associated with the SOI to generate an SM output; receiving by an anomaly detection (AD) model, SOI production data from a production SOI to generate an AD model output; receiving by an adapted simulation (AS) model, at least one of the SM output, the SOI production data from the production SOI, a hypothesized future input, or the AD model output from the AD model to generate an estimated future output; and determining, by a remaining useful life (RUL) model, an RUL prediction of the production SOI based on the estimated future output.

Another aspect provides a method for end-to-end PHM, comprising receiving SOI data associated with an SOI to generate a SM output; receiving SOI production data from a production SOI to generate an AD model output; receiving at least one of the SM output, the SOI production data, a hypothesized future input, or the AD model output to generate an estimated future output; and determining, an RUL prediction of the production SOI based on the estimated future output.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects and are therefore not to be considered limiting of the scope of this disclosure.

### Application A Figures

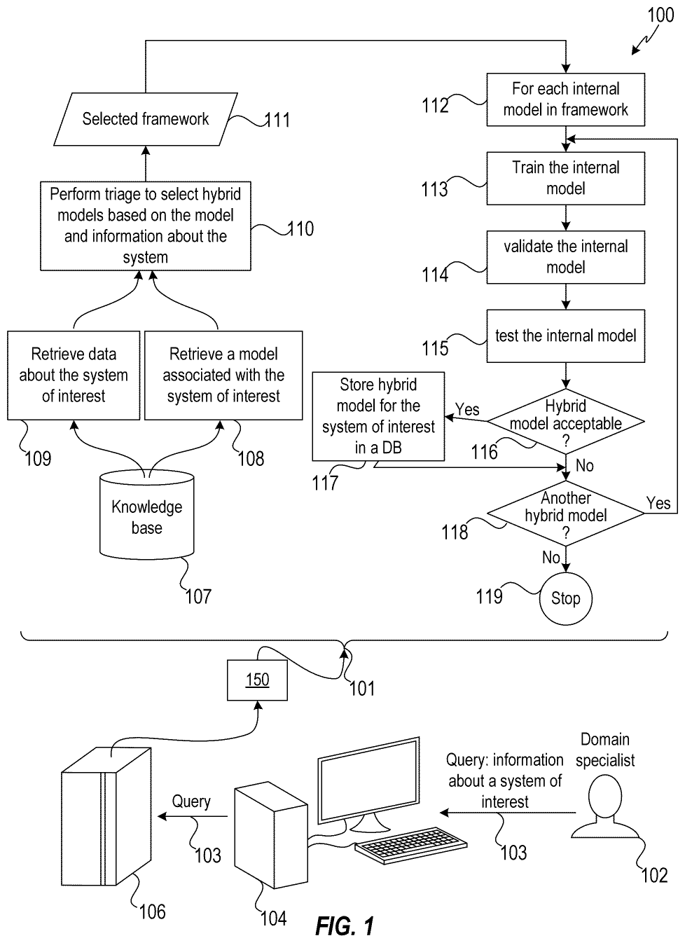

FIG. 1 depicts an example system deploying a hybrid modeling tool.

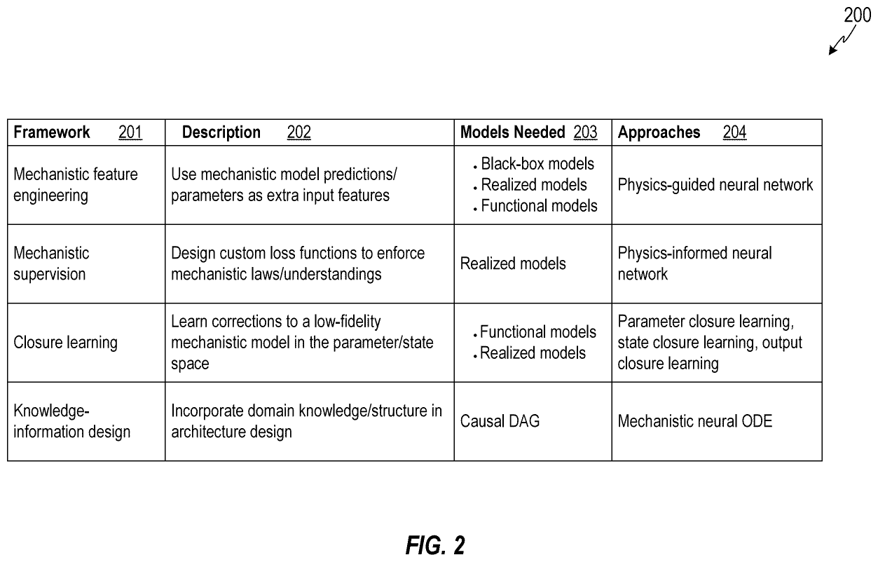

FIG. 2 depicts an example table detailing types of frameworks to generate hybrid models.

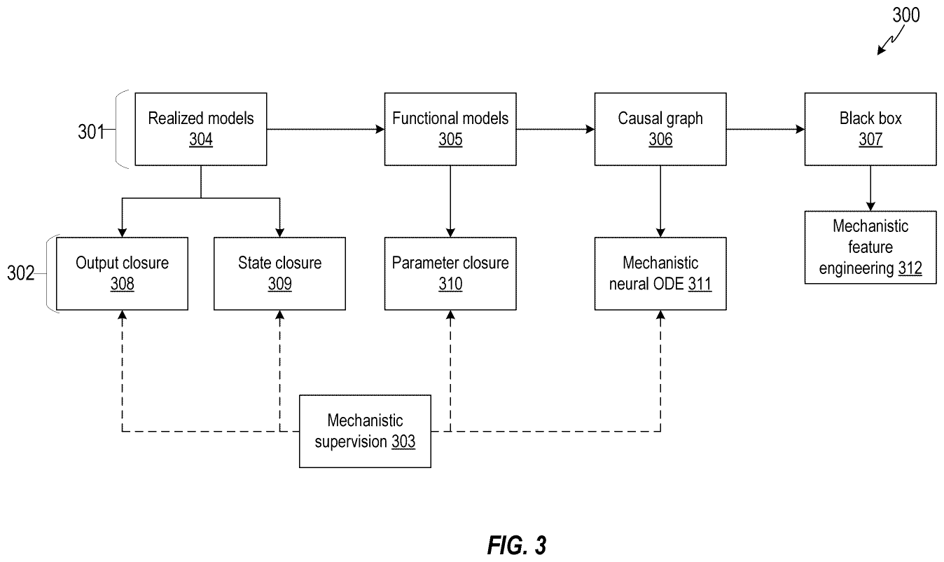

FIG. 3 depicts an example triage process of the modeling tool.

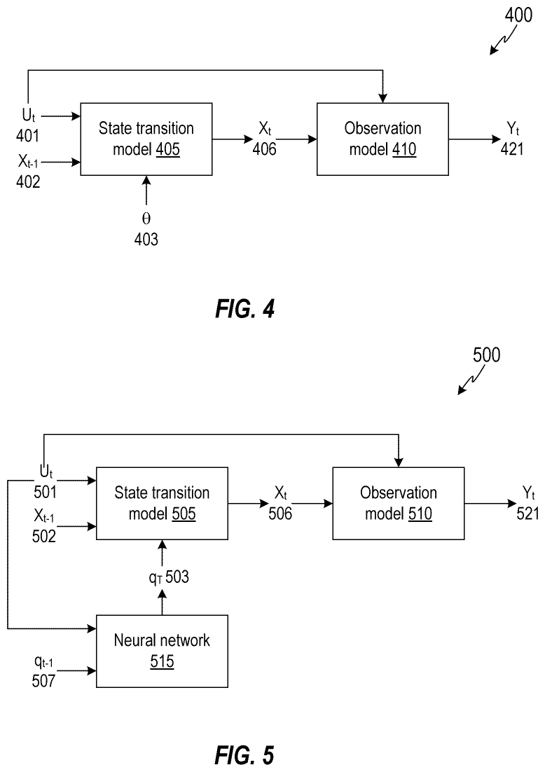

FIG. 4 depicts an example architecture of a discrete time state-space model.

FIG. 5 depicts an example architecture of a parameter closure learning framework.

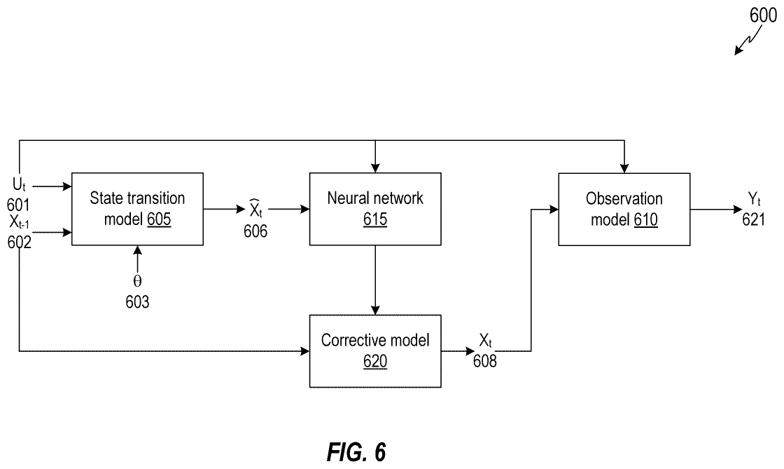

FIG. 6 depicts an example architecture of a state closure learning framework.

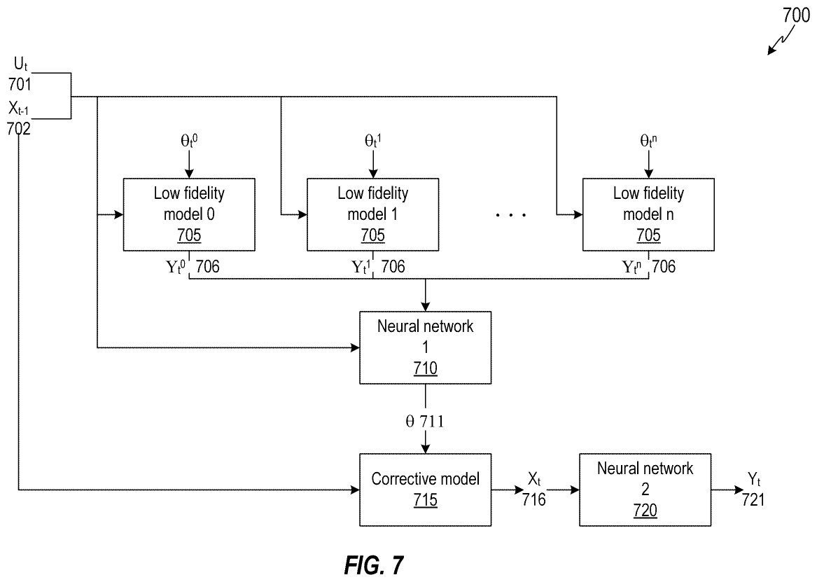

FIG. 7 depicts an example architecture of an output closure learning framework.

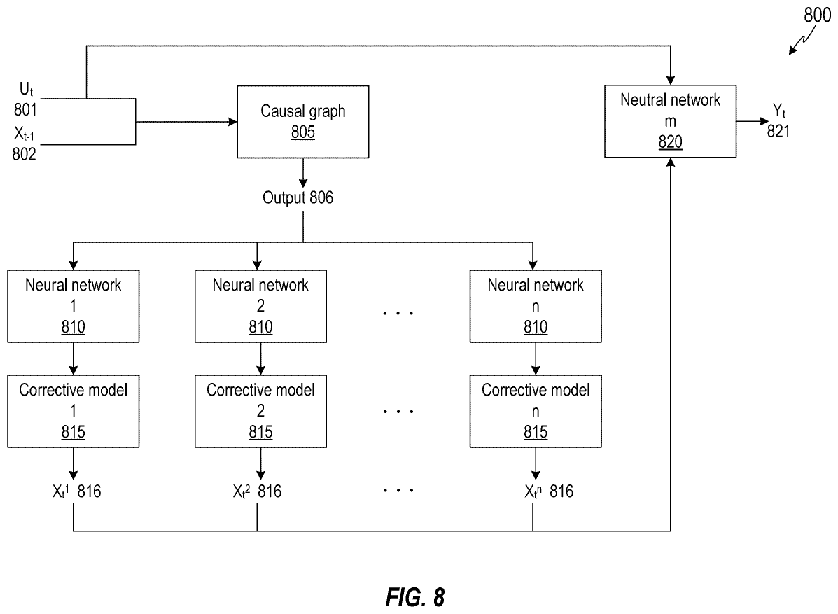

FIG. 8 depicts an example architecture for a mechanistic neural ordinary differential equation (ODE) framework.

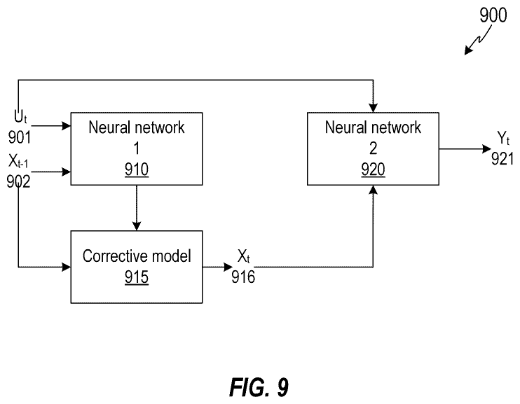

FIG. 9 depicts an example black-box neural ODE framework.

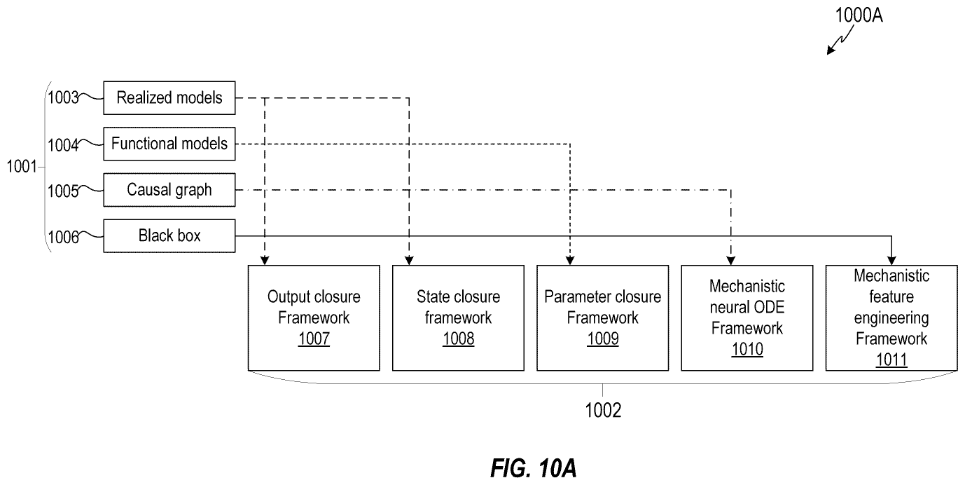

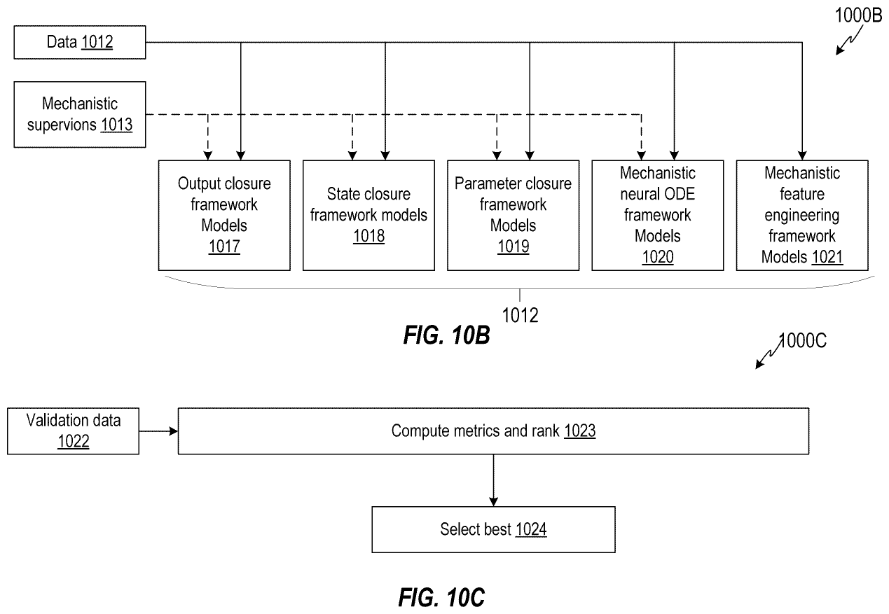

FIG. 10A depicts an example triage process for hybrid modeling by the hybrid modeling tool.

FIG. 10B depicts an example training process for hybrid modeling by the hybrid modeling tool.

FIG. 10C depicts example model ranking process for hybrid modeling by the hybrid modeling tool.

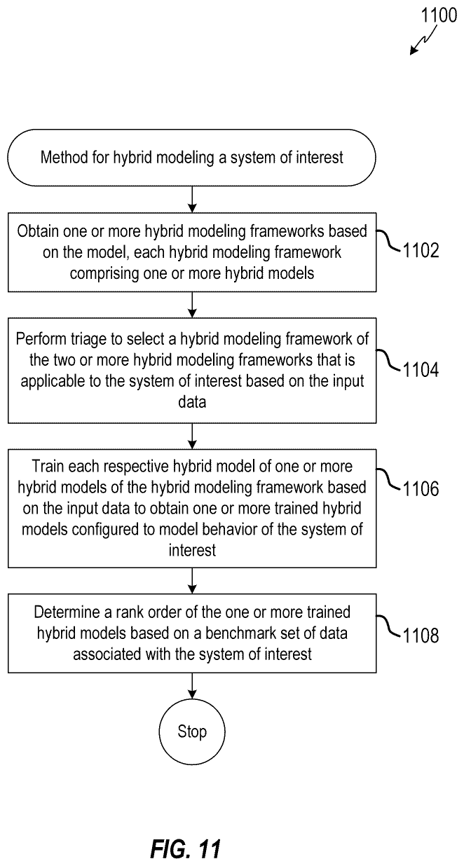

FIG. 11 depicts an example of a method performed by a processing system.

### Application B Figures

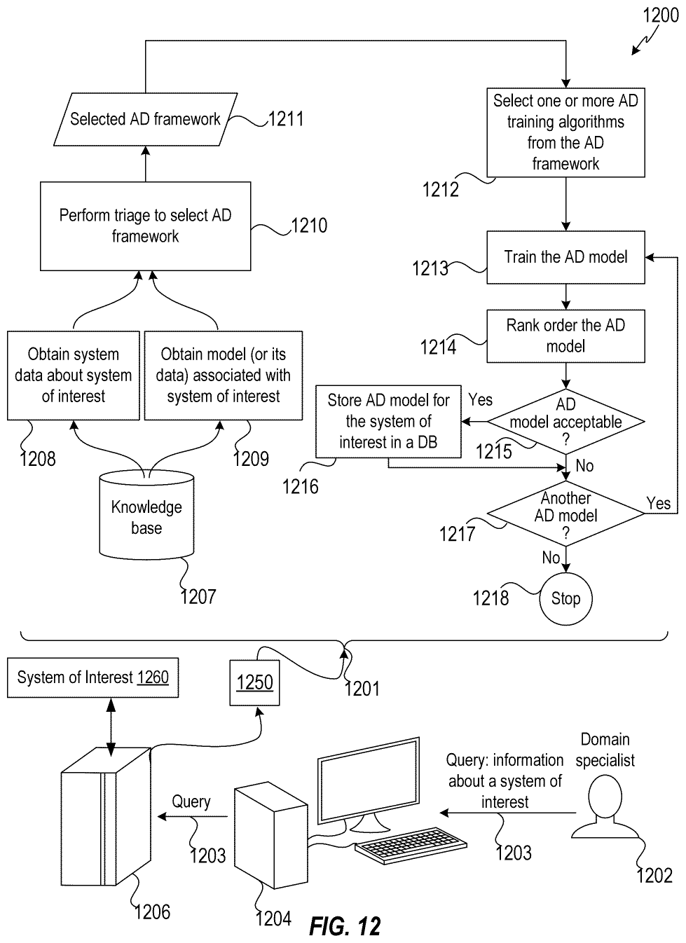

FIG. 12 depicts an example system deploying an anomaly detection (AD) modeling tool.

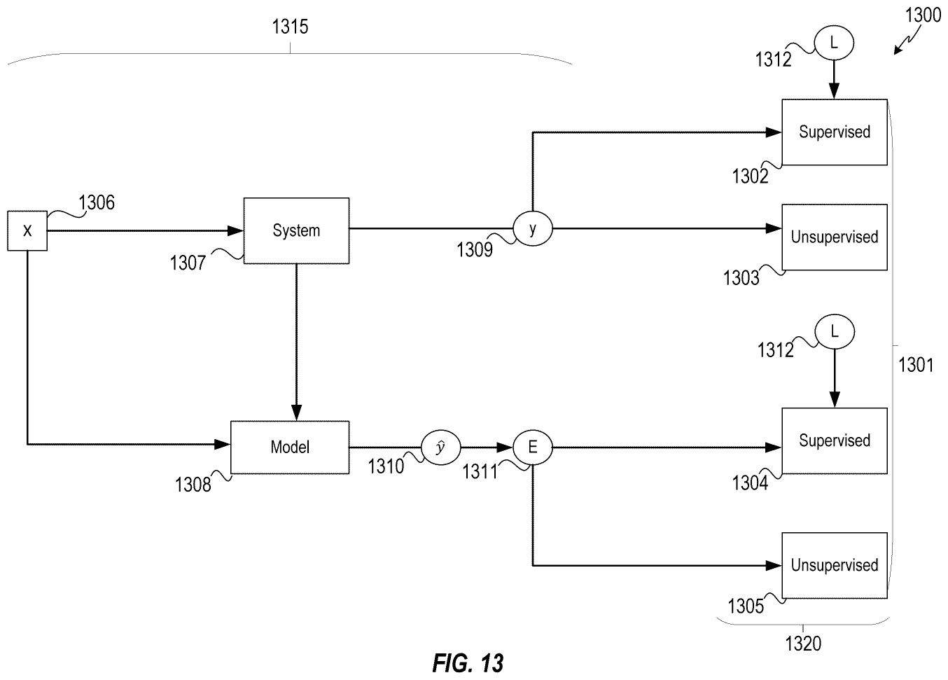

FIG. 13 depicts an example triage process of the AD modeling tool.

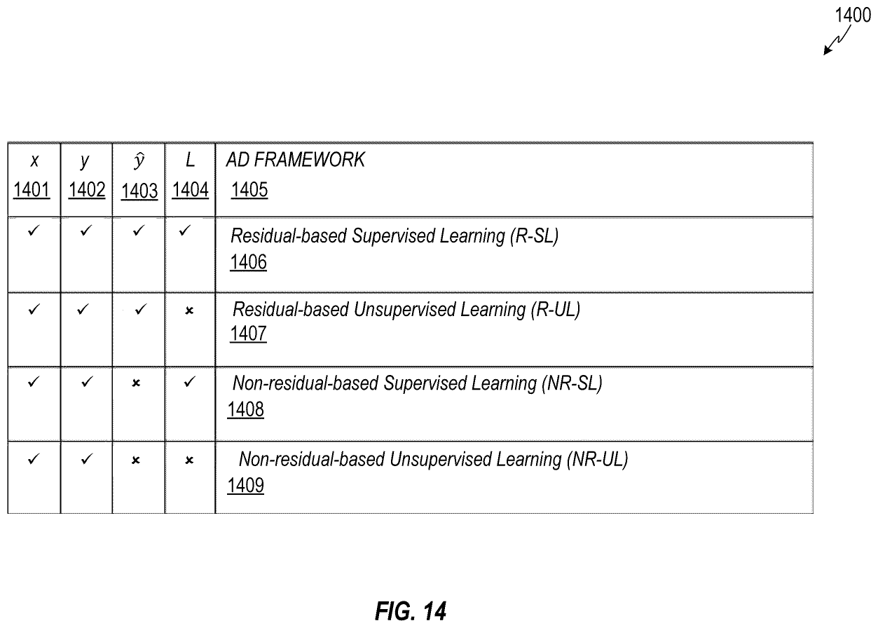

FIG. 14 depicts an example table illustrating the ruleset for how data types are used to perform triage.

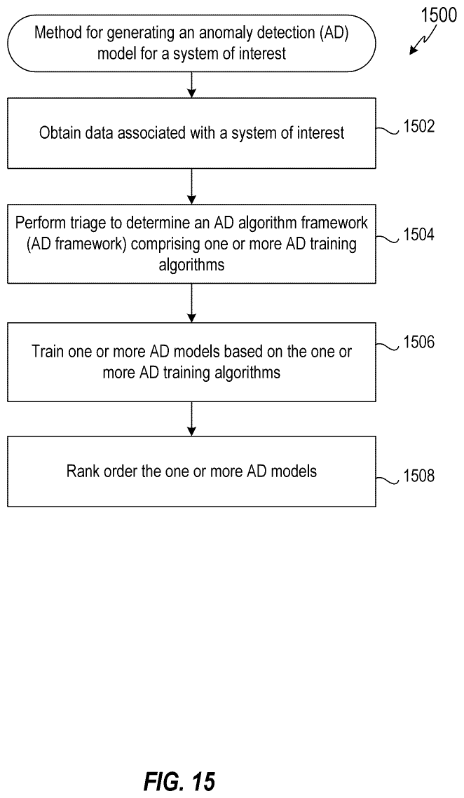

FIG. 15 depicts an example method for generating anomaly detection models.

### Application C, D & E Joint Figures

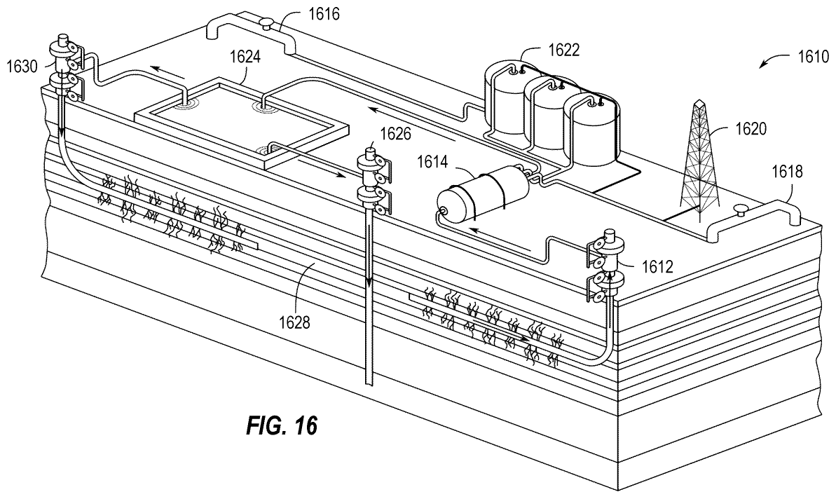

FIG. 16 depicts an example oil and gas production system.

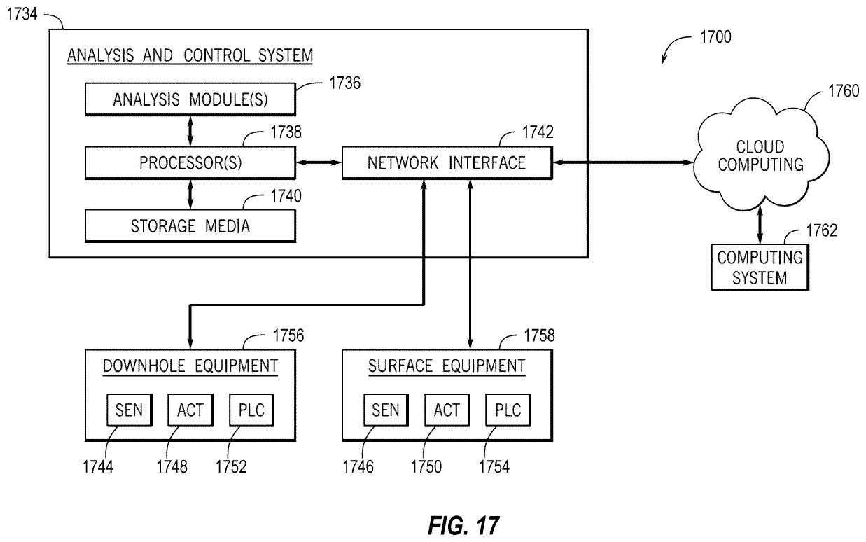

FIG. 17 depicts a production control system configured to control the oil and gas production system of FIG. 16.

### Application C Figures

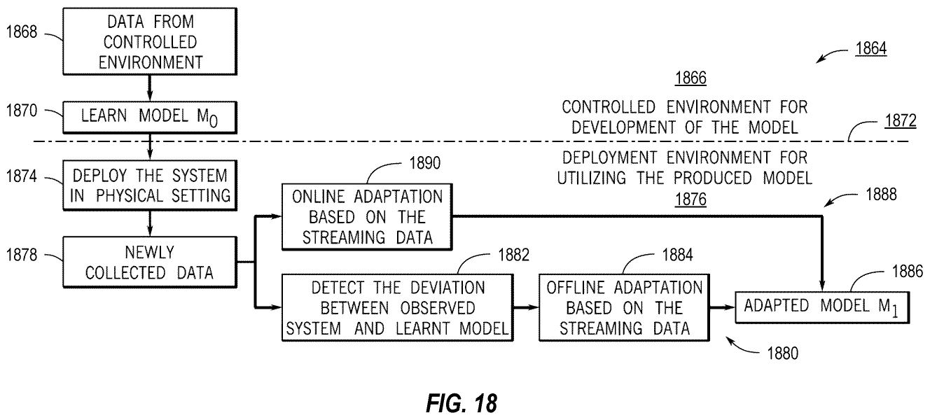

FIG. 18 depicts an example flow chart of a workflow describing how an adaptation technique can adapt a model that is trained/learned in a controlled setting to keep and always align with the system's actual behavior.

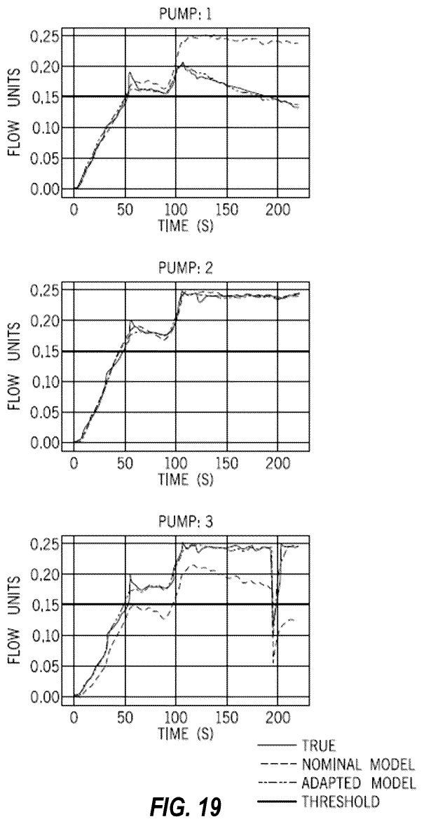

FIG. 19 depicts an example of results from offline adaptation of a recurrent neural network (RNN).

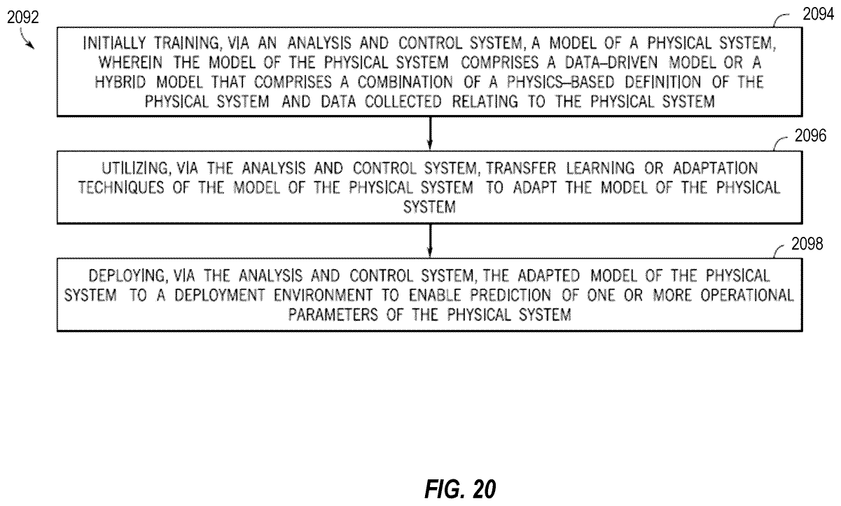

FIG. 20 depicts a flow diagram of a method for adapting models of physical systems using transfer learning or adaptation techniques (e.g., Jacobian Feature Regression) in both online and offline modes.

### Application D Figures

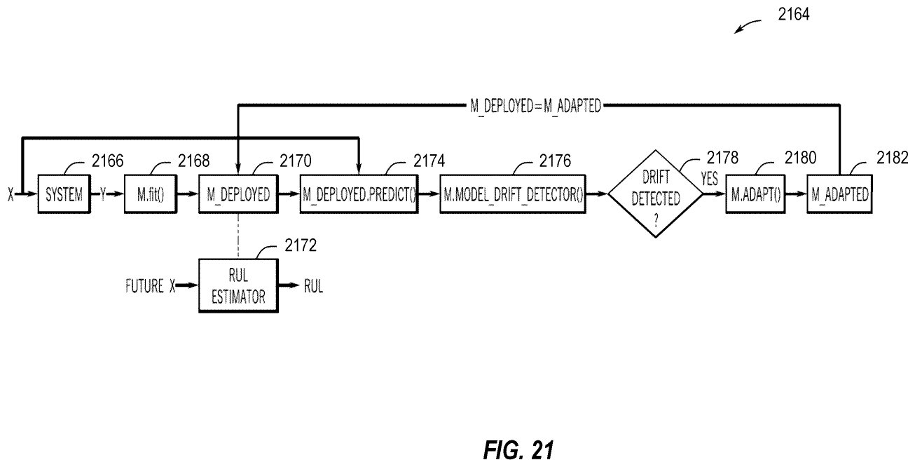

FIG. 21 depicts a workflow describing how an adaptation technique can adapt a model that is trained/learned in a controlled setting to predict RUL of equipment.

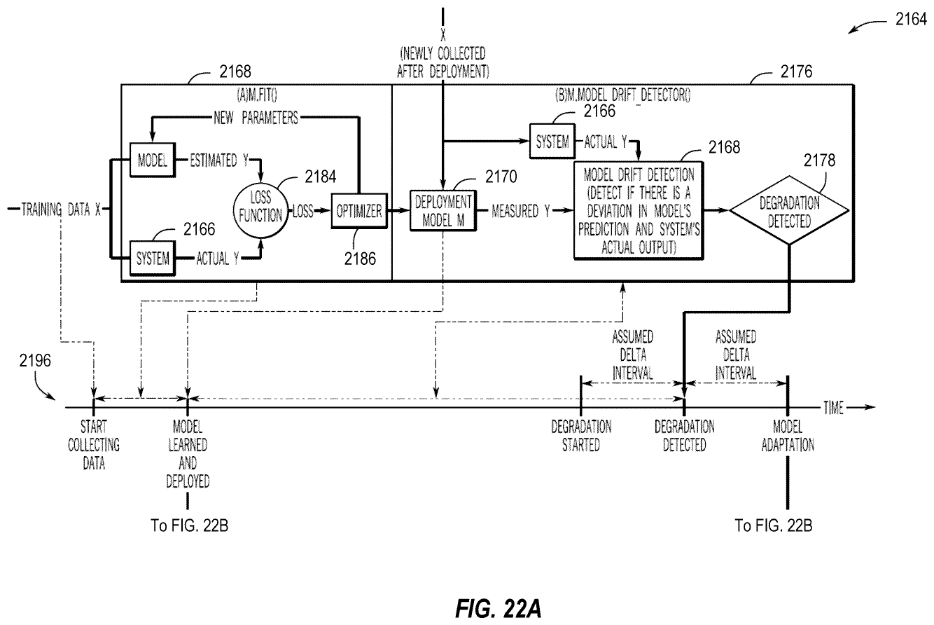

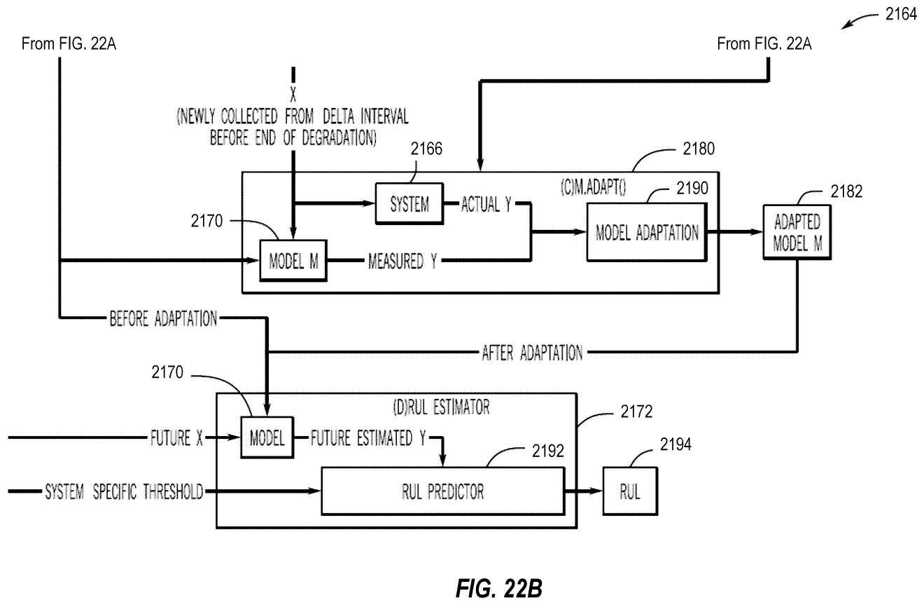

FIGS. 22A and 22B depict more algorithmic details of the M.fit( ), M.model_drift_detector( ), M.adapt( ), and RUL Estimator blocks of the workflow of FIG. 21.

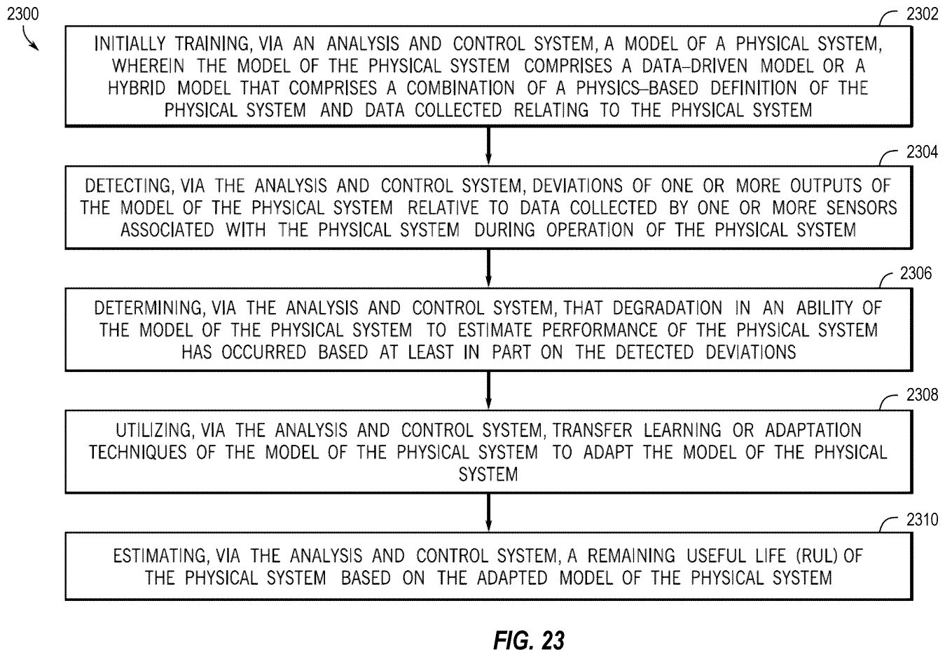

FIG. 23 depicts a flow diagram of a method for estimating an RUL of a physical system based on adaptive system representation.

### Application E Figures

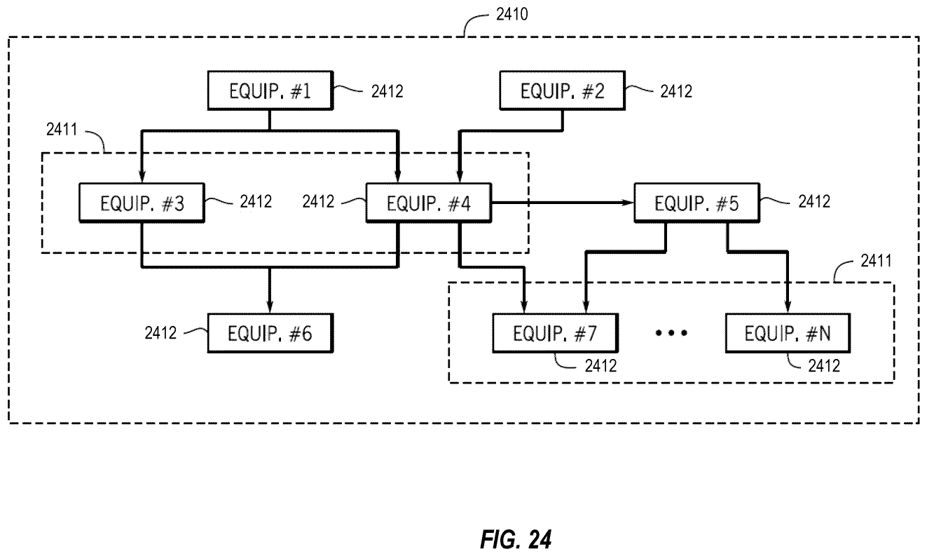

FIG. 24 depicts an example system having a plurality of different pieces of equipment that may be utilized to accomplish the specific functions of the system.

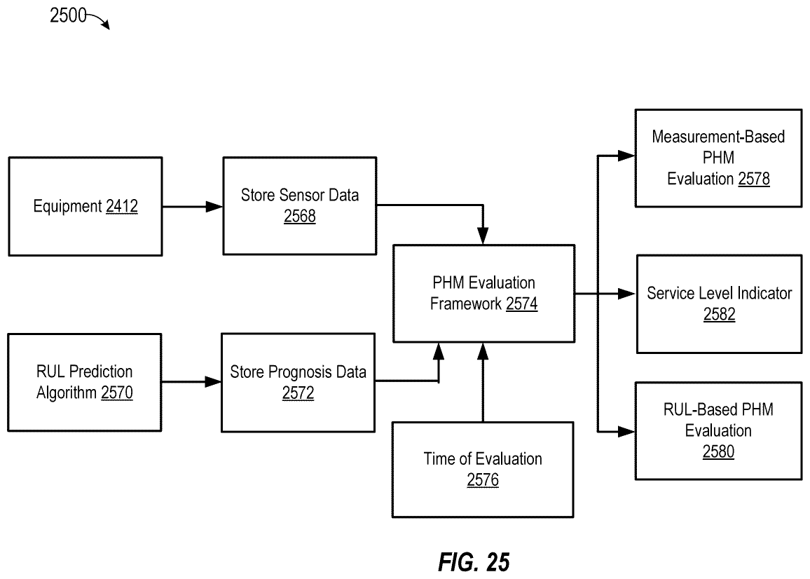

FIG. 25 depicts a workflow for predicting RUL of equipment as well as evaluating the accuracy of the RUL prediction.

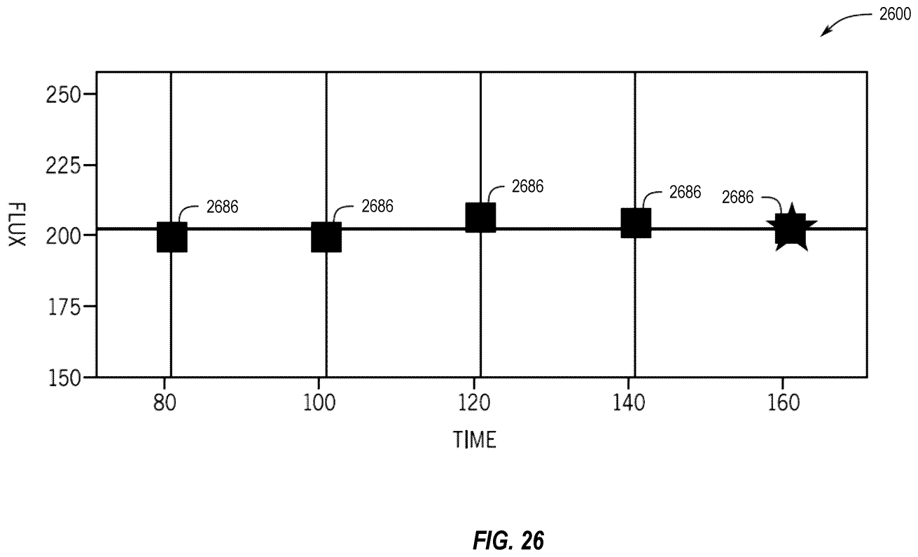

FIG. 26 depicts a graph of example results of a measurement-based PHM performance evaluation.

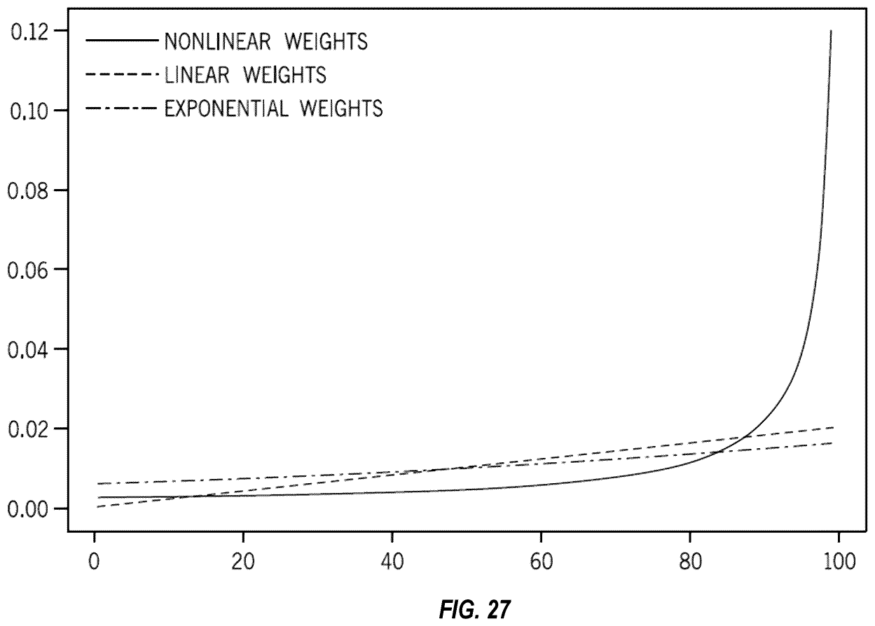

FIG. 27 depicts example weighting functions.

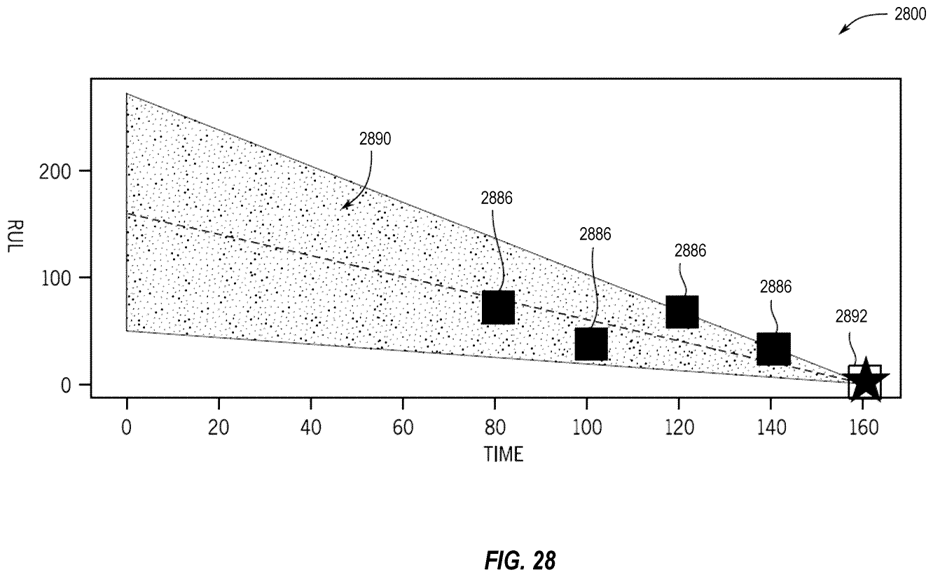

FIG. 28 depicts a graph of example results of an RUL-based PHM evaluation.

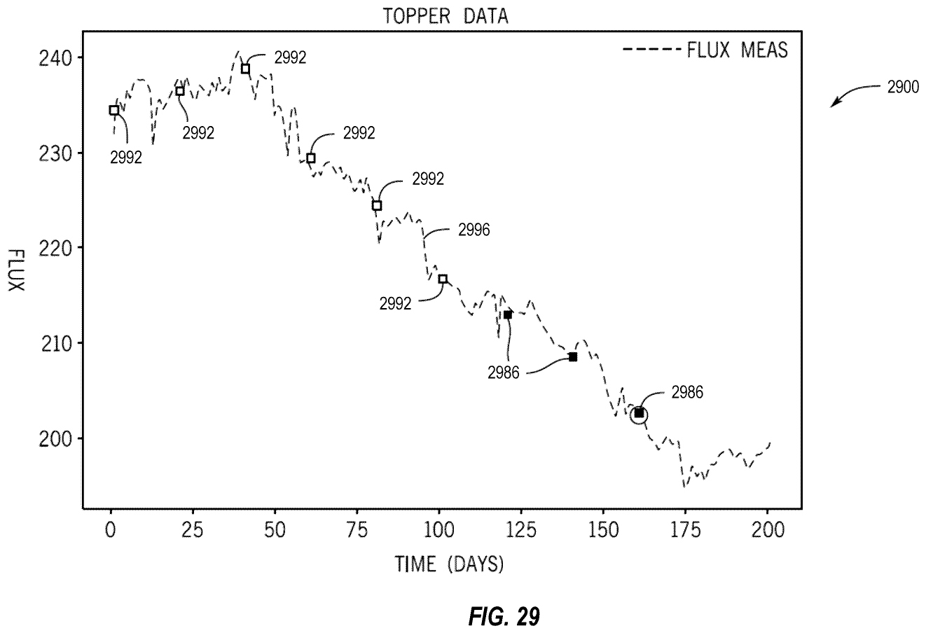

FIG. 29 depicts a graph of example results of how measured values at a plurality of time steps correlate to evaluation verdicts at the time steps.

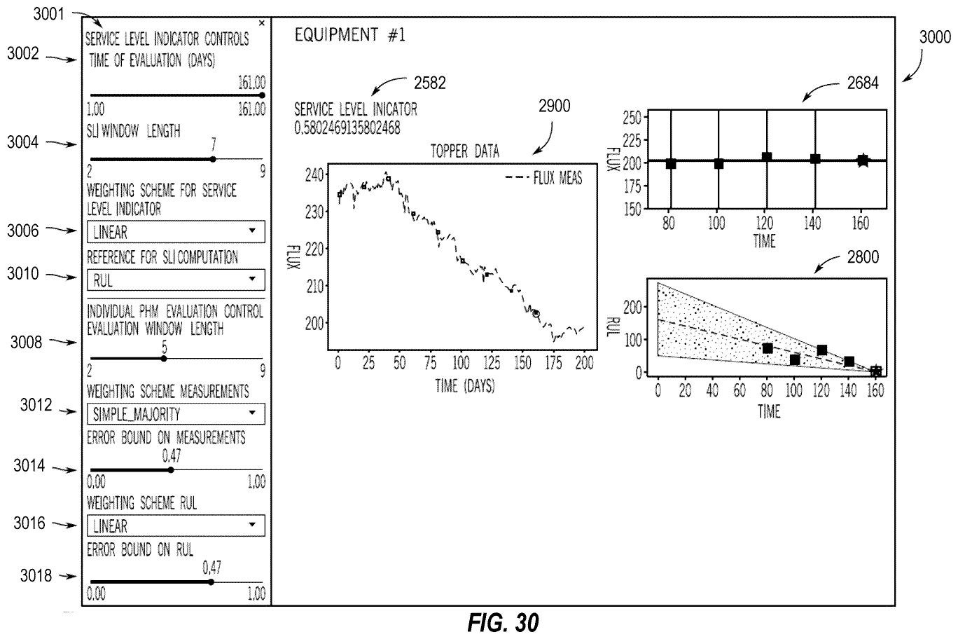

FIG. 30 depicts an example of a graphical user interface used to provide a dashboard of relevant graphs and metrics relating to the outputs illustrated in FIGS. 26, 28, and 29.

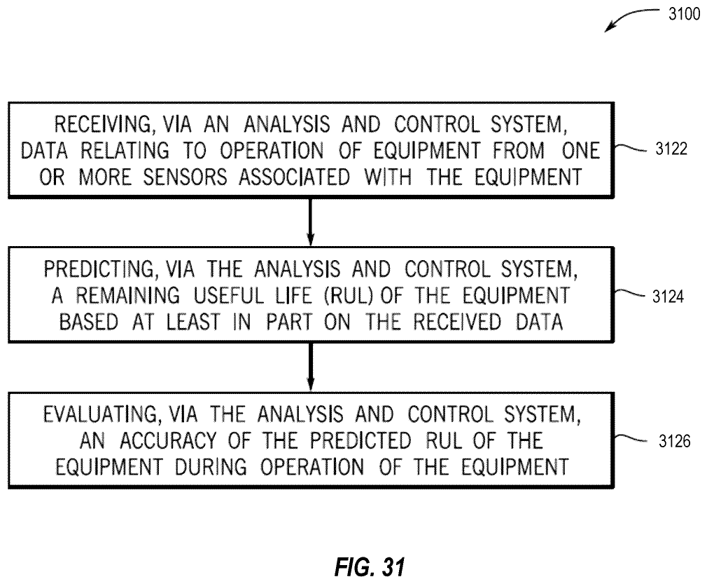

FIG. 31 depicts a flow diagram of a method for predicting RUL of equipment and evaluating the accuracy of the RUL prediction.

### Present Application Figures

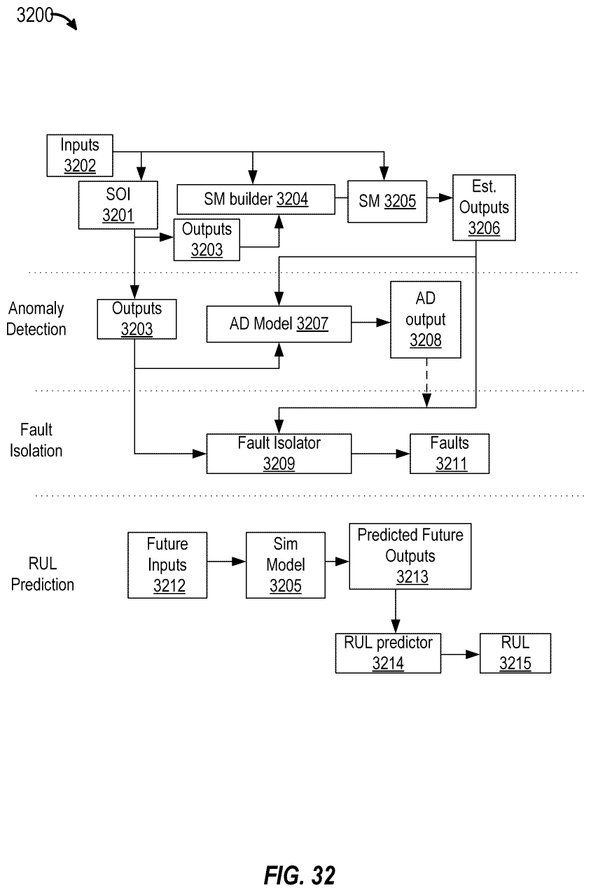

FIG. 32 depicts an example PHM system.

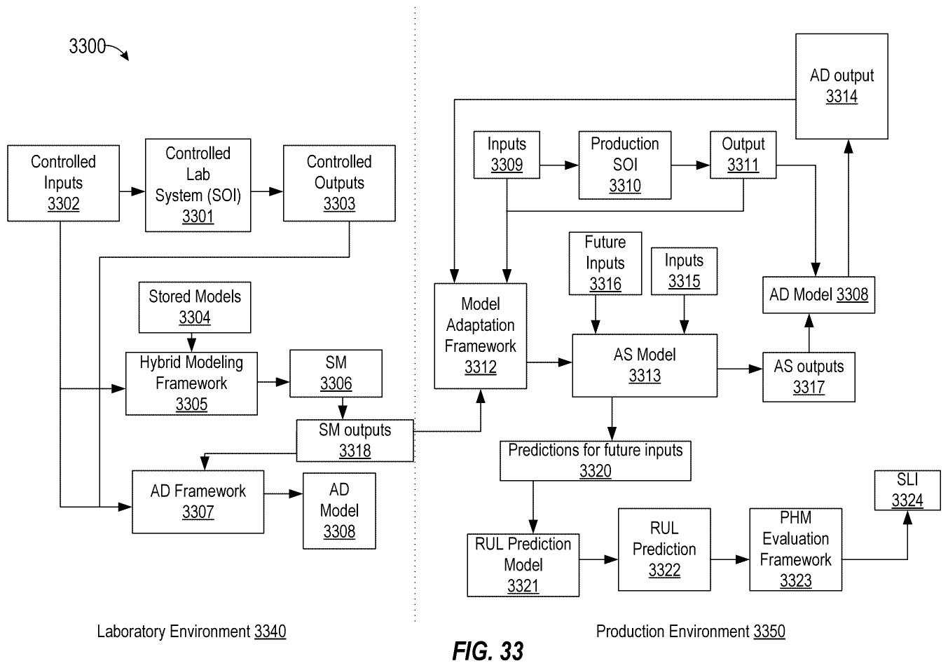

FIG. 33. depicts an example architecture of an AutoPHM framework for PHM systems.

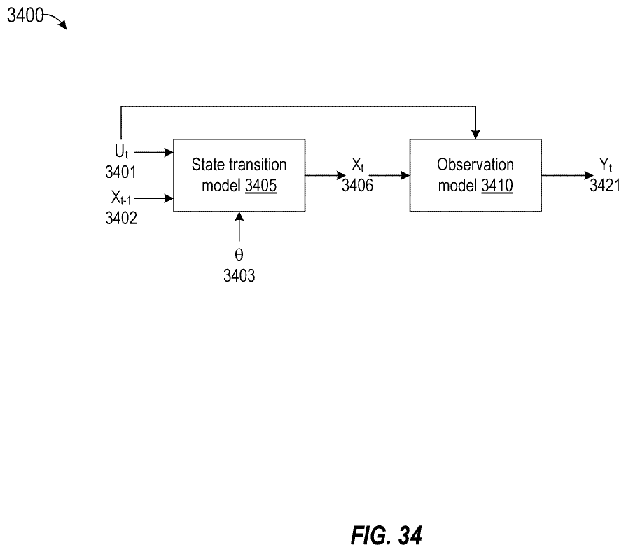

FIG. 34 depicts an example architecture of a discrete time state-space hybrid model that may be used by the AutoPHM framework.

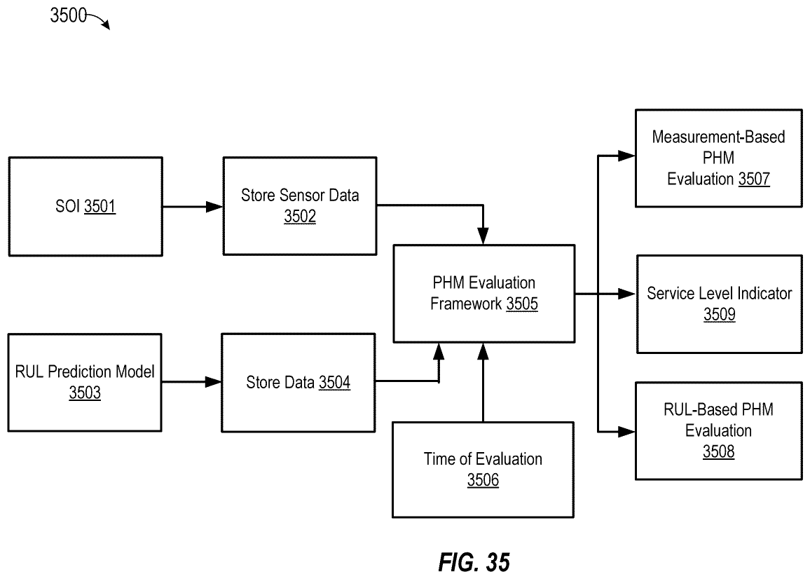

FIG. 35 depicts an example of a workflow for evaluating an RUL prediction model by a PHM evaluation algorithm.

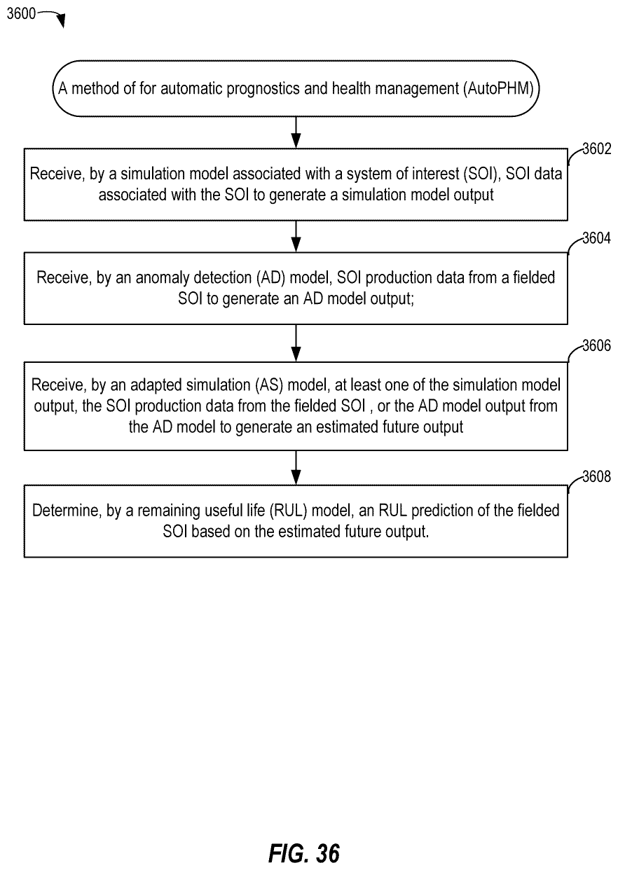

FIG. 36 depicts an example method for end-to-end PHM based on an AutoPHM framework.

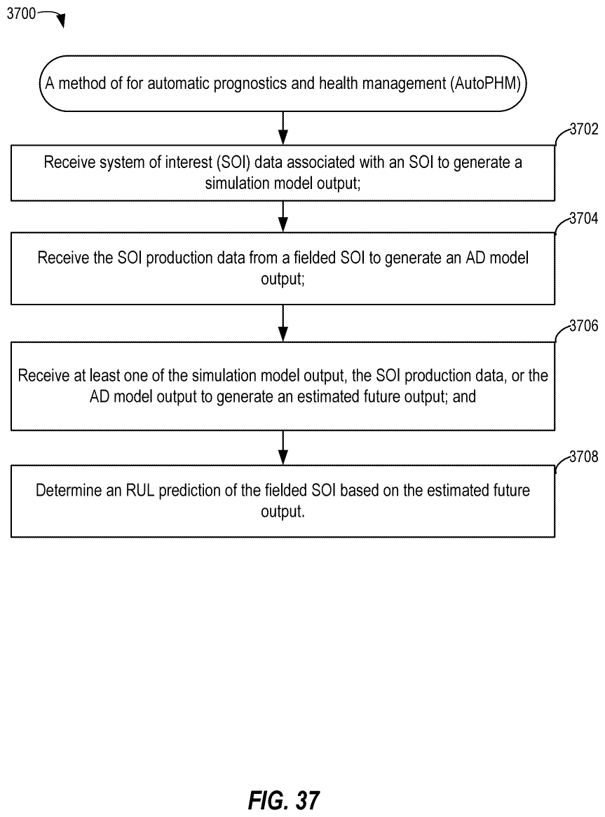

FIG. 37 depicts another example method for end-to-end PHM based on an AutoPHM framework.

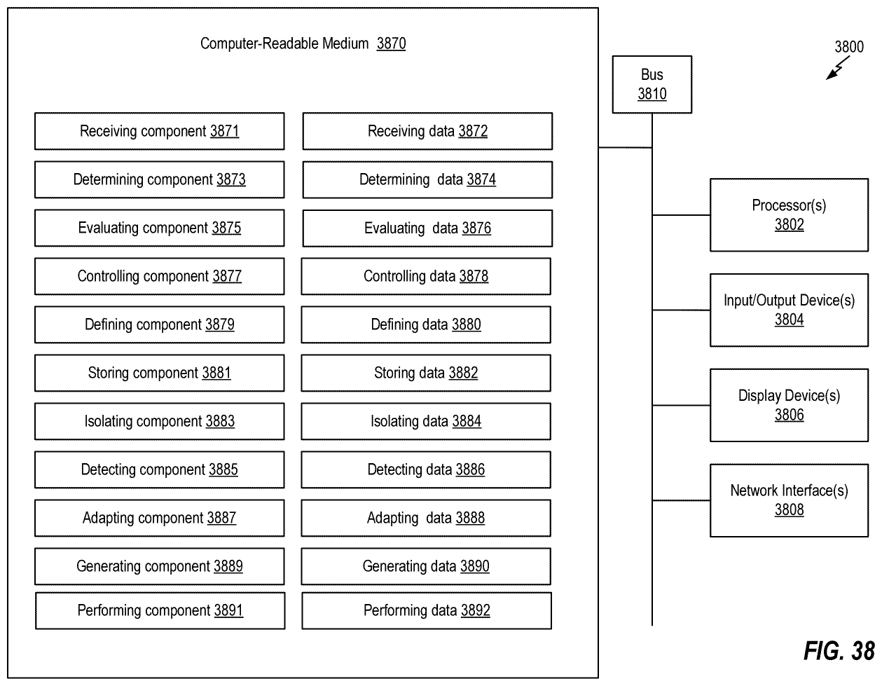

FIG. 38 depicts an example processing system with which aspects of the present disclosure and those of Applications A-E can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

### Detailed Description of Application A

Aspects of the disclosure of Application A provide apparatuses, methods, processing systems, and computer-readable mediums for a hybrid modeling tool for autonomously building, training and testing hybrid models.

ML models are generally data-driven, which means the validity of the outputs heavily depend on the validity of the inputs used. ML models therefore cannot guarantee the scientific validity of their outputs, which rely heavily on the validity of their inputs.

System models (e.g., mechanistic or scientific models) rely on the underlying theories related to the system of concern. A system model aims to mimic a system through its assumptions on the underlying mechanisms of the system. This may involve constructing mathematical formulations representing those physical systems and determining whether the input or output behaviors of the model is consistent with experimental or scientific data. System models are therefore generally specific to a domain or physical system making them inflexible in their application. Due to their complexity, system models tend to be compute resource intensive.

Industries in different fields utilize different underlying systems. For example, in healthcare, anatomical and biochemical systems may be of most concern. In the oil and gas industry it may be that reservoir and seismic systems are the most relevant. System models may exist for a particular physical system, but these models are generally inflexible and may rely on the availability of domain experts for their use. Hybrid models that combine the benefits of ML models with system models may be created specifically for each system or industry. However, creating each hybrid model on a bespoke basis is time consuming and computationally resource intensive. Furthermore, without a common framework, generated hybrid models may vary in their validity and reliability.

Aspects described herein present a hybrid modeling tool that provides a streamlined and automated process of building, training, and testing hybrid models. The modeling tool may utilize a discrete-time state-space modeling framework that may be deploy various models of various types as a hybrid model to be readily applied to any dynamical system of interest (e.g., a physical system) given a set of inductive biases. A technical benefit of the hybrid modeling tool is the ability to generate hybrid models that utilize expressions of ML techniques, inductive bias from system models, and signals from underlying data to arrive at a hybrid model for a physical system of interest.

Generating hybrid models may involve multiple computational demands across development, integration, validation, and performance evaluation stages. For example, at the model development stage, selecting the appropriate algorithms for each component of the hybrid model often involves testing several models. This can require substantial computational resources for simulations and evaluations. Additionally, the process of optimizing parameters for different model components typically requires numerous iterations, which can be computationally expensive.

The aspects described herein provide modeling tools and processes for autonomous hybrid model generation that may be applied to a wide range of systems, and which beneficially reduce compute resource usage compared to manually generating hybrid models. For example, the modeling tool may autonomously classify hybrid modeling algorithms into various frameworks, and may automatically perform processes to select the types of algorithms and models to utilize in the generated hybrid model based on the data available. For example, the modeling tools and processes described utilize a specialized triage process that autonomously selects from several types of hybrid modeling framework(s) (referred to herein as framework(s)) based on underlying system model(s) and input data to generate hybrid model(s). The triage process to select the framework(s) reduces the amount of testing that may be expended and reduces computational resources dedicated for simulations and evaluations.

In certain aspects of hybrid modeling, an integration phase may attempt to ensure that different model components work together. This phase may require additional computations and processing to align data formats, scales, and structures. There may also be multiple rounds of simulations to understand how the various components of the models interact with each round of simulation, this also being computationally resource intensive (e.g., requiring a high amount of compute and memory). Therefore, generating new hybrid models may include an integration phase that relies on computationally intensive processes, which makes custom bespoke hybrid model generation for each type of industry or system difficult.

The modeling tool described herein and its associated processes rely on pre-designed model combinations that may be applied in various contexts based on specific hybrid modeling framework(s). The hybrid modeling tool therefore provides for components of model combinations that are known to be integrate well with each other, reducing any processing or computations to determine integration of models together.

In certain aspects, implementation of hybrids models may also present challenges. For example, using multiple software packages to build and test a hybrid model, may present high computational overhead from data transfers and compatibility synchronizations that adds both computational resource use and computational time.

The use of a unified modeling tool to build and test hybrid models reduces overhead from data transfers or data transformations between different software packages or tools. A unified modeling tool therefore simplifies the process and reduces computational time and computational resources in generating hybrid models.

### Example Hybrid Modeling Tool Systems and Processes

FIG. 1 depicts an example system 100 deploying a hybrid modeling tool 150 (modeling tool 150) that can execute a modeling tool process 101. The modeling tool 150 may be software-based, and may be comprised of any one or more of applications, applets, integrated developmental environments, software libraries, data sources and the like. The system 100 may include a user device 104, which may be any sort of computing device, including desktop, tablet, and mobile computing devices. The user device 104 may contain or be connected to a display. A user 102, e.g., a domain specialist, may input a query 103 into the user device 104. For example, the user device 104 may display a user interface (UI) that enables the user 102 to input data. For example, the query 103 may initiate the modeling tool process 101. In some aspects, the query 103 may be information or input data about a system of interest. For example, the user 102 may select, e.g., on a user interface (UI), a specific system or type of system, e.g., a system of interest, to model with the modeling tool process 101.

The query 103 is sent to a server system 106. The server system 106 may be a single server, a combination of servers, mainframe, an on-premises server system, a cloud-based server system, an OS type of server or other specialized server(s) (e.g., virtual servers). In some aspects, the server system 106 triggers the modeling tool 150 to initiate the modeling tool process 101. The modeling tool process 101 may include obtaining data from a knowledge base 107, which may comprise any type of a centralized repository of information, e.g., internal organizational databases or documentation platforms.

At 108 the modeling tool process 101 includes obtaining a system model associated with the system of interest. The system model may represent the system of interest for which a hybrid model is to be generated. For example, the system model may include representations of a physical system of interest with equations. The system model may be of various levels of abstraction, including black-box models, causal-directed acyclic graphs, functional models, and realized models (in order from highest level of abstraction to lowest level of abstraction). In some aspects, the system model at 108 is selected by the user 102 or is otherwise triggered by the query 103. The system model retrieved at 108 may be a mechanistic model, statistical model, a physical environmental model, physics model, or other scientific model.

The modeling tool 150 can also obtain data at 109 (e.g., input data) about the system of interest from the knowledge base 107. The modeling tool 150 may also obtain data about the system of interest from a user input, e.g., from the query 103, or from the knowledge base 107 based on the user input. For example, if the system of interest was a natural gas reservoir, then the data may include chemical reaction modeling data. The data obtained at 109 may be based on official data, e.g., organizational or governmental published data. In some aspects, 108 or 109 may be associated with or triggered by the query 103. For example, the user 102 may input the query 103 to retrieve the data at 109 or to retrieve the model at 108. In some aspects, the query 103 itself may include data inputs (e.g., data on a particular reservoir or the particular system) from the user 102 that are sent to the knowledge base 107 or to the modeling tool 150.

At 110, the modeling tool 150 performs a triage to select framework(s) 111 associated with the system model obtained at 108. The triage at 110 may include eliminating other framework(s) not suitable for hybrid modeling based on the system model from 108, the data from 109, or both. The selected framework(s) 111 may comprise hybrid model(s) 112. The hybrid model(s) 112 may comprise various models of varying types combined within the framework.

In some aspects, the framework(s) 111 may have their association(s) with the system model preconfigured in the knowledge base 107. The framework(s) 111 provide hybrid model(s) comprising any number of combinations of various models, e.g., a combination of a system model and a data-driven model (e.g., mechanistic model(s) and ML model(s)). In some aspects, framework(s) comprise hybrid model(s) of a combination of physics-based models and data-driven models (e.g., ML model).

The modeling tool 150 may train the hybrid model(s) 112 of the framework(s) 111 at 113. Training the hybrid model(s) 112 at 113 may include training an ML model of the hybrid model(s) 112 using a dataset, e.g., the data retrieved at 109. During training, the hybrid model(s) 112 may learn patterns and relationships between the data and the various models within the hybrid model(s) 112 by adjusting its parameters to minimize the difference between its predictions and labeled data, such as the actual outcomes.

At 114 validating the hybrid model(s) 112 may include further tuning the model, e.g., tuning its hyperparameters, by using a different dataset to the training dataset used at 113. Validation is performed at 114 to help prevent overfitting so that the hybrid model(s) 112 can be applied to a wide-range of data sets and contexts.

At 115, the modeling tool 150 may test the hybrid model(s) 112. This may include evaluating the hybrid model(s) 112 on a test data set which may be a second data set obtained at 109 or otherwise obtained by the modeling tool 150. Testing the hybrid model(s) 112 assesses how well the hybrid model(s) 112 generalizes to new, unseen data, providing an estimate of its performance in real-world scenarios.

Based on the results of 113-115, the modeling tool 150 makes a determination at 116 on whether the now trained, tested, and validated hybrid model(s) 112 are acceptable. This determination may be based on pre-defined performance metrics of outputs of the hybrid model(s) 112. The benchmarks may be associated with the framework(s) 111 to determine if the hybrid model(s) are performant. If the hybrid model(s) 112 meet pre-defined benchmark(s), at 117 they may be stored in a database, e.g., for future use by the modeling tool 150.

At 118, the modeling tool 150 may determine whether additional hybrid model(s) 112 should be trained. The number of hybrid model(s) 112 may be based on a configuration of the user 102 or obtained as part of the query 103, or be associated with the framework(s) 111. For example, each of the framework(s) 111 may set a certain number of hybrid model(s) 112 to be trained when the framework(s) 111 is selected. If the modeling tool 150 determines at 117 that additional hybrid model(s) 112 should be trained, then 113-115 are applied to other hybrid model(s) 112.

The modeling tool process 101 may stop at 119, if the modeling tool 150 determines at 118 that a sufficient number of acceptable hybrid models have been generated.

FIG. 2 depicts an example table 200 detailing types of frameworks for hybrid modeling tool to generate hybrid model(s). The column 201 describes the framework(s) that may be used by the modeling tool to generate hybrid models for a system of interest. The modeling tool may correspond to the modeling tool 150 of FIG. 1 and its processes, e.g., the modeling tool process 101 of FIG. 1. The framework(s) in the column 201 may correspond to the framework(s) 111 of FIG. 1. Example hybrid model(s) listed in the column 201 include a mechanistic feature engineering framework, a mechanistic supervision framework, a closure learning framework, and a knowledge-information design framework, and may correspond to the hybrid model(s) 112 of FIG. 1. The example table 200 may involve data that is hardcoded into the modeling tool.

The example table 200 also includes a column 202 describing corresponding framework(s) of the column 201. For example, based on the column 202, the mechanistic feature engineering framework relies on mechanistic model predictions or parameters as extra input features to its hybrid model(s). The mechanistic supervision framework uses custom loss functions for enforcing mechanistic or scientific laws or phenomenon understandings on its internal models. The closure learning framework learns corrections to low-fidelity mechanistic model(s) in a parameter/state-space. Finally, the knowledge-information design framework incorporates domain knowledge or structures in its design.

The example table 200 also includes a column 203 listing system models that may be utilized by corresponding frameworks in the column 201. These system models may be of different levels of abstraction. Listed from highest to lowest levels of abstraction, the mechanistic models can include black-box models, causal-directed acyclic graphs, functional models, and realized models. These mechanistic models can be inputs to the modeling tool to determine the appropriate framework(s) during a triage process, e.g., 110 of FIG. 1. The system models listed in the column 203 may correspond to the system model obtained at 108 of FIG. 1.

For example, based on the column 203, the mechanistic feature engineering framework may utilize black box models, realized models, and functional models. The mechanistic supervision framework only uses realized models. The closure learning framework uses both functional models and realized models. The knowledge-information design only uses causal DAGs.

Column 204 lists possible approaches that may be taken by each of the frameworks of the column 201. The mechanistic feature engineering framework may be a physics-guided neural network. The mechanistic supervision framework may be a physics-informed neural network. The closure learning framework may utilize any of parameter closure learning, state closure learning, or output closure learning. The knowledge-information design framework may utilize mechanistic neural ODE.

FIG. 3 depicts an example triage process 300 of the modeling tool. The triage 300 may correspond with the triage at 110 of FIG. 1. The triage 300 is a determination of what hybrid model framework(s) 302 to use based on the available system models, e.g., the system model(s) obtained at 108 of FIG. 1. The modeling tool may correspond with the modeling tool 150 of FIG. 1. The framework(s) 302 may correspond with the framework(s) 111 of FIG. 1, or the framework(s) listed in the column 201 of FIG. 2.

System models 301 may include models of varying levels of abstraction. The system models 301 may correspond to the models listed in the column 203 of FIG. 2. The system models 301 may include a realized model 304, a functional model 305, a causal graph model 306, and a black box model 307 (listed in order of lowest abstraction to highest abstraction). A realized model 304 may be a model where the functions have parameters with given values. A functional model 305 may define some relationships between inputs and outputs functionally, e.g., outputs defined with functions based on parameters. A causal graph model 306 is a model where some inputs are connected to some outputs through causal relationships, but the calculations or transformation of inputs to outputs are otherwise unknown or unobservable. A black box model 307 may be a model where inputs are processed in an unobservable algorithm that transforms them into outputs, and where only the inputs and outputs may be observed without any relationships between them.

The framework(s) 302 may include an output closure framework 308, a state closure framework 309, a parameter closure framework 310, a mechanistic neural ODE framework 311, and a mechanistic feature engineering framework 312. The triage 300 determines which framework(s) 302 to implement based on available system models 301 for the system under consideration. For example, if a realized model 304 is available, then available framework(s) 302 may include the output closure framework 308 or the state closure framework 309. In aspects, where a functional model 305 is available, the framework(s) 302 deployed may include the parameter closure framework 310. In aspects where a causal graph model 306 is available to the modeling tool, the mechanistic neural ODE framework 311 may be deployed. In aspects where a black box model 307 is available to the modeling tool, the mechanistic feature engineering framework 312 may be used.

In some aspects of the triage 300, given the availability of a type of the system models 320, the modeling tool can also derive other model types of higher abstraction (e.g., models requiring less detail). For example, if a realized model 304 is available, the modeling tool may derive any of the other system models 305-307, and consequently may use any of the frameworks suitable for the other models. However, if a black box model 307 is available (model with the highest abstraction) then other models cannot be derived from it. The rules of the triage 300 may be hard coded into a catalogue or look-up table, for example in the knowledge base 107, of FIG. 1, with data similar to the example table 200 of FIG. 2.

In some aspects, the output closure framework 308, the state closure framework 309, the parameter closure framework 310 and the mechanistic neural ODE framework 311 may rely on a mechanistic supervision 303, where the frameworks 308-311 rely on mechanistic supervision 303 to enforce mechanistic laws/understandings for their respective models. Mechanistic supervision refers to a system model (e.g., a state transition model) supervising or inputting parameters into a neural network to reinforce or adjust its learning.

FIG. 4 depicts an example architecture of a state-space model 400 that may be applied in various hybrid modeling framework(s) to generate a hybrid model. The example architecture may be one example of an architecture of any of the framework(s) 302 of FIG. 3, of the framework(s) listed in column 201 of FIG. 2, or of the framework(s) 111 of FIG. 1 for generating a hybrid model. The final output (Yₜ) 421 generated by the state-space model 400 may represent an underlying data generating system, e.g., a state of a system of interest being modeled by the hybrid model.

The primary components of the state-space model 400 include a state-transition model 405 (which may be a system model) and an observation model 410. The state-space model 400 may be described by the following two example equations:

$${X}_{t} = g ( {X}_{t - 1} , {U}_{t} ; θ ) \qquad Eq . 1.$$

$${Y}_{t} = h ( {X}_{t} , {U}_{t} ) \qquad Eq . 1.1$$

Function (g) represents state-transition model 405. Equation 1.0 represents function (g) producing an output of a latent state (Xₜ) 406 of the state-transition model 405. Function (h) represents the observation model 410. The Equation 1.1 represents function (h) producing the final output (Yₜ) 421 using the latent state (Xₜ) 406 output of Equation 1.0 as input into function (h) of Equation 1.1.

Exogenous input(s) (Uₜ) 401 represent inputs at discrete time step (t). The exogenous input(s) (Uₜ) 401 may correspond with the data obtained at 109 of FIG. 1 or it may correspond with data received via the query 103 of FIG. 1. Function (g), with model parameters (θ) 403 represents the evolution of the latent state (Xₜ) 406 overtime under the influence of the exogenous input(s) (Uₜ) 401. The prior state input(s) (Xₜ₋₁) 402 represents a prior state of the state-transition model at discrete time step (t−1) which is input into the function (g) to generate the state-transition model 405's latent state (Xₜ) 406. The prior state input(s) (Xₜ₋₁) 402 may correspond with the system model obtained at 108 of FIG. 1 or with data received via the query 103 of FIG. 1. Latent state (Xₜ) 406 is an output generated by the function (g) and represents the state-transition model 405's latent state (Xₜ) 406 at time (t).

Function (h) represents the observation model 410. Function (h) represents how the output (Yₜ) 411 is generated from the latent state (Xₜ) 406 used as an input with the exogenous input(s) (Uₜ) 401. Function (h) produces the final output (Yₜ) 421, which represents measured outputs at time (t) based on its inputs 401 and 406.

Model parameters (θ) 403 represents model parameters and may be predefined by a system model, e.g., the system models 301 of FIG. 3 or those listed in the column 203 of FIG. 2. The model parameters may be for a system model that corresponds to the system model obtained at 108 of FIG. 1.

In certain aspects, for data-driven models, both functions (g) and (h) may comprise black-box deep neural networks. And for system models (e.g., mechanistic models), both (g) and (h) may comprise explicit functional forms. Generating a hybrid model includes combining deep neural networks and system models when deciding (g) and (h) based on the framework(s) utilized (e.g., the framework(s) 302 of FIG. 3).

FIG. 5 depicts an example architecture of a parameter closure framework 500. The parameter closure framework 500 may correspond to the parameter closure framework 310 of FIG. 3. The parameter closure framework 500 comprises a state-transition model 505, an observation model 510, and a neural network 515. The neural network 515 may represent any deep neural network that maps a real vector to another vector of possibly different length. The parameter closure framework 500 may be applied when functional models are available, e.g., the functional model 305 of FIG. 3. The final output (Yₜ) 521 generated by parameter closure framework 500 may represent an underlying data generating system, e.g., a state of a system of interest being modeled by hybrid model.

In some aspects, system models (e.g., mechanistic models) assume parameters to be fixed. The parameter closure framework 500 allows parameters to change over time which provides flexibility to the hybrid model(s) generated. In certain cases, changing parameters also better represent the underlying data-generating mechanisms (to better represent phenomenon such as equipment aging, or environmental changes over time). The parameter closure framework 500 may be represented by the following equations:

$${θ}_{t} = N N ( {θ}_{t - 1} , {X}_{t - 1} , {U}_{t} ) \qquad Eq . 2.$$

$${X}_{t} = {g}_{0} ( {X}_{t - 1} , {U}_{t} ; {θ}_{t} ) \qquad Eq . 2.1$$

$${Y}_{t} = {h}_{0} ( {X}_{t} , {U}_{t} ) \qquad Eq . 2.2$$

Where: Eq. 2.0+Eq. 2.1+Eq. 2.2

The functions (g₀) and (h₀) represent functions used by system models, where function (g₀) represents the state-transition model 505 and function (h₀) represents the observation model 510. The function (NN) represents the neural network 515. Equation 2.1 represents function (g₀) producing an output of a latent state (Xₜ) 506 of the state-transition model 505. The Equation 2.2 represents function (h₀) producing the final output (Yₜ) 521 using the latent state (Xₜ) 506 as an input. Equation 2.0 represents function (NN) producing an output model parameter (θₜ) 503 that is input into the function (g₀) of Equation 2.1.

Exogenous input(s) (Uₜ) 501 represent inputs at discrete time step (t). The exogenous input(s) (Uₜ) 501 may correspond with the data obtained at 109 of FIG. 1 or it may correspond with data received via the query 103 of FIG. 1. Function (g₀) with model parameters (θₜ) 503 represents the evolution of the latent state (Xₜ) 506 overtime under the influence of the exogenous input(s) (Uₜ) 501. The prior state input(s) (Xₜ₋₁) 502 represents a prior state of the state-transition model 505 at discrete time step (t−1). The prior state input(s) (Xₜ₋₂) 502 is input into the function (g₀) to generate the state-transition model 505 latent state (Xₜ) 506. The prior state input(s) (Xₜ₋₂) 502 may correspond with the system model obtained at 108 of FIG. 1 or with data received via the query 103 of FIG. 1.

Function (h₀) represents the observation model 510. Function (h₀) represents how the observable output is generated from the latent state (Xₜ) 506 as well as the exogenous input(s) (Uₜ) 501. Function (h₀) produces the output (Yₜ) 511, which represents measured outputs at time t based on its inputs 501 and 506.

Model parameter(s) (θₜ) 503 represents model parameters at time (t) and may be predefined by a system model, e.g., the system models 301 of FIG. 3 or those listed in 203 of FIG. 2. The model parameters may be for a system model that corresponds to the system model obtained at 108 of FIG. 1. In the parameter closure framework 500, the model parameters (θₜ) 503 may be updated by the neural network 515 and may be outputs of the neural network 515. The inputs to the neural network 515 may be the prior parameters (θₜ₋₁) 507 of a previous time step (t−1), which then outputs the model parameters (θₜ) 503 for a time step (t). In some aspects, the outputs of the model parameter(s) (θₜ) 503 of the neural network 515 are inputs to the state-transition model 505 which produces an output of latent state (X) 506 to bean input into the observation model 510 as represented by the function (h₀). The observation model 510 then generates the output (Yₜ) 511 from the input of the latent state (Xₜ) 506.

FIG. 6 depicts an example architecture of a state closure framework 600. The state closure framework 600 may correspond to the state closure framework 309 of FIG. 3. The state closure framework 600 comprises a state-transition model 605, an observation model 610, a neural network 615, and a corrective model 620. The neural network 615 may represent any deep neural network that maps a real vector to another vector of possibly different length. The state closure framework 600 may be applied to realized models, e.g., the realized model 304 of FIG. 3. The final output (Yₜ) 621 generated by the state closure framework 600 may represent an underlying data generating system, e.g., a state of a system of interest being modeled by the hybrid model.

The state closure framework 600 is used on the assumption that parameter learning on its own, e.g., as is done in the parameter closure framework 500 of FIG. 5, is not sufficiently accurate and requires corrections from a neural network at each time step to prevent error accumulation and to enhance stability. One example of the state closure framework 600 is represented by the following equations:

$${\hat{X}}_{t} = {g}_{0} ( {X}_{t - 1} , {U}_{t} ; θ ) \qquad Eq . 3.$$

$${X}_{t} = {X}_{t - 1 +} N N ( {\hat{X}}_{t} , {U}_{t} ) \qquad Eq . 3.1$$

$${Y}_{t} = {h}_{0} ( {X}_{t} , {U}_{t} ) \qquad Eq . 3.2$$

Where: E q. 3.0+Eq. 3.1+Eq. 3.2

The functions (g₀) and (h₀) represent functions used by the state closure framework 600, where (g₀) represents the state-transition model 605 and (h₀) represents the observation model 610. The function NN represents the neural network 615 and a corrective model 620. Equation 3.0 represents function (g₀) producing an output of a latent state (\hat{X}ₜ) 606 of the state-transition model 605. The Equation 3.2 represents function (h₀) producing the final output (Yₜ) 621 using the latent state (Xₜ) 606 as an input. Equation 3.1 represents function (NN) with the corrective model 620 producing an output model parameter (θₜ) 603 input into the function (g₀) of equation 3.0.

Exogenous input(s) (Uₜ) 601 represent inputs at discrete time step (t). The exogenous input(s) (Uₜ) 601 may correspond with the data obtained at 109 of FIG. 1 or it may correspond with data received via the query 103 of FIG. 1. Function (g₀) with model parameters (θ) 603 represents the evolution of the latent state 606 (\hat{X}ₜ) overtime under the influence of the exogenous input(s) (Uₜ) 601 but without any additions. The prior state input(s) (Xₜ₋₂) 602 represents a prior state of the state-transition model 605 at discrete time step (t−1). The prior state input(s) (Xₜ₋₁) 602 is input into the function (g₀) to generate the state-transition model 605 latent state (\hat{X}ₜ) 606. The prior state input(s) (Xₜ₋₁) 602 may correspond with the system model obtained at 108 of FIG. 1 or with data received via the query 103 of FIG. 1.

The latent state (\hat{X}ₜ) 606 is input into the neural network 615 as represented by the function (NN). The neural function (NN) takes as inputs the latent state (\hat{X}ₜ) 606 as well as the exogenous input(s) (Uₜ) 601. The neural network 615 then produces an output based on the function (NN).

In the state closure framework 600, the latent state 606 (\hat{X}ₜ) output of the state-transition model 605 is input into the neural network 615, which in turn produces an output to the corrective model 620 which adds the output of the neural network to the prior state input(s) (Xₜ₋₁) 602. The corrective model 620 then generates a corrected latent state (Xₜ) 608 that is used as an input to the observation model 610 as represented by the function (h₀). The observation model 510 then generates the output (Yₜ) 511 from the input of the corrected latent state (Xₜ) 608.

The adding of the prior state input(s) (Xₜ₋₂) 602 which represents a prior state to the output of the neural network 615 allows the outputted corrected latent state to learn the residual in the latent state. This is particularly useful if it is easier for the neural network 615 to learn the residual than the states themselves.

FIG. 7 depicts an example architecture of an output closure framework 700 for one aspect of a hybrid model. The output closure framework 700 may correspond to the output closure framework 308 of FIG. 3. The output closure framework 700 comprises a number (n) of low fidelity model(s) 705, a first neural network 710, a corrective model 715, and a second neural network 720. Each of the neural networks 710 and 720 may represent any deep neural network that maps a real vector to another vector of possibly different length. The output closure framework 700 may be applied to realized models, e.g., the realized model 304 of FIG. 3. In some aspects, more than the two neural networks 710 and 720 may be included in the output closure framework 700. The final output (Yₜ) 721 generated by output closure framework 700 may represent an underlying data generating system, e.g., a state of a system of interest being modeled by the hybrid model.

The low fidelity model(s) 705 represent system models (e.g., mechanistic models) of low fidelity. In some aspects, each of the low fidelity model(s) 705 may represent a different feature of a system. The output closure framework 700 may be represented by the following equations:

$${X}_{t} = {X}_{t - 1 +} N {N}_{1} ( {X}_{t - 1} , {U}_{t} , Y {(}^{0} {}_{t} ) , Y {(}^{1} {}_{t} ) , … , Y {(}^{n} {}_{t} ) ) \qquad Eq . 4.$$

$${Y}_{t} = {NN}_{2} ( {X}_{t} , {U}_{t} , Y {(}^{0} {}_{t} ) , Y {(}^{1} {}_{t} ) , … , Y {(}^{n} {}_{t} ) ) ) \qquad Eq . 4.1$$

Where: Eq. 4.0→Eq. 4.1

The function (NN₁) represents the first neural network 710, while the function (NN₂) represents the second neural network 720. Equation 4.0 represents producing a corrected latent state (Xₜ) 716 as an output by using the function (NN₁) along with the corrective model 715. Equation 4.1 uses the corrected latent state (Xₜ) 716 from equation 7.0 as input to generate the final output (Yₜ) 721 via the function (NN₂).

Exogenous input(s) (Uₜ) 701 represent inputs at discrete time step (t). The exogenous input(s) (Uₜ) 701 may correspond with the data obtained at 109 of FIG. 1 or may correspond with data received via the query 103 of FIG. 1. Prior state input(s) (Xₜ₋₁) 702 represents a prior state of the system at discrete time step (t−1). The prior state input(s) (Xₜ₋₁) 702 may correspond with the system model obtained at 108 of FIG. 1 or with data received via the query 103 of FIG. 1.

The exogenous input(s) (Uₜ) 701 and the prior state input(s) (Xₜ₋₁) 702 are input into the low fidelity model(s) 705 to generate outputs (Yⁿₜ) 706 for each low fidelity model. The low fidelity model(s) 705 also consider model parameters (θ) 703 to produce the outputs (Yⁿₜ) 706 where (n) represents the fidelity model of the low fidelity model(s) 705 and t represents a time step. The outputs (Yⁿₜ) 706 represent an output of the k^{th} system (e.g., mechanistic) model at time (t). The outputs (Yⁿₜ) 706 from the low fidelity model(s) 705 are input into the first neural network 710.

Parameters (θ) 711 are output by the first neural network 710 and are input into a corrective model 715 to be generate a corrected latent state (Xₜ) 716. The corrective model 715 adds the parameters (θ) 711 of the first neural network 710 to the prior state input(s) (Xₜ₋₁) 702 and generates corrected latent state (Xₜ) 716.

The corrected latent state (Xₜ) 716 is input into the second neural network 720 as represented by the function (NN₂). The neural function (NN₂) takes as inputs the corrected latent state (X t) 716, the exogenous input(s) (Uₜ) 601, as well as the outputs (Yⁿₜ) 706 from the low fidelity model(s) 705. The neural function (NN₂) generates the final output (Yₜ) 721.

FIG. 8 depicts an example architecture of mechanistic neural ordinary differential equations 800 (mechanistic neural ODE 800) for one aspect of a hybrid model.

The mechanistic neural ODE 800 may correspond to the mechanistic neural ODE framework 311 of FIG. 3. The mechanistic neural ODE 800 comprises a causal graph 805, e.g., a directed acyclic graph (DAG), a number (n) of first neural networks(s) 810, a number (n) of corresponding corrective models 815, and a second neural network 820. The neural networks 810 and 820 may represent any deep neural network that maps a real vector to another vector of possibly different length. The mechanistic neural ODE 800 may be applied to causal graph models, e.g., the causal graph model 306 of FIG. 3. The final output (Yₜ) 821 generated by the mechanistic neural ODE 800 may represent an underlying data generating system, e.g., a state of a system of interest being modeled by the hybrid model.

The mechanistic neural ODE 800 may be represented by the following equations:

$${X}_{t}^{i} = {X}_{t - 1}^{i} + {NN}_{i} ( {X}_{t - 1}^{pa ( i )} , {U}_{t - 1}^{pa ( i )} ) \qquad Eq . 5.$$

$${Y}_{t} = N N ( {X}_{t} . {U}_{t} ) \qquad Eq . 5.1$$

Where: Eq. 5.0→Eq. 5.1

The neural network(s) 810 are each represented by the function (NNᵢ), while the neural network 820 is represented by the function (NN). The equation 5.0 produces an output of a corrected latent state (Xⁱₜ) 816 from each of the neural network(s) 810 and its corresponding corrective model 815. The equation 5.1 uses the combined outputs of the equations 5.0 of the various neural network(s) 810 and their respective corrective model(s) 815 as an input to produce the final output (Yₜ) 821.

The aim of the mechanistic neural ODE 800 is to encode causal structure into neural networks 810 and 820 so that the model as a whole learns evolution of particular states based on prior states in the causal graph. This may help prevent over-fitting and improve robustness of the model. The causal graph 805 represents system model(s) (e.g., mechanistic models). The causal graph 805 receives the exogenous input(s) (Uₜ) 801 that represent inputs at discrete time step (t). The causal graph 805 also receives the prior state input(s) (Xₜ₋₁) 802 that represent a prior state of the system at discrete time step (t−1). Exogenous input(s) (Uₜ) 801 represent inputs at discrete time step (t). Prior state input(s) (Xₜ₋₁) 802 represents a prior state of the system at discrete time step (t−1). The exogenous input(s) (Uₜ) 801 or may correspond with the data obtained at 109 of FIG. 1 or it may correspond with data received via the query 103 of FIG. 1. The prior state input(s) (Xₜ₋₁) 802 may correspond with the system model obtained at 108 of FIG. 1 or with data received via the query 103 of FIG. 1. The exogenous input(s) (Uₜ) 801 and the prior state input(s) (Xₜ₋₁) 802 are input into the causal graph 805 to generate an output 806. The output 806 is then input into each of the neural network(s) 810. The neural network(s) 810 are each represented by the function (NNᵢ) where (i) represents a specific neural network of the neural network(s) 810. The function (NNᵢ) also includes the variable (pa(i)) which represents the parents of the stat variable (i) in the causal graph.

The output of each of the neural network(s) 810 as represented by the function (NNᵢ) is input into a corresponding corrective model 815. Each of the corrective model(s) 815 adds the prior state input(s) (Xₜ₋₁) 802 to the output of the corresponding neural network 810 to generate a representation of a corrected latent state (Xⁱₜ) 816.

In some aspects, the corrected latent states (Xⁱₜ) 816 from each of the corrective model(s) 815 are added together and inputs these together as latent state (Xₜ) into the neural network 820. The neural network 820 is represented by the function (NN). The neural network 820 also obtains as input the exogenous input(s) (Uₜ) 801, and generates the final output (Yₜ) 821.

FIG. 9 depicts an example black-box neural ODE framework 900 for one aspect of a hybrid model. The black-box neural ODE 900 implements a state-space model, e.g., the state-space model 400 of FIG. 4, by using a recurrent neural network containing a custom recurrent cell encapsulating the functions (g) and (h) of the state-space model 400 of FIG. 4. A custom recurrent cell is a unit within a neural network such as a recurrent neural network (RNN) designed to achieve certain tasks. A custom recurrent cell allows for modifications in its structure, e.g., by changing activation functions or adjusting the number of gates.

The black-box neural ODE 900 may correspond to the mechanistic feature engineering framework 312 of FIG. 3. The black-box neural ODE 900 may be utilized when a black box system model is available, e.g., the black box model 307 of FIG. 3. For example, in aspects where no information about the underlying system apart from awareness of the state of variables is available, the system could be modeled by using a neural network to learn and represent the state-transition and observation models as represented by the functions (g) and (h) of FIG. 4. The advantage of this model is that it could provide additional flexibility to model more complex functions to represent state-transition and observation models using back-propagation learning techniques.

The black-box neural ODE 900 comprises a first neural network 910, a second neural network 920, and a corrective model 915. The neural networks 910 and 920 may represent any deep neural network that maps a real vector to another vector of possibly different length. The black-box neural ODE 900 may be applied to black box models, e.g., the black box model 307 of FIG. 3. The final output (Yₜ) 921 generated by the black-box neural ODE 900 may represent an underlying data generating system, e.g., a state of a system of interest being modeled by the hybrid model. The black-box neural ODE 900 may be represented by the following equations:

$${X}_{t} = {X}_{t - 1} + N N ( {U}_{t} , {X}_{t - 1} ) \qquad Eq . 6.$$

$${Y}_{t} = N N ( {X}_{t} . {U}_{t} ) \qquad Eq . 6.1$$

Where: Eq. 6.0→Eq. 6.1

Equation 6.0 represents the first neural network 910 with function (NN). Equation 6.1 represents the second neural network 920 with the function (NN) as well. However, the equation 6.0 along with the corrective model generates an output of latent state (Xₜ) 916 that is input into the function (NN) of the equation 6.1 to generate the final output (Yₜ) 921.

The first neural network 910 receives exogenous input(s) (Uₜ) 901 that represent inputs at discrete time step (t). The first neural network 910 also receives the prior state input(s) (Xₜ₋₁) 902 that represent a prior state of the system at discrete time step (t−1). Exogenous input(s) (Uₜ) 901 represent inputs at discrete time step (t). Prior state input(s) (Xₜ₋₁) 902 represents a prior state of the system at discrete time step (t−1). The exogenous input(s) (Uₜ) 901 or may correspond with the data obtained at 109 of FIG. 1 or it may correspond with data received via the query 103 of FIG. 1. The prior state input(s) (Xₜ₋₁) 902 may correspond with the system model obtained at 108 of FIG. 10r with data received via the query 103 of FIG. 1. The exogenous input(s) (Uₜ) 901 and the prior state input(s) (Xₜ₋₂) 902 are input into the first neural network 910 as represented by the function (NN) to generate an output that is then added to the prior state input(s) (Xₜ₋₁) 902 by the corrective model 915 to generate an output representing the latent state (Xₜ) 916.

The latent state (Xₜ) 916 is then input into the second neural network 920 which uses it along with exogenous input(s) (Uₜ) 901 to produce the final output (Yₜ) 921.

FIG. 10A depicts another example triage process 1000A of the hybrid modeling tool. The example triage process 1000A may combine with example processes 1000B and 1000C of FIGS. 10B and 10C, respectively, to autonomously generate hybrid model(s). In some aspects, the processes 1000A-1000C of FIGS. 10A-10C in combination may correspond with the modeling tool process 101 of FIG. 1.

In some aspects, the example triage process 1000A comprises a set of system models 1001. The set of system models 1001 may include realized models, functional models, causal graph models and black box models (listed in order of lowest abstraction to highest abstraction). The set of system models 1001 may correspond to the set of system models 301 of FIG. 3.

In some aspects, the example triage process 1000A comprises a set of framework(s) 1002 for the generating of hybrid model(s). The set of framework(s) 1002 may include an output closure framework, a state closure framework, a parameter closure framework, a mechanistic neural ODE framework, and a mechanistic feature engineering framework. The set of framework(s) 1002 may correspond to the framework(s) 302 of FIG. 3, or the listed framework(s) in column 201 of FIG. 2. For example, implementation of a framework of the set of framework(s) 1002 generate hybrid model(s).

In the example triage process 1000A, if a modeling tool, e.g., the modeling tool 150 of FIG. 1, obtains one or more of the set of system models 1001, it may use the availability of these models to determine the framework(s) that may be used to generate framework(s) 1002. The obtaining of the models may correspond with the obtaining of a system model at 108, of FIG. 1. In some aspects, the obtaining of these system models may correspond to the obtaining of the data received at 109 of FIG. 1, or may correspond to data received from the user 102, e.g., via the query 103 of FIG. 1.

In some aspects, given the availability of one type of system model, the modeling tool can also derive models of higher abstraction. For example, if a causal graph model(s) 1005 is available, the modeling tool can generate black box model(s) 1006 (and consequently use the framework(s) 1002 for the black box model(s) 1006). In some aspects, the availability of realized system model(s) 1003 allows the modeling tool to utilize an output closure framework 1007, e.g., as described by the output closure framework 700 of FIG. 7. In relation to FIGS. 10A-10C, the modeling tool may also utilize a state closure framework 1008, e.g., as described by the state closure framework 600 of FIG. 6. The availability of functional model(s) 1004 allows the modeling tool to utilize the parameter closure framework 1009, e.g., as described by the parameter closure framework 500 of FIG. 5. The availability of causal graph model(s) 1005 allows the modeling tool to utilize the mechanistic neural ODE framework 1010, e.g., as described by the mechanistic neural ODE 800 of FIG. 8. The availability of a black box model(s) 1006 allows the modeling tool to utilize a mechanistic feature engineering framework 1011, e.g., as described by the black-box neural ODE 900 of FIG. 9.

FIG. 10B depicts an example training process 1000B for hybrid modeling by the hybrid modeling tool. The example training process 1000B may continue from the example triage process 1000A of FIG. 10A.

Each of the frameworks described in the framework(s) 1002 of FIG. 10A (example frameworks) may comprise one or more models (respective models 1017-1021). The models 1017-1021 may correspond with any of the models described in the example architectures 400-900 of FIGS. 4-9. The combination of different models in the example frameworks provides hybrid modeling (also described as a hybrid model). For example, the models in these example frameworks may include observation models, state-space models, neural networks, corrective models, and the like. The output closure framework 1007 may comprise models 1017, the state closure framework 1008 may comprise models 1018, the parameter closure framework may comprise models 1019, the mechanistic neural ODE framework 1010 may comprise models 1020, and the mechanistic feature engineering framework 1011 may comprise models 1021.

The training of these models of the example frameworks may occur as described in relation to the frameworks 400-900 of FIGS. 4-9. Training may occur with input data 1012 that may correspond with any input data described in relation to the frameworks 400-900 of FIGS. 4-9. Some input data into one model (of the models 1017-1021) may for example be output data of another model. The example training process 1000B may also include mechanistic supervision 1013 (which may correspond with the mechanistic supervision 303 of FIG. 3), where a system model (e.g., a state transition model) may supervise or input parameters into a neural network to reinforce or adjust its learning. However, in some aspects, the mechanistic feature engineering framework 1011 may not utilize a system model such as a state-space model to supervise the neural network but may rely on a corrective model instead to train the neural network(s) (e.g., the corrective model 915 of FIG. 9).

FIG. 10C depicts an example model ranking process 1000C for hybrid modeling by the hybrid modeling tool. The example model ranking process 1000C may continue from the processes 1000A or 1000B of FIGS. 10A-10B.

For example, if an underlying system being modeled has realized models, causal graph models, functional models, or blackbox models, then the modeling tool may compare all the different available models and their associated framework(s) to determine which framework produces the most accurate results. This may be based on predetermined benchmarks.

Validation data 1022 that may be produced by the example training process 1000B of FIG. 10B may be used for computing metrics of each model produced by each of the frameworks 1007-1012 in FIG. 10A. The validation data may be produced in a manner corresponding to 115 of FIG. 1, which may include tuning any of the models 1017-1021.

The validation data is then processed to compute metrics and ranking of the models at 1023. Computations of the validation data 1022 may include determination of performance metrics (that may include statistical analysis). The determination of performance metrics may include generating one or more of mean absolute error (MAE), Absolute error (AE), peak absolute error (PAE), mean absolute percentage error (MAPE), root mean squared error (RMSE), and correlation for the results generated by each of the models 1017-1021. The various models may be ranked based on these statistical comparisons. The modeling tool, e.g., the modeling tool 150 of FIG. 1, selects 1024 the best performing hybrid model 1017-1021 (or a hybrid model based on any other predefined selection or criteria) for the system.

### Example Method for Hybrid Modeling a System of Interest

FIG. 11 shows a method 1100 for hybrid modeling a system of interest. In one aspect, method 1100 may be performed by a processing system, such as a processing system 3800 described with reference to FIG. 38.

Method 1100 begins at block 1102 with obtaining one or more hybrid modeling frameworks based on the model, each hybrid modeling framework comprising one or more hybrid models.

Method 1100 then proceeds to block 1104 with performing triage to select a hybrid modeling framework of the one or more hybrid modeling frameworks that is applicable to the system of interest based on associated metrics and the input data.

Method 1100 then proceeds to block 1106 with training each respective hybrid model of the one or more hybrid models of the hybrid modeling framework based on the input data to obtain one or more trained hybrid models configured to model behavior of the system of interest.

Method 1100 then proceeds to block 1108 with determining a rank order of the one or more trained hybrid models based on a benchmark set of data associated with the system of interest.

In some aspects, the method 1100 includes displaying a user interface on a display device that enables a user to input data associated with a system of interest and select a model associated with the system of interest.

In some aspects, the method 1100 includes displaying the one or more trained hybrid models and corresponding rank in the user interface on the display device.

In some aspects, the user interface enables the user to select and run a trained hybrid model that is configured to model behavior of the system of interest.

In some aspects, each hybrid model of one or more hybrid models comprises a physics-based model and a data-driven model.

In some aspects, block 1104 includes: obtaining an output closure framework and a state closure framework when the model selected by the user is a realized model; obtaining an output closure framework, a state closure framework, and a parameter closure framework when the model selected by the user is a functional model; obtaining an output closure framework, a state closure framework, a parameter closure framework, and a mechanistic neural ODE when the model selected by the user is a causal graph; or obtaining an output closure framework, a state closure framework, a parameter closure framework, a mechanistic neural ODE, and a mechanistic feature engineering framework when the model selected by the user is a black box.

In some aspects, block 1108 includes at least one of: performing parameter closure learning on the respective hybrid model to obtain a parameter closure model applicable to the system of interest; performing state closure learning on the respective hybrid model to obtain a state closure model applicable to the system of interest; performing output closure learning on the respective hybrid model to obtain an output closure model applicable to the system of interest; performing mechanistic neural ODE learning on the respective hybrid model to obtain a mechanistic neural ODE model applicable to the system of interest; and performing black-box neural ODE learning on the respective hybrid model to obtain a black-box neural ODE model applicable to the system of interest, wherein the parameter closure model, the state closure model, the output closure model, and the mechanistic neural ODE model are the trained hybrid models, and wherein training is performed using a loss function with one or more penalty terms configured to enforce mechanistic rules.

In some aspects, the parameter closure model comprises: a state transition model configured to receive as input a state value and an exogenous value and output a latent state value; a neural network configured to update parameters of the state transition model; and an observation model configured to receive as input the state value and output an observed value.

In some aspects, the state closure model comprises: a state transition model configured to receive a state value and an exogenous value and output a latent state value; a neural network configured to receive the state value and output an updated state value; and an observation model configured to receive the updated state value and output an observed value.

In some aspects, the state closure model comprises: a state transition model configured to receive a state value and an exogenous value and output an intermediate state value; a neural network configured to receive the intermediate state value and the exogenous value and output a parameter; a corrective model configured to receive the state value and the parameter and output a latent state value; and an observation model configured to receive the latent state value and the exogenous value and output an observed value.

In some aspects, the output closure model comprises: a low-fidelity model configured to receive a state value and an exogenous value and output an intermediate observed value; a first neural network configured to receive the state value, the exogenous value, and the intermediate observed value and output a parameter; an addition model configured to receive the state value and the parameter and output a latent state value; and a second neural network configured to receives the latent state value and output an observed value.

In some aspects, the mechanistic neural ODE model comprises: a causal graph configured to receive a state value and an exogenous value and outputs a causal value; a set of neural networks configured to receive the causal value and output a set of latent state values; and a neural network configured to receive the exogenous value and the set of latent state values and output an observed value.

In some aspects, the black-box neural ODE model comprises: a first neural network configured to receive a state value and an exogenous value and output a parameter; an additional model configured to receive the parameter and the state value and output a latent state value; and a second neural network configured to receive the latent state value and the exogenous value and output an observed value.

In some aspects, block 1110 includes inputting the input data to the respective trained hybrid model; obtaining, as output from the respective trained hybrid model, observed data; and determining an error associated with a trained hybrid model based on the observed data and ground truth data associated with the system of interest; and rank ordering the one or more trained hybrid models based on associated errors.

In some aspects, method 1100, or any aspect related to it, may be performed by an apparatus or a processing system, such as processing system 3800 of FIG. 38, which includes various components operable, configured, or adapted to perform the method 1100. Processing system 3900 is described below in further detail.

The method 1100 provides a process for autonomous hybrid model generation that may be applied to a wide range of systems, and which provides several technical benefits, such as beneficially reducing compute resource usage compared to generating hybrid models manually. The triage process to select the framework(s) reduces the amount of testing that may be expended and reduces computational resources dedicated for simulations and evaluations. Furthermore, pre-designed model combinations may be based on specific hybrid modeling framework(s). These model combinations are known to be integrate well with each other, reducing any processing or computations to determine integration of models. The use of the method 1100, which may be a unified modeling process to build and test hybrid models reduces overhead from data transfers or data transformations between different software packages or tools. A unified modeling tool therefore simplifies the process and reduces computational time and computational resources in generating hybrid models.

Note that FIG. 11 is just one example of a method, and other methods including fewer, additional, or alternative operations are possible consistent with this disclosure.

### Detailed Description of Application B

Aspects of the disclosure of Application B provide apparatuses, methods, processing systems, and computer-readable mediums for autonomous generation of anomaly detection models for target systems.

AD models identify patterns or instances that deviate from the norm, potentially indicating unexpected events or actions, malicious activity, or system failures, as a few examples. Conventionally, AD models are developed for specific use cases and are not generalizable. Consequently, each time a new use case arises, a new AD model must be developed, which leads to wasteful resource usage (e.g., compute, power, network traffic, data storage, etc.).

A practical example of AD model deployment can include a pump system that is being deployed in the field after development in the lab. Data would have been collected on the pump system in the lab during development that allows creation of a simulation model of the pump system. The simulation model represents the system's nominal behavior. Once the pump system is deployed in the field, data from the field is collected and recorded to generate real-life data for the behavior of the system in the field. As the pump system deteriorates with time and use after field deployment, the detection of anomalies becomes quite important. Therefore, AD models should be developed and deployed to detect problems with the pump system. However, the creation of AD models requires compute power, time and data resources for modeling, customizing and designing AD model solutions. The aspects disclosed herein overcome AD model development issues by utilizing AD algorithm frameworks that enhance the AD model generation and fine-tuning process.

Generating AD models may involve multiple computationally intensive tasks during development, integration, and performance evaluation stages. For example, at the development stage, selecting the appropriate algorithms to train the AD model may involve testing several different training algorithms. This can require substantial computational resources for simulations and evaluations. The process of optimizing parameters for different model components typically also requires numerous iterations and continuous iterative tweaking of the AD model, which is computationally demanding. In the conventional process, it is generally only practicable that one training algorithm is used and then continuously tweaked and improved to train an adequately performing AD model.

An integration phase during conventional AD model generation attempts to ensure that different model components work together. This integration phase may require multiple rounds of simulations to understand how the various components of the AD model interact, which increases the difficulty of creating custom AD models for a target system. A technical benefit is also provided by the aspects described herein by improving performance evaluation of AD models.

In addition to technical improvements provided herein in relation to development, integration and performance evaluation stages, other technical benefits arise from the disclosure herein due to the improvements in the various types of AD models capable of being generated. Conventional AD models may be predominantly data-driven and may not integrate system information, but instead rely on generic training or modeling data. System information can include data outputs of a system, e.g., outputs of a target system or associated simulation models. Consequently, conventional AD models may be limited in their applicability and accuracy and may perform particularly poorly in the presence of insufficient or low-quality data (e.g., data with significant noise).

Aspects described herein provide an automated process of generating AD models for a target system and based on the target system or associated data. The AD modeling process automatically selects a suitable AD algorithm framework (AD framework) based on the data types available to it. The selected AD framework may comprise training algorithms (AD training algorithms) and settings to train AD models based on a set of data of one or more data types. In some aspects, the AD modeling process not only automates the generation of AD models, but also automates evaluation and benchmarking of generated AD models in a systematic and repeatable manner. Aspects described herein may autonomously deploy the highest performing generated AD model(s). Alternatively, the generated AD models can be displayed with ranking or benchmarks to allow a user to select the most suitable AD model from the generated AD models. A target system can be any system of interest for which the AD modeling process generates an AD model. A target system can include machines and mechanical systems, natural (e.g., ecological) systems, social or economic systems, and information systems, to name just a few. The proposed AD model creation processes described herein can utilize a simulation model (and its data) as well as field data collected to generate AD model(s).

Beneficially, aspects described herein provide AD modeling processes for autonomous AD model generation applicable to a wide range of target systems. For example, the AD frameworks described herein may autonomously select or determine an AD framework based on inputs associated with a target system. Based on this AD framework, the AD modeling process may automatically perform processes to select AD training algorithms without having to test multiple different AD training algorithms or AD training algorithm combinations. For example, the modeling processes described herein may utilize a triage process that autonomously selects from several AD frameworks associated with the target system and the types of data provided to the target system to generate the AD model. The AD frameworks selected by the triage include pre-designed AD training algorithm combinations known to be integrate well based on provided data types and the intended AD model. The triage process to select the AD framework therefore reduces the amount of testing and computational resources dedicated for simulations and evaluations of different AD training algorithms or combinations.

One technical benefit of the aspects described herein is the ability to generate AD models for a target system based on pre-generated pre-tested AD frameworks. This reduces compute resource usage by eliminating the need to repeatedly recreate system-specific AD models that can be applied to different target systems.

A further technical benefit of the aspects described herein is the production of improved AD models over conventional AD models that perform anomaly detection more effectively by leveraging various types of data. The AD frameworks perform triage to select AD training algorithms to develop AD models using a target system's domain knowledge and data outputs, including by using outputs of simulation models, e.g., hybrid models simulating the target system. These hybrid simulation models may combine mechanistic or scientific system models with ML models, and generate highly relevant context-specific outputs that are then used to perform triage to select AD training algorithms and train the AD models. Thus, an AD framework can utilize a target system's domain knowledge data and thereby reduce the impact of poor training data or noise used to train the AD models. The AD frameworks are therefore able to generate AD model(s) that are capable of producing superior anomaly detection results that have improved accuracy and reliability.

A further technical benefit of the aspects described herein is reducing compute usage during AD model generation by allowing the use of pre-trained AD models that are associated with an AD framework. Once an AD framework is selected, pre-trained models may be obtained, e.g., from a repository, and used for the new model. This allows training AD models without having to build them from the ground up but by using the trained weights of the historical AD models and reducing overall compute resource usage in training and generating the AD model.

The AD modeling processes described herein therefore provide a generalizable framework for automating the generation of new, performant AD models in a systematic and repeatable manner while beneficially reducing compute resource.

### Example Autonomous Streamlined AD Model Generation

FIG. 12 depicts an example system 1200 deploying an AD modeling tool 1250. The AD modeling tool 1250 can execute a modeling process 1201. The AD modeling tool 1250 may be software-based, and may be comprised of any one or more of applications, applets, integrated developmental environments, software libraries, data sources, and the like. The system 1200 may be associated with or include a target system 1260.

A target system 1260 may be any type of system that an AD model is to be generated for. The target system 1260 could for example include biological or other organic systems, environmental systems, manufacturing production line systems, network systems, medical systems, or any other system that uses or generates data. For example, the target system 1260 may also include machinery, vehicles, devices, or other equipment. The target system 1260 may be a live system generating data in real-time or it may be a system that has historical data associated with it stored in a database, server, computing storage system, or knowledge base.

The system 1200 may include a user device 1204, which may be any sort of computing device, including desktop, tablet, and mobile computing devices. The user device 1204 may contain or be connected to a display. A user 1202, e.g., a domain specialist, inputs 1203 a query into the user device 1204. For example, the user device 1204 displays a user interface (UI) that enables the user 1202 to input data. The user input 1203 initiates the modeling process 1201. In some aspects, the user input 1203 may be information or input data about a target system. For example, the user 1202 selects on the UI, a specific system or type of system, e.g., the target system 1260, to generate an AD model for with the modeling process 1201.

The user input 1203 is sent to a server system 1206. The server system 1206 may be a single server, a combination of servers, mainframe, an on-premises server system, a cloud-based server system, an OS type of server or other specialized server(s) (e.g., virtual servers). In some aspects, the server system 106 triggers the AD modeling tool 1250 to initiate the modeling process 1201. The modeling process 1201 may include obtaining data from a knowledge base 1207. The knowledge base 1207 may comprise any type of a centralized repository of information, e.g., internal organizational databases or documentation platforms.

The AD modeling tool 1250 can also obtain system data at block 1208 from the knowledge base 1207 or the user 1202, e.g., via the user input 1203. The system data is associated with, or generated from the target system 1260 and may be live data or historical stored data. For example, the AD modeling tool obtains input data x or output data y of the target system 1260 at block 108. In one example, if the target system 1260 was a natural gas reservoir, then the data may include chemical reaction modeling data, or gas volume extraction data. The data obtained at 1208 may also be based on system deployment field data or official data, e.g., organizational or governmental published data.

At block 1209 the modeling process 1201 obtains a model, e.g., the simulation model associated with the target system 1260 or data associated with the simulation model or a previously stored AD model. The model can be obtained from the knowledge base 1207 or from the user 1202, e.g., via the user input 1203. The model could include a simulation model that represents the target system 1260. For example, the simulation model includes representations of a physical target system, such as the target system 1260. The simulation model may include representation(s) of the target system 1260's nominal behavior, anomalous behavior, or both. This representation of the system's nominal behavior can be physics-based, data-driven ML-based, or a hybrid of both. A physics based model is derived from the laws of physics or other first-principle scientific knowledge and relies on mathematical equations to model a system and predict its behavior. An ML model learns patterns and relationships in data without having to rely on any scientific principles, but instead uses large datasets to train the model to recognize patterns in the data. A hybrid model typically combines both models. The simulation model may be made up of one or more of the aforementioned models and can include various levels of abstracted physics models, including black-box models, causal-directed acyclic graphs, functional models, and realized models (in order from highest levels of abstraction to lowest levels of abstraction). The simulation model may also be a hybrid model made up from a combination of system model(s) and ML model(s). The simulation model obtained at block 1209 may include mechanistic models, statistical models, physical environmental models, physics models, or other scientific models.

In some aspects, the simulation model obtained at block 1209 can include previously generated or stored model(s), e.g., previously generated or stored AD model(s) as well as data associated with these AD model(s), allowing the system to use the AD model or its data as initial weights for training purposes, e.g., when training the AD model(s) at block 1212, instead of starting with completely new and untrained AD models. For example, if the target system is a pump system, and previous AD models were created and saved for the pump system, then this stored AD model may be obtained at block 1209 from the knowledge base 1207.

In some aspects, blocks 1208 or 1209 may be associated with or triggered by the user input 1203. In some aspects, obtaining the system data at block 1208 and obtaining the simulation data at block 1209 may both be optional aspects. For example, only one of block 1208 or block 1209 occurs, while in other aspects both occur.

At block 1210, the AD modeling tool 1250 performs a triage to select AD framework(s) 1211 associated with the data obtained at block 1208 or the simulation model obtained at block 1209. The triage at block 1210 may include determining AD framework(s) 1211 that are suitable based on blocks 1208 or 1209. The triage at block 1210 can include eliminating other AD framework(s) 1211 not suitable for the AD model based on the data obtained at block 1208, or the simulation model obtained at block 1209, or both, and selecting the AD framework(s) to generate the AD model(s).

In some aspects, the AD framework(s) 1211 comprise one or more AD training algorithms. The AD training algorithms can be based on ML models, mechanistic or scientific models, or hybrid models combining both ML and scientific models. At block 1212, the AD modeling tool 1250 selects AD training algorithm(s) from the selected AD framework(s) 1211 to train the AD model(s). Example AD training algorithm(s) include one-dimensional convolutional neural network-long short-term memory models (CNN1D-LSTM), variational autoencoder-Long short-term memory model (VAE-LSTM), sequence variational autoencoder-Long short-term memory models (SeqVAE-LSTM), variational autoencoder-bi-directional Long short-term memory models (VAE-BiLSTM), sequence variational autoencoder bi-directional Long short-term memory models (SeqVAE-BilSTM), an isolation forest, a one class support vector machine (SVM), Local outlier factor models, Gaussian mixture models, and a Long short-term memory (LSTM) models.

At block 1213, the AD modeling tool 1250 trains AD model(s) based on the training algorithm(s) designated by the AD framework(s) 1211. Training the AD model(s) at block 1213 can include training an ML model using a dataset, e.g., the data retrieved at blocks 1208 or 1209. During training at block 1213, the AD model(s) can learn patterns and relationships between the data where parameters are adjusted to minimize the difference between targets and training data.

The training at block 1213 can include validating the AD model(s), which includes tuning the model, e.g., tuning its hyperparameters, by using a different dataset to the training dataset used at block 1212. Validation can be performed to help prevent overfitting so that the generated AD model(s) can be applied to a wide-range of data sets and contexts.

The training at block 1213 can also include the AD modeling tool 1250 testing the generated AD model(s). This may include evaluating the AD model(s) on a test data set that may be a second data set obtained at blocks 1208 or 1209 or otherwise obtained by the AD modeling tool 1250. Testing the AD model(s) assesses how well they generalize to new, unseen data, providing an estimate of model performance in real-world scenarios.

The trained AD model(s) are then benchmarked, or rank ordered at block 1214 to determine the most suitable or appropriate AD model(s) for the target system 1260. The ranking can be based on performance metrics obtained during the training stage or benchmarking at block 1214 for each trained AD model. Each of the AD framework(s) 1211 includes its own benchmark test(s) or predefined benchmark values. Rank ordering at block 1214, e.g., based on benchmarking of the AD model(s), can be applied for multiple generated AD models, which also include other AD models, e.g., off-the-shelf commercial AD models, or previously generated or stored AD models.

The benchmarking at block 1214 can include predefined evaluation and benchmarking tests to classify or identify acceptable models or to rank the generated AD model(s). Evaluation metrics for the evaluation and benchmarking tests can include user defined metrics based on the equipment and the business needs. Also, any standard metric for classification can be used, such ROC-Score, an F1-Score, etc., for evaluating of the AD model(s). For example, based on the user defined metrics, the relevant AD model(s) are evaluated on the test data and the various metrics are computed to identify the best suitable algorithm. All of this information is retained for future benchmarking whenever a similar system is given by the user in the future.

Based on the results of block 1214, the AD modeling tool 1250 makes a determination at block 1215 on whether a generated and ranked AD model of the generated and ranked AD model(s) is acceptable. This determination may be based on pre-defined performance metrics of outputs of the AD model(s). The benchmarks to determine if the AD model(s) are performant are associated with the AD framework(s) 1211 or with other benchmarks, e.g., benchmarks retrieved from the knowledge base 1207. If the AD model(s) meet pre-defined benchmark(s), at block 1216 they are stored in a database, e.g., for future use by the AD modeling tool 1250.

At block 1217, the AD modeling tool 150 determines whether additional AD model(s) should be trained. The total number of AD model(s) required can be based on a configuration of the user 1202 or obtained as part of the user input 1203, or be associated with the AD framework(s) 1211. For example, each AD framework(s) 1211 can set a certain number of AD model(s) to be trained when the AD framework(s) 1211 are selected. If the AD modeling tool 1250 determines at block 1217 that additional AD model(s) should be generated, for example because there are not enough acceptable AD model(s) (e.g., as determined at block 1215) generated, then blocks 1213-1215 are applied to other AD model(s).

The modeling process 1201 stops at block 1218, if the AD modeling tool 1250 determines at block 1217 that a sufficient number of acceptable hybrid models have been generated.

FIG. 13 depicts an example triage process 1300 of the AD modeling tool. The example triage process 1300 may correspond with block 1210 of FIG. 12. The AD modeling tool may correspond to the AD modeling tool 1250 of FIG. 12.

The example triage process 1300 selects a specific AD framework of a set 1301 of AD frameworks, wherein each AD framework comprises one or more AD training algorithms. The set 1301 may include a non-residual-based supervised learning (NR-SL) AD framework 1302, a non-residual-based unsupervised learning (N R-UL) AD framework 1303, a residual-based supervised learning (RB-SL) AD framework 1304, and a residual-based unsupervised learning (RB-UL) AD framework 1305.

The example triage process 1300 automatically uses the available data associated with a target system 1307 or a simulation model 1308 (e.g., a simulation model 1308 of the target system 1307) to determine or select 1320 the AD framework from the set 1301 of AD frameworks. The example triage process 1300 at 1315 classifies the data it has available to it, e.g., data from blocks 1208 or 1209 of the modeling process 1201 of FIG. 12, or otherwise form the user input 1203 or the knowledge base 1207 of the system 1200 of FIG. 12. The classifying of the available data at 1315 by the example triage process 1300 includes classifying the data into one or more types including any of input(s) ×1306 (inputs of the target system 1307 or of the simulation model 1308), output(s) y 1309 of the target system 1307, output(s) y 1310 of the simulation model 1308, or label(s) L 1312. A residual value E 1311 may be determined during the example triage process 1300 or otherwise by the AD modeling tool 1250 of FIG. 12. The residual value E 1311 is determined based on a difference between the output ŷ 1310 of the simulation model 1308 (which represents an expected/predicted output) and the output y 1309 of the target system 1307 (which represents the actual output of the target system 1307).

In all of the residual based learning frameworks (the RB-SL AD framework 1304 and the RB-UL AD framework 1305) the output ŷ 1310 of the simulation model 1308 can be used as the input into one or more training algorithm(s) to train the AD model. Furthermore, the output ŷ 1310 of the simulation model 1308 can be used to fine-tune training data (e.g., before it is used to train the AD model(s)) if the simulation model 1308 is associated with additional features/signals that could be informative for the AD model(s) that are to be generated for the target system.

Based on the classifying at 1315 of the available data, the example triage process 1300 automatically determines, or selects the AD framework(s) of the set 1301 of AD frameworks, or eliminates AD framework(s) of the set 1301 of AD frameworks from selection. For example, if the output ŷ 1310 is not included in the available data that was classified at 1315, then the AD frameworks 1304 and 1305 are eliminated and only the AD frameworks 1302 and 1303 can be selected from to train and generate the AD model(s). The example triage process 300 is an autonomous process executed by a modeling tool running on a processing system, e.g., the processing system 3800 of FIG. 38, that selects the AD framework from the set 1301 of AD frameworks that will be used to generate AD model(s) and define AD training algorithms and settings used to train, evaluate, and benchmark the AD model(s). In some aspects, the AD frameworks of the set 1301 include predefined evaluations and benchmarking tests for AD model(s) generated by the AD framework.

FIG. 14 depicts an example table 1400 illustrating the ruleset for how data types available are used to perform the triage. The triage may correspond with the example triage process 1300 of FIG. 13.

The example table 1400 illustrates the rules used to determine or select each of the AD frameworks, for example at 1320 of FIG. 13. The example table 1400 includes columns 1401-1405. Column 1401 depicts the availability of data classified as an input x. The input(s) x of the column 1401 corresponds to the input(s) ×1306 of FIG. 13. Column 1402 depicts the availability of data classified as an output y. The output y of the column 1402 corresponds to the output(s) y 1309 of FIG. 13. Column 1403 depicts the availability of data classified as an output(s) ŷ. The output(s) ŷ of the column 1403 corresponds to the output(s) ŷ 1310 of FIG. 13. Column 1404 depicts the availability of data classified as label(s) L. The label(s) L of the column 1404 corresponds to the label(s) L 212 of FIG. 13.

Column 1405 depicts the AD frameworks, where each row in the column 1405 depicts one type of AD framework. Each of the AD frameworks in the column 1405 is associated with a type of AD training algorithms. The AD framework can utilize AD training algorithm types based on R-SL 1406, R-UL 1407, NR-SL 1408, and NR-UL 1409.

In some aspects, all the AD frameworks listed in the column 1405 require the availability of data of types of at least the input x and of the output y. According to the example table 1400, when available data include all types listed in the column 1401-1404, e.g., the input x, the output y, the output ŷ, and the label L then the AD framework that would be selected would be one that utilizes the R-SL 1406. The presence of the output y and the output ŷ allow the calculation of the residual (which is the difference between the output y and the output ŷ), while the presence of labels L allows for supervised learning, therefore the AD frameworks selected will be the framework that utilizes R-SL 1406 to train the AD model(s). R-SL 1406 example AD training algorithms may include a CNN1D-LSTM, a VAE-LSTM, a SeqVAE-LSTM, a VAE-BiLSTM, a SeqVAE-BiISTM, an Isolation Forest model, an SVM, a Local Outlier Factor model, a Gaussian Mixture model, and a Long Short-Term Memory (LSTM) model.

According to the example table 1400, when available data includes the types of the input x, the output y, and the output y then the AD framework that would be selected would be framework that utilizes the R-UL 1407, since the lack of labels L with the data means that the training of the model cannot utilize supervised learning to train the AD model(s). R-UL 1407 example AD training algorithms may include VAE-LSTM, SeqVAE-LSTM, VAE-BiLSTM, SeqVAE-BiISTM, and LSTM.

According to the example table 1400, when available data includes the types of the input x, the output y, and the labels L then the AD framework that would be selected would be framework that utilizes the NR-SL 1408. The presence of labels L in the data allows for supervised learning, while the lack of output ŷ means that the residual cannot be determined and therefore the AD framework cannot utilize residual-based training to train the AD model(s). NR-SL 1408 example AD training algorithms may include CNN1D-LSTM, VAE-LSTM, SeqVAE-LSTM, VAE-BiLSTM, SeqVAE-BiISTM, isolation forest, one class SVM, Local Outlier Factor, Gaussian Mixture Model, and LSTM.

According to the example table 1400, when available data only includes the types of the input x, the output y, then the AD framework that would be selected would be framework that utilizes the NR-UL 1409. The lack of labels L in the data prevents supervised learning, while the lack of output y means that the residual cannot be determined and therefore the AD framework cannot utilize residual-based training to train the AD model(s). NR-UL 1409 example AD training algorithms may include VAE-LSTM, SeqVAE-LSTM, VAE-BiLSTM, SeqVAE-BiISTM, and LSTM.

### Example Method for Autonomous AD Model Generation

FIG. 15 shows a method 1500 for hybrid modeling a target system. In one aspect, method 1500 may be performed by a processing system, such as a processing system 3800 described with reference to FIG. 38. The method 1500 provides a generalizable framework that automates the building of new AD models in a systematic and repeatable manner reducing compute resource usage associated with AD model generation. In some aspects, the method 1500 corresponds to the modeling tool process 101 of FIG. 12.

Method 1500 begins at block 1502 with obtaining data comprising at least one input and at least one output, the at least one input and the at least one output associated with a target system. Block 1502 can correspond to one or both of blocks 1208 or 1209 or FIG. 12.

The method 1500 then proceeds to block 1504 with performing triage to select an anomaly detection (AD) algorithm framework (AD framework) from a set of AD frameworks, wherein the AD framework is based on the at least one input and the at least one output and wherein the AD framework comprises one or more AD training algorithms. The triage at 1504 can correspond to the triage at block 1210 of FIG. 12.

The method 1500 then proceeds to block 1506 with training one or more AD models based on the one or more AD training algorithms of the AD framework. The AD framework can include any of the frameworks in the set 1301 of AD frameworks of FIG. 13. The method 1500 provides AD frameworks comprising AD training algorithms known to be integrate well with the type of data provided and the AD model to be generated, reducing any processing or computations to determine integration of models, data, or training algorithms together. The block 1506 can correspond to the training of an AD model at block 1213 of FIG. 12.

The method 1500 then proceeds to block 1508 with rank ordering the one or more AD models based on at least one of a benchmark set of data associated with the target system, pre-set metrics, or user-defined values. Block 1508 can correspond to block 1214 of FIG. 12.

In some aspects, method 1500 further includes obtaining a selection of an AD model of the one or more AD models from a user. For example, obtaining a selection via a user input 1203 of FIG. 12.

In some aspects, method 1500 further includes executing the AD model on at least one data input associated with the target system. For example, the AD model after being trained can be executed to be used to detect anomalies in the target system by being provided real-time output data from the target system and produce an output or result, e.g., an anomaly classification of the target system.

In some aspects, method 1500 further includes obtaining one or more stored AD models from a knowledge base, wherein the method 1500 comprises obtaining at least one of the at least one input or the at least one output from the one or more stored AD models. This can correspond to either one or both of blocks 1208 or 1209 of FIG. 12. One benefit of the method 1500 is that it enables reuse and retraining of AD models built for one system to be used for other systems expediting the development of AD models for a target system and reducing the need for training data including anomalous data. For example, instead of training a model from the ground up, previously trained models may be obtained from a knowledge base at block 1502 and the weights of the retrieved model can be used to train an AD model for the target system.

In some aspects, block 1504 includes: classifying one or more subsets of the data as a data type of data types, wherein the data types comprise an input type, an output type, a label type, or a predicted output type, wherein the one or more subsets comprise the at least one input and the at least one output, wherein the at least one input is classified as the input type, and the at least one output is classified as the output type; selecting the AD framework based on the data types the one or more subsets are classified into; and selecting the one or more AD algorithms associated with the AD framework to train the one or more AD models according to the one or more AD algorithms, wherein the one or more AD algorithms utilize non-residual based unsupervised learning, non-residual based supervised learning, residual based unsupervised learning, or residual based supervised learning. The data types can correspond with the data types presented in FIG. 13 (1306, 1309, 1310 and 1312) and can correspond to the data types listed in columns 1401-1404 of FIG. 14. The AD framework can be selected form the set 1301 of AD frameworks of FIG. 13, or the AD frameworks listed in column 1405 of FIG. 14. The method 1500 therefore leverages AD frameworks that deploy pre-designed AD training algorithms or combinations that can be applied in various contexts based on the specific AD framework, which reduces compute resource usage from selecting and integrating AD training algorithms and their components with data and data types.

In some aspects, the one or more subsets further comprise at least one label, wherein the at least one label is classified as the label type. The label type corresponds to label(s) L 1312 of FIG. 13.

In some aspects, the one or more subsets further comprise at least one predicted output, wherein the at least one predicted output is classified as the predicted output type. The predicted output type corresponds to the output ŷ 1310 of FIG. 13.

In some aspects, the AD framework is associated with one of: the input type and the output type and with the one or more AD algorithms that utilize the non-residual based unsupervised learning (e.g., the NR-UL 1409 of FIG. 14); the input type, the output type, and the label type and with the one or more AD algorithms that utilize the non-residual based supervised learning (e.g., the NR-SL 1408 of FIG. 14); the input type, the output type, and the predicted output type, and with the one or more AD algorithms that utilize the residual based unsupervised learning (e.g., the R-UL 1407 of FIG. 14); or the input type, the output type, the label type, the predicted output type, and with the one or more AD algorithms that utilize the residual based supervised learning (e.g., the R-SL 1406 of FIG. 14).

In some aspects, the one or more AD training algorithms are configured to utilize NR-UL 1409 and the AD framework is configured to be associated with the at least one input and the at least one output.

In some aspects, the data further comprises one or more of at least one label or at least one predicted output, e.g., one or more of the label(s) L 1312 and the output ŷ 1310 of FIG. 13.

In some aspects, the at least one predicted output is associated with a simulation model related to the target system.

In some aspects, the method 1500 further includes determining a residual value associated with the predicted output, wherein the residual value comprises a difference between the at least one predicted output and the at least one output. The residual value can correspond to the residual value E 1311 of FIG. 13.

In some aspects, the one or more AD training algorithms utilize non-residual based supervised learning (e.g., the AD framework 1302 utilizing NR-SL of FIG. 13), and the AD framework is configured to be associated with the at least one input and the at least one output and the at least one label.

In some aspects, the one or more AD training algorithms utilize residual based unsupervised learning (e.g., the AD framework 1304 utilizing R-UL of FIG. 13), and the AD framework is configured to be associated with the at least one input, the at least one output and the at least one predicted output.

In some aspects, the one or more AD training algorithms utilize residual based supervised learning (e.g., the AD framework 1305 utilizing NR-UL of FIG. 13), and the AD framework is configured to be associated with the at least one input, the at least one output, the at least one predicted output, and the at least one label.

In some aspects, block 1502 includes obtaining the data from a user. For example, this may correspond to obtaining data from a user 1202 via a query or input 1203 of FIG. 12.

In some aspects, method 1500, or any aspect related to it, may be performed by an apparatus or processing system, such as processing system 3800 of FIG. 38, which includes various components operable, configured, or adapted to perform the method 1500.

The method 1500 provides a technical benefit of reducing compute resource usage by eliminating the need to repeatedly recreate system-specific AD models that can be applied in various contexts from the ground up by leveraging AD frameworks that utilize predefined and pre-tested AD training algorithms and algorithm combinations designed for the data types available to the method 1500. Additionally, the method 1500 relies on the domain knowledge and data of the target system or a simulation of the target system to not only determine the AD frameworks that select the most suitable AD algorithms but also to train the AD models based on this domain knowledge and data reducing the reliance on generic poor training data. The ability to leverage pre-trained models that are based on the same AD frameworks also reduces training time and amount required to generate AD models reducing overall compute resource usage.

Note that FIG. 15 is just one example of a method, and other methods including fewer, additional, or alternative operations are possible consistent with this disclosure.

### Detailed Description of Application C, D, and E Joint Figures

FIG. 16 illustrates an example oil and gas production system 1610 having various worksite locations that contain equipment that may be monitored and controlled as described in greater detail herein. As illustrated in FIG. 16, oil and gas is produced along with water atone or more production wells 1612. Then, each reservoir fluid (e.g., oil, gas, the produced water, the returned injected hydraulic fracturing fluid, and so forth) may be separated using one or more separators 1614 with most of the produced oil and gas being directed into oil and gas pipelines 1616, 1618, respectively, and the remainder flared via a flare stack 1620 and the produced water being directed to a temporary storage facility 1622 for local treatment and subsequent storage in, for example, a surface pond 1624. In certain embodiments, most of the produced water is re-injected into saltwater disposal (SWD) wells 1626 with only a small portion used for fracturing purposes via injection into a formation 1628 by one or more fracturing wells 1630. As described in greater detail herein, various pieces of equipment at each of the locations illustrated in FIG. 16 may be analyzed using the techniques described herein. Furthermore, the analytic techniques described herein may be extended to other types of production systems other than oil and gas production systems 1610.

FIG. 17 illustrates a production control system 1700 (e.g., that includes the analysis and control system 1734) configured to control the oil and gas production system 1610 of FIG. 16. In certain embodiments, the analysis and control system 1734 may include one or more analysis modules 1736 (e.g., a program of computer-executable instructions and associated data) that may be configured to perform various functions of the embodiments described herein. In certain embodiments, to perform these various functions, the one or more analysis modules 1736 may execute on one or more processors 1738 of the analysis and control system 1734, which may be connected to one or more storage media 1740 of the analysis and control system 1734. Indeed, in certain embodiments, the one or more analysis modules 1736 may be stored in the one or more storage media 1740.

In certain embodiments, the computer-executable instructions of the one or more analysis modules 1736, when executed by the one or more processors 1738, may cause the one or more processors 1738 to generate one or more models (e.g., forward model, inverse model, mechanical model, and so forth). Such models may be used by the analysis and control system 1734 to predict values of operational parameters that may or may not be measured (e.g., using gauges, sensors, and so forth) during operations.

In certain embodiments, the one or more processors 1738 may include a microprocessor, a microcontroller, a processor module or subsystem, a programmable integrated circuit, a programmable gate array, a digital signal processor (DSP), or another control or computing device. In certain embodiments, the one or more processors 1738 may include machine learning and/or artificial intelligence (AI) based processors. In certain embodiments, the one or more storage media 1740 may be implemented as one or more non-transitory computer-readable or machine-readable storage media. In certain embodiments, the one or more storage media 1740 may include one or more different forms of memory including semiconductor memory devices such as dynamic or static random access memories (DRAMs or SRAMs), erasable and programmable read-only memories (E PROM s), electrically erasable and programmable read-only memories (EEPROM s) and flash memories; magnetic disks such as fixed, floppy and removable disks; other magnetic media including tape; optical media such as compact disks (CDs) or digital video disks (DVDs); or other types of storage devices. Note that the computer-executable instructions and associated data of the analysis module(s) 1736 may be provided on one computer-readable or machine-readable storage medium of the storage media 1740, or alternatively, may be provided on multiple computer-readable or machine-readable storage media distributed in a large system having possibly plural nodes. Such computer-readable or machine-readable storage medium or media are considered to be part of an article (or article of manufacture), which may refer to any manufactured single component or multiple components. In certain embodiments, the one or more storage media 1740 may be located either in the machine running the machine-readable instructions or may be located at a remote site from which machine-readable instructions may be downloaded over a network for execution.

In certain embodiments, the processor(s) 1738 may be connected to a network interface 1742 of the analysis and control system 1734 to allow the analysis and control system 1734 to communicate with multiple downhole sensors 1744 and surface sensors 1746, as well as communicate with actuators 1748, 1750 and/or programmable logic controllers (PLCs) 1752, 1754 of surface equipment 1756 and of downhole equipment 1758, as described in greater detail herein. In certain embodiments, the network interface 1742 may also facilitate the analysis and control system 1734 to communicate data to cloud computing resources 1760, which may in turn communicate with external computing systems 1762 to access and/or to remotely interact with the analysis and control system 1734.

It should be appreciated that the production control system 1732 illustrated in FIG. 17 is only one example of a production control system, and that the production control system 1732 may have more or fewer components than shown, may combine additional components not depicted in the embodiment of FIG. 17, and/or the production control system 1732 may have a different configuration or arrangement of the components depicted in FIG. 17. In addition, the various components illustrated in FIG. 17 may be implemented in hardware, software, or a combination of both hardware and software, including one or more signal processing and/or application specific integrated circuits. Furthermore, the operations of the production control system 1732 as described herein may be implemented by running one or more functional modules in an information processing apparatus such as application specific chips, such as application-specific integrated circuits (ASICs), field-programmable gate arrays (FPGAs), programmable logic devices (PLDs), systems on a chip (SOCs), or other appropriate devices. These modules, combinations of these modules, and/or their combination with hardware are all included within the scope of the embodiments described herein.

### Detailed Description of Application C

Certain existing techniques, for example, the techniques for adapting recurrent neural networks (RNNs) to changes in dynamical systems present certain challenges. One approach (known as the Forgione approach) is to adapt an existing RNN model, which was trained on a nominal system, to a perturbed system (i.e., the system after changes). Instead of retraining the model from scratch, the Forgione approach proposes adding an adaptive correction term to the model's output. This correction term is designed to account for discrepancies between the nominal system and the perturbed system. This approach, based on Jacobian Feature Regression (JFR) and a non-parametric view using Gaussian processes, offers efficient model adaptation. The Forgione approach particularly utilizes the JFR defined in the feature space defined by the Jacobian of the model with respect to its nominal parameters. The Forgione approach also proposes a non-parametric view that utilizes a Gaussian process. This could be useful to provide flexibility and efficiency for very large networks or when only a few data points are available.

The embodiments described herein address the shortcomings of the Forgione approach and other similar techniques by providing an improved approach for recalibrating model parameters of retrained ML models through JFR of a lab-developed model to a field environment. In such embodiments, an RNN may be used to model the dynamic system, and this nominal RNN may be trained on available measurements. Then, it is assumed that the system dynamics change, causing the nominal RNN to not be accurate enough for predicting the observed measurements in the presence of these perturbed system dynamics. In other words, an unacceptable degradation of the nominal model performance occurs. A transfer learning approach may be implemented to improve the performance of the nominal model in the presence of perturbed system dynamics, where the nominal model is augmented with additive correction terms that are trained on the currently observed “perturbed-system” data; and these correction terms are learned through a JFR method defined in terms of the features spanned by the model's Jacobian concerning its nominal parameters.

The embodiments described herein extend the implementation of JFR (or other suitable transfer learning or adaptation techniques) to physics-informed neural networks modeled using a state-space formulation and demonstrate that this approach works faster and more accurately than retraining these ML and physics-informed machine learning (PIML) models. The other techniques are based on incoming data, fine-tuning, and using active learning-based approaches to retrain models. In addition, the other techniques also include learning corrective terms, corrective models, and full retraining of the models from scratch. In addition, the embodiments described herein extend the workflows described herein for PHM-based use cases, for example, use cases that are focused on utilizing JFR or other suitable transfer learning or adaptation techniques to improve the robustness of PHM solutions.

The embodiments described herein also demonstrate that JFR is more sustainable than other retraining and transfer learning methods. Prior approaches inherently work in an offline mode, where the adaptation happens once it is triggered based on some prior knowledge or analysis. The embodiments described herein also demonstrate how such offline adaptation approach may be modified into an online adaptation technique. Finally, the embodiments described herein also demonstrate the application of online and offline adaptation algorithms on applications relevant to the oil and gas industry, such as membranes, compressors, and so forth.

As described above, the embodiments described herein build upon developed JFR algorithms by extending the implementation of JFR (or other suitable transfer learning or adaptation techniques) to physics-informed neural networks modeled using a state-space formulation; demonstrating that JFR is more sustainable than other retraining and transfer learning methods; demonstrating how an offline adaptation approach may be modified into an online adaptation technique; and also demonstrating the application of online and offline adaptation algorithms on applications relevant to the oil and gas industry, such as membranes, compressors, and so forth. Because of the wide-scale demand and applicability of modeling a physical system, the embodiments described herein may be useful for many applications, such as modeling and simulation of dynamic systems and equipment and processes; optimization of systems; control of systems; forecasting of events; prognostics and health management; automation; and decision making, among others.

As described above, modeling and simulation of engineering systems (often referred to as digital twins) benefit many applications, such as optimization, control, forecasting, prognostics and health management, automation, and decision-making, among others. Such models may be physics-based, such as a system of dynamic differential equations, or data-driven, such as a machine learning model (including deep learning models such as artificial neural networks), or a hybrid combination of both physics-based and data-driven models, such as a physics-informed neural network. Typically, building such models involve operating the system in a more constrained environment than the real world, like in a laboratory setting or a machine-shop setting to collect data, and then using this “training dataset” to calibrate the parameters of the model (e.g., equation parameters or weights of the neural networks). Unfortunately, the “test data” and “validation data” for these systems usually come from the real world, where the system will operate when fielded and can sometimes be very different from the laboratory or machine shop setting. In addition, often, a model of a system needs to be built that is different from what was built using stale or obsolete “training data.”

These differences in training and testing datasets are even more apparent in applications of prognostics and health management, where there is a need to have an estimation of the current system state (either nominal or degraded) as well as prediction of when something is going to break/fail in the future so that corrective actions may be taken proactively before the imminent failure state is encountered, rather than reactively after the system has failed.

For applying PHM techniques, having a model representing the system is very important. The model helps establish the nominal expected behavior, which is then compared with the observed system behavior to assess whether an anomaly has been detected in real life. If it is detected, the following stages of PHM workflow are triggered, which helps isolate and quantify the faults. Along with these, the model also helps us determine the RUL of the system, which along with the information about the anomaly, faults, and degradation information helps in decision-making. To perform PHM, there is often a requirement to build models of faulty or degraded systems, and it is nearly impossible to replicate all possible failure conditions that the system will encounter when deployed. As such, there are always some gaps in coverage of nominal and faulty operating conditions.

Learning and forming such models is an intensive task requiring a lot of inputs from the subject matter experts (SMEs) and collected data that would be useful for estimating the established behavior of the system. One possible way to create the model is to use the data collected from a controlled environment, such as an environment in a manufacturing facility, and use that data to model the system. However, collecting the data that helps identify faulty scenarios and the changes that might occur in real-life scenarios is nearly impossible. Furthermore, many things vary when the system is deployed, making it relatively difficult to use the data collected from the manufacturing facilities while designing and manufacturing the system. Because of different variations, it becomes difficult to use the learned model representation of the system to carry out all of the various PHM operations, and the model needs to be recalibrated to the current sensor data being received.

A methodology has been developed to recalibrate a lab-developed model to new/different measurements observed in a field/real-world environment. In particular, an RNN may be used to model the dynamic system, and this nominal RNN may be trained on the available measurements. Then, it is assumed that the system dynamics change, causing the nominal RNN to not be accurate enough for predicting the observed measurements in the presence of these perturbed system dynamics. In other words, an unacceptable degradation of the nominal model performance occurs. A transfer learning approach has been proposed to improve the performance of the nominal model in the presence of perturbed system dynamics, where the nominal model is augmented with additive correction terms that are trained on the currently observed “perturbed-system” data; and these correction terms are learned through a JFR method defined in terms of the features spanned by the model's Jacobian concerning its nominal parameters.

FIG. 18 illustrates an example flow chart of a workflow 1864 for utilizing the techniques described herein for developing a robust way that helps take the model built using the data from controlled environments (e.g., manufacturing facilities) and deploy it along with the system, and then use (e.g., continuously, in certain embodiments) the incoming data to adapt the model to ensure the model always in close alignment with the behavior of the system.

As established, the data from the controlled environments 1866 (e.g., laboratory) may be used to configure and train different models that represent the system. This is represented by the blocks 1868, 1870 above the horizontal dotted line 1872 in FIG. 18. In particular, data from the controlled environments (e.g., block 1868) may be used to initially learn a model M₀ (e.g., block 70). However, things tend to change over time once the model M₀ is learned and the system is deployed in a physical setting (e.g., the oil and gas production system 1610 illustrated in FIG. 16) (e.g., block 1874) to be used in the field environment (e.g., the deployment environment 1876 below the horizontal dotted line 1872 in FIG. 18). Over time, the system's behavior changes, leading to the model M₀ becoming stale and not being in line with the system's behavior. As the system operates in real-life, different measurements may be collected (e.g., collected data 1878) and stored in a database. Using the designed approach, there are two choices for model adaptation: Offline Model Adaptation and Online Model Adaptation.

In offline Model Adaptation (e.g., the bottom path 1880 illustrated in FIG. 18), the data is continuously collected from the deployment environment 1876 in this setting. The model M₀ and the system are constantly monitored, and any kind of deviations may be detected and tagged (e.g., block 1882). If the deviations are above a given threshold, all of the past information collected before the deviations happen (e.g., the streaming data 1884) may be utilized for adapting the model M₁ (e.g., block 1886). The bottom path 1880 is an offline adaptation technique as not all the incoming information is directly used for adaptation. Rather, the adaptation may be triggered based on the output of anomaly detection. The embodiments described herein extend the offline model adaptation approach of Forgione to hybrid models that represent the dynamics of a system by leveraging both first principles domain knowledge and data-driven ML approaches. One such example of a hybrid modeling approach is physics guided neural networks (PGNN). PGNN uses a first principles model in parallel with data-driven components (e.g., RNN s). It could be helpful to directly use the first principles model, even if it is not tuned and calibrated to the best quality. The developed PGNN architecture may be further coupled with the adaptation technique to help generate a model that is always in close alignment with the physical system.

In online Model Adaptation (e.g., the top path 1888 illustrated in FIG. 18), there is no dependency on the anomaly detection process. Rather, as and when new measurements are recorded (e.g., the streaming data 1890), they are used for adapting the model M₁ (e.g., block 1886). This helps in the continuous utilization of the incoming information. The modification of the adaptation approach to an online form is a new contribution of the embodiments described herein.

Both online and offline adaptation methods (e.g., the top path 1888 and the bottom path 80 illustrated in FIG. 18, respectively) have certain drawbacks. Specifically, the online adaptation technique requires a lot of computing power as the models are continuously adapted. Furthermore, observing a single non-standard data point may result in a deviation from the model's behavior, whereas it is not a persistent thing for the physical system. On the other hand, offline adaptation requires dependencies on the anomaly detectors and the storage systems where the data is stored.

A model closely aligned with the physical system helps seamlessly deploy different applications such as optimization, control, forecasting, prognostics and health management, automation, and decision-making, among others, from the first instance the system is deployed. Further, it enables utilization of the incoming data efficiently and update the model constantly. It also enables quantification of the model's behavior change, which could be reflected based on the differences between the models (e.g., Nominal Model: Trained using the data from a controlled setting, Adapted Model: Adapted using incoming data) predictions. In addition, it also enables automatic adjustment of control of operational parameters of the physical system based on the data that changes during operation of the physical system.

FIG. 19 illustrates an example of results for a dataset that defines a system comprising of three pumps, where the dotted line represents predictions from a nominal model, whereas a first solid line represents the actual system behavior and a second solid line represents the output of the adapted model, which, as observed, is better aligned with the actual expected conduct. The introduced fault for pump #1 is why the observed results differ from the expected. The embodiments described herein also demonstrate that the online and offline model adaptation algorithms using JFR are more sustainable than other retraining and transfer learning methods.

Retraining a machine learning model of a dynamic system using sensor readings obtained in a laboratory setting may often not be similar enough to the fielded setting environment. This requires the need to retrain the machine learning model for the fielded scenario. For example, having an updated model support all the different applications including optimization, control, forecasting, prognostics and health management, automation, and decision-making, among others, is important.

The embodiments described herein address these unmet needs by providing a fast and more robust way of dealing with transfer learning. Further, the embodiments described herein support the vision of having more robust models representing the system that allow reliable solutions that help mitigate the risks of running the system into a bad state and be more proactive in the actions to fix the system early on. The major bottleneck that arises with the current methods to model the system is the delay in collecting the data and the time spent creating/learning the model after that. The embodiments described herein allow for reduction of the delay by efficiently using data from the controlled settings such as the manufacturing facilities and using the real-time collected data for both online and offline adaptation of the model to reflect the system's current state.

The embodiments described herein may be applied to many various applications. In essence, any application that requires the dynamic modeling of systems will benefit from the embodiments described herein. Such applications include, but are not limited to, optimization, control, forecasting, prognostics and health management, automation, and decision-making.

The embodiments described herein allow for relatively fast deployment of data-driven models from lab-to-field scenarios. In addition, the embodiments described herein also extend approaches to the adaptation of hybrid PIML approaches to new data. In addition, the embodiments described herein demonstrate that this methodology works on multiple datasets pertinent to the oil and gas industry. In addition, the embodiments described herein further showcase that this methodology utilizes less power, thereby contributing fewer carbon emissions. The relatively fast and robust adaptation of the models enable the models to be “evergreen” and “constantly updated” and adapt to wear and tear and other degradation of the system. As a result, the embodiments described herein make the PHM process more reliable by ensuring that the system model is continuously adapted to reflect the system state's most up-to-date and true representation.

The embodiments described herein also make it easier for the models created on different datasets to be adapted to their current fielded environments. This adaptation will enable the models to be “evergreen” and “constantly updated” and be able to adapt to wear and tear and other degradation of the system, useful for RUL prediction. The embodiments described herein may also help be more sustainable with a reduced carbon footprint compared to complete retraining. The embodiments described herein may also be used for both online and offline adaptation given the adaptation is faster than complete retraining.

FIG. 20 illustrates a flow diagram of a method 2092 (e.g., to be at least partially performed by the analysis and control system 34 of FIG. 17) for adapting models of physical systems using transfer learning or adaptation techniques (e.g., Jacobian Feature Regression) in both online and offline modes. For example, the method 2092 may include initially training, via the analysis and control system 34, a model of a physical system (e.g., equipment 1756, 1758 illustrated in FIG. 17). The model of the physical system includes a data-driven model or a hybrid model that includes a combination of a physics-based definition of the physical system and data collected relating to the physical system (block 2094). The method 2092 may also include utilizing, via the analysis and control system 34, transfer learning or adaptation techniques of the model of the physical system to adapt the model of the physical system (block 2096). The method 2092 may also include deploying, via the analysis and control system 34, the adapted model of the physical system to a deployment environment to enable prediction of one or more operational parameters of the physical system (block 2098).

In addition, in certain embodiments, the method 2092 may include utilizing, via the analysis and control system 34, JFR of the model of the physical system to adapt the model of the physical system. In addition, in certain embodiments, the method 2092 may include automatically controlling, via the analysis and control system 34, the one or more operational parameters of the physical system based at least in part on the adapted model of the physical system. In addition, in certain embodiments, the method 2092 may include utilizing, via the analysis and control system 34, the transfer learning or adaptation techniques on a state-space formulation of the hybrid model of the physical system to adapt the model of the physical system. In addition, in certain embodiments, the model of the physical system comprises a recurrent neural network (RNN). In addition, in certain embodiments, the method 2092 may include utilizing, via the analysis and control system 34, the transfer learning or adaptation techniques on a state-space formulation of the model of the physical system based at least in part on data detected from the physical system that changes during operations of the physical system to adapt the model of the physical system. In addition, in certain embodiments, the method 2092 may include utilizing, via the analysis and control system 34, the transfer learning or adaptation techniques on the state-space formulation of the model of the physical system based at least in part on data detected in a controlled environment separate from the physical system to adapt the model of the physical system.

### Detailed Description of Application D

RUL of equipment may be predicted via predictive maintenance algorithms. Typically, there are a few approaches to predicting the RUL of a system: (a) model-based approaches, (b) data-driven approaches, or (c) hybrid models that combine model-based with data-driven techniques. In model-based approaches, the system is typically represented as a set of equations governing the operation of the particular system, and one needs a nominal model of the system as well as multiple fault progression models. One has to first detect and isolate the fault and quantify the fault magnitude, and using this fault magnitude as a starting point, simulate the fault progression model into the future to estimate the RUL. More often than not, it is relatively difficult to reduce the possible fault models to one fault and, hence, multiple fault progression models have to be simulated in time, which is not computationally efficient. With the rise of data-driven methods, it is also possible to learn the representation of a system using completely data-driven methods, as well as using a hybrid combination of the physical representation and data-driven methods. Data-based approaches (with a sufficiently large number of layers and parameters) may be able to capture both the nominal as well as fault progression using one model, but typically they are re-trained after the fault has been detected and a sufficient amount of failure data has been collected, leading to a delay in RUL prediction as also computational inefficiency.

The possibility of learning hybrid models representing both the nominal and fault dynamics of the system opens up doors for updating the representation of the system with real-life data in an efficient way so as to ensure that the representation of the system is always close to the real-life system. This helps ensure that the predicted RUL is always taking into account any sort of degradation or changes in operating conditions that may impact the behavior of the physical system. The RUL predicted using such an updated system is more accurate as it is aware of the present state of the system.

Many possible methods are available that enable this “updating/adaptation” of the model, such as retraining of ML models, recalibration of the model parameters based on some initially collected field data, and so forth. However, many of these approaches are computationally expensive and cannot be used in dynamic, fast-changing environments that need quick recalibration requirements compared to a complete re-training of the ML model that is typically both data- and time-intensive.

Certain existing techniques, for example, the techniques for performing recalibration through Jacobian Feature Regression (JFR) of a lab-developed model to the field environment based on a Forgione approach present certain challenges. The Forgione approach uses a recurrent neural network (RNN) to model the dynamic system, and this nominal RNN is trained on available measurements. Then, it is assumed that the system dynamics change, causing the nominal RNN to not be accurate enough for predicting the observed measurements in the presence of these perturbed system dynamics. In other words, an unacceptable degradation of the nominal model performance occurs. A transfer learning approach to improve the performance of the nominal model in the presence of perturbed system dynamics is proposed, where the nominal model is augmented with additive correction terms that are trained on the currently observed “perturbed-system” data; and these correction terms are learned through a JFR method “defined in terms of the features spanned by the model's Jacobian concerning its nominal parameters”.

The embodiments described herein address the shortcomings of the Forgione approach and other similar techniques by providing an improved approach for recalibrating model parameters of retrained machine learning (ML) models based, for example, on data collected during operation of the physical systems being monitored. The embodiments described herein extend the implementation of JFR (or other suitable transfer learning or adaptation techniques) to hybrid models and demonstrates that this approach works faster and more accurately than retraining these machine learning (ML) and physics-informed machine learning (PIML) models. The other techniques are based on incoming data, fine-tuning, and using active learning-based approaches to retrain models. In addition, the other techniques also include learning corrective terms, corrective models, and full retraining of the models from scratch. In addition, the embodiments described herein extend the workflows described herein for PHM-based use cases, for example, use cases that are focused on utilizing JFR or other suitable transfer learning or adaptation techniques to improve the robustness of PHM solutions.

The embodiments described herein also demonstrate the use of such adapted models to make the RUL prediction more robust. The approach presented in the Forgione approach inherently works in offline mode, where the adaptation happens once it is triggered based on some prior knowledge or analysis. The embodiments described herein also demonstrate how the offline adaptation approach may be modified into an online adaptation technique. In addition, using JFR for online adaptation removes the burden of modeling different fault progression models and simulating these models in parallel to predict the correct RUL. In addition, the embodiments described herein provide a workflow to utilize the adaptation technique (offline as well as online) in order to have a more accurate and robust estimation of RUL for data-driven and hybrid models without needing to build multiple fault propagation models or having to retrain the model from scratch after collecting a sufficient amount of failure data. Finally, the embodiments described herein also demonstrate the application of the online and offline adaptation algorithms on applications relevant to the oil and gas industry, such as membranes, compressors, and so forth.

As described above, the embodiments described herein build upon developed JFR algorithms by demonstrating a workflow to utilize the adaptation technique (offline as well as online) in order to have a more accurate and robust estimation of RUL of equipment 1756, 1758 for data-driven and hybrid models without needing to build multiple fault propagation models or having to retrain the model from scratch after collecting a sufficient amount of failure data; and demonstrating the application of the online and offline adaptation algorithms on applications relevant to the oil and gas industry, such as membranes, compressors, and so forth. In addition, the embodiments described herein also extend the implementation of JFR (or other suitable transfer learning or adaptation techniques) to physics-informed neural networks modeled using a state-space formulation; demonstrate that JFR is more sustainable than other retraining and transfer learning methods; and demonstrate how an offline adaptation approach may be modified into an online adaptation technique. Because of the wide-scale demand and applicability of estimating the RUL of a physical system (e.g., equipment 1756, 1758), the embodiments described herein may be useful for many applications, being particularly relevant for Asset Performance Management (APM) workflows.

FIG. 21 illustrates a workflow 2164 describing how an adaptation technique can adapt a model that is trained/learned in a controlled setting to predict RUL of equipment 1756, 1758 of FIG. 17. In particular, FIG. 21 presents an overall approach for using JFR (or other suitable transfer learning or adaptation techniques) for adapting models for predicting RUL. The physical system 2166 can be any asset (e.g., equipment 1756, 1758) for which prediction of RUL is desired. Typically, input signals (denoted by X) are known and measured sensor readings (denoted by Y) are obtained via the sensors 1744, 1746 described above with reference to FIG. 17. From these, Model M may be built that can help predict the RUL of the physical system 2166. Additionally, Model M can be based on hypothesized future inputs (denoted by Future X). As described in greater detail herein, the Model M may be trained using data-driven approaches or hybrid approaches that combine model-based with data-driven approaches. Model M may be built and trained with input-output signals using an M.fit( ) algorithm 2168. Typically, nominal X and Y combinations may be used to build Model M. Once Model M is trained, it may be deployed and denoted by M_deployed model 2170, and this deployed Model M may be used as an RUL Estimator 2172 to predict the future outputs of the M_deployed model 2170, and depending on when these outputs cross a failure threshold, determine the RUL of the physical system 2166.

If there is no degradation in the physical system 2166, the M_deployed model 2170 would forever be able to correctly predict (denoted as M_deployed.predict( ) 2174 the future observations of the physical system 2166. However, engineered systems 2166 eventually encounter some sort of degradation or failure. As such, one way to adapt to this changing M_deployed model 2170 would be to retrain the M_deployed model 2170 for every new pair of X and Y. The process of retraining the M_deployed model 2170 can be computationally expensive. Hence, to intelligently call the model update, an M.model_drift_detector( ) algorithm 2176 may be developed and deployed that compares the predictions of the M_deployed model 2170, and the data collected by the sensors 44, 46 associated with the physical system 2166 to see if there is a statistically significant drift between the predicted and observed sensors. If there is a significantly significant drift (determined at block 2178), then while there are many reasons for which this drift could occur, the drift may be attributed to degradation in the physical system 66 that are not captured by the M_deployed model 2170 anymore, and the parameters of this M_deployed model 2170 need to be re-calibrated or adapted to the newly observed data collected by the sensors 44, 46. If that is the case, then the JFR algorithm (denoted by the M.Adapt( ) function 2180) may be used to adapt the M_deployed model 2170 to the new data observed. This adapted model is denoted as M_adapted 2182 and now replaces the M_deployed model 2170, and the process continues as significant deviation is detected in the sensor readings predicted by the M_deployed model 2170 and the observed sensor readings associated with the physical system 2166. It will be appreciated whether any such deviations are significant enough to consider that substantial degradation in the ability of the M_deployed model 2170 to estimate the actual sensor readings for the system 2166 may be based on whether the deviations in predicted versus actual values of the sensor readings are greater than predetermined thresholds.

FIGS. 22A and 22B illustrate more algorithmic details of the M.fit( ) 2168, M.model_drift_detector( ) 2176, M.adapt( ) 2180, and RUL Estimator 2172 blocks of the workflow 2164 of FIG. 21. As illustrated in FIG. 22A, the M.fit( ) algorithm 2168 may take the training data X, and compare the estimated outputs Y from the M_deployed model 2170 versus the actual sensor reading outputs Y (e.g., as collected by the sensors 1744, 1746 of FIG. 17) with reference to a loss function 2184, which feeds loss into an optimizer algorithm 2186 to determine the M_deployed model 2170. In addition, the M.fit( ) algorithm 2168 may utilize newly collected parameter data to continuously update the M_deployed model 2170.

Then, the M_deployed model 2170 may receive newly collected inputs X after deployment, which may be used to determine measured outputs Y on which drift detection 2188 may be performed by the M.model_drift_detector( ) 2176 to detect if there are any deviations in the prediction of the M_deployed model 2170 and the actual output associated with the physical system 2166. If degradation is detected (e.g., in block 2178), then the M_deployed model 2170 may be adapted by the M.Adapt( ) function 2180 using data collected from the sensors (e.g., 1746, 1748 of FIG. 17) before and after the degradation to determine measured outputs Y on which the model adaptation 2190 (using the JFR algorithm) of the M.Adapt( ) function 2180 may adapt the M_deployed model 2170 to generate the M_adapted model 2182.

Finally, the M_deployed model 2170 (e.g., before adaptation) or the M_adapted model 2182 (e.g., after adaptation) may use future inputs X to generate future outputs Y, which may be used by an RUL predictor algorithm 2192 of the RUL Estimator 2272 to determine an RUL 2194 of the physical system 2166 based at least in part on a system-specific threshold.

FIG. 22A also illustrates an example timeline 2196 for use of the workflow 2164 illustrated in FIGS. 21, 22A, and 22B over time. For example, as discussed in conjunction with FIG. 17, the timeline 2196 illustrates points in time where the analysis and control system 1734 begins collecting data (e.g., using the sensors 1744, 1746 of FIG. 17), when the analysis and control system 1734 learns and deploys the model, when degradation of the model may be assumed to have started, when the degradation of the model is detected by the analysis and control system 1734, and when the model is adapted by the analysis and control system 1734, as described in greater detail herein.

As such, the embodiments described herein enable the determination of RUL of physical systems 2166 (e.g., equipment 1756, 1758) based on hybrid models (e.g., a combination of a physics-based definition of the physical systems 2166 and data collected relating to the physical systems 2166) that are adapted (e.g., automatically, in certain embodiments) based on JFR of the hybrid models when degradations of the hybrid models of the physical systems 2166 are detected (e.g., automatically, in certain embodiments). The embodiments described herein may be extended to any applications requiring the use of RUL. Integrating the proposed techniques in such applications may help enhance the overall effectiveness of the applications.

The embodiments described herein provide improvements over existing technologies insofar as the showcase that the techniques utilize less power, contributing to fewer carbon emissions. The relatively fast and robust adaptation of the hybrid models enable the hybrid models to be “evergreen” and “constantly updated”, for example, adapting to wear and tear and other degradation of the physical systems 2166. As a result, the embodiments described herein make PHM processes more reliable by ensuring that the models of the physical systems 2166 are continuously adapted to reflect the most up-to-date and true representation of the state of the physical systems 2166.

In addition, the embodiments described herein help ensure that the prediction of RUL always considers any sort of degradation or changes in operating conditions that may impact the behavior of the physical systems 2166. The RUL predicted using such an updated physical system 2166 is more accurate as it is aware of the present state of the physical system 2166. Furthermore, accurate and robust estimation of RUL helps in optimizing the overall decision-making process.

FIG. 23 illustrates a flow diagram of a method 2300 (e.g., to be at least partially performed by the analysis and control system 1734 of FIG. 17) for estimating RUL of a physical system (e.g., 2166 and 2266 of FIGS. 21 and 22) based on adaptive system representation, as described in greater detail herein. For example, the method 2300 may include initially training, via the analysis and control system 1734, a model 2170 of a physical system 2166. The model 2170 of the physical system 2166 includes a data-driven model or a hybrid model that includes a combination of a physics-based definition of the physical system 2166 and data collected relating to the physical system 2166 (block 2302). The method 2300 may also include detecting, via the analysis and control system 1734, deviations of one or more outputs of the model 2170 of the physical system 2166 relative to data collected by one or more sensors 1744, 1746 associated with the physical system 2166 during operation of the physical system 2166 (block 2304). The method 2300 may also include determining, via the analysis and control system 1734, that degradation in an ability of the model 2170 of the physical system 2166 to estimate performance of the physical system 2166 has occurred based at least in part on the detected deviations (block 2306). The method 2300 may also include utilizing, via the analysis and control system 1734, transfer learning or adaptation techniques of the model 2170 of the physical system 2166 to adapt the model 2170 of the physical system 2166 (block 2308). The method 2300 may also include estimating, via the analysis and control system 1734, an RUL of the physical system 2166 based on the adapted model 2182 of the physical system 2166 (block 2310).

In addition, in certain embodiments, the method 2300 may include utilizing, via the analysis and control system 1734, JFR of the model 2170 of the physical system 2166 to adapt the model 2170 of the physical system 2166. In addition, in certain embodiments, the method 2300 may include automatically controlling, via the analysis and control system 1734, one or more operational parameters of the physical system 2166 based at least in part on the estimated RUL of the physical system 2166. In addition, in certain embodiments, the method 2300 may include determining, via the analysis and control system 1734, that the degradation in the ability of the model 2170 of the physical system 2166 to estimate the performance of the physical system 2166 has occurred, in response to detecting that the deviations of the one or more outputs of the model 2170 of the physical system 2166 relative to the data collected by the one or more sensors 1744, 1746 associated with the physical system 2166 are greater than predetermined thresholds. In addition, in certain embodiments, the method 2300 may include continuously monitoring, via the analysis and control system 1734, the one or more sensors 1744, 1746 to automatically detect the deviations of the one or more outputs of the model 2170 of the physical system 2166 relative to the data collected by the one or more sensors 1744, 1746 associated with the physical system 2166 during operation of the physical system 2166. In addition, in certain embodiments, the method 2300 may include utilizing, via the analysis and control system 1734, the transfer learning or adaptation techniques on a state-space formulation of the model 2170 of the physical system 2166 to adapt the model 2170 of the physical system 2166. In addition, in certain embodiments, the model 2170 of the physical system 2166 includes an RNN.

### Detailed Description of Application E

It is relatively important to be able to accurately and effectively ascertain how well predictive maintenance algorithms are predicting the RUL of equipment, taking into account changes relating to the equipment and an overall system of which the equipment is part, as well as the fact that certain relatively important data may be missing. Doing so enables operators of the equipment to make more effective planning decisions including, but not limited to, deciding when to replace the equipment, when to make other changes relating to other equipment of the shared system, and so forth. To this end, the embodiments described herein provide an online methodology and associated metrics to more accurately and effectively evaluate the predictive performance of RUL prediction algorithms, for example, when ground truth or true RUL data is not available. The generated metrics may then be integrated into service-level indicators to be tracked, for example, via live online-enabled dashboards.

As described in greater detail herein, since ground truth failure data may not be available, certain sensor values may be assumed at particular times to be ground truth and be used to evaluate how well RUL prediction algorithms are currently predicting past measurement predictions up until the particular times (i.e., the current values of the sensors), and past RUL predictions up until the particular times (i.e., the time to reach the current values at multiple earlier times). In certain embodiments, the evaluation may give more weight to more recent predictions than to older predictions using different weighting schemes, and may generate service-level indicators for RUL prediction algorithm performance. As used herein, the term “ground truth data” is intended to refer to actual measurement data relating to equipment that is detected (e.g., using real-world sensors associated with the equipment) and may be used to train machine learning and/or artificial intelligence (AI) algorithms, as described in greater detail herein.

It should be noted that the RUL evaluation framework described herein is independent of the particular RUL prediction algorithms and can be applied to any and all prediction algorithms. In addition, as described above, an advantage of the RUL evaluation framework described herein lies in its ability to work without actual run-to-failure (ground truth) data, which is generally the most expensive to collect.

FIG. 24 illustrates an example system 2410 having a plurality of different pieces of equipment 2412 that may be utilized to accomplish the specific functions of the system 2410. The system 2410 may correspond to the oil and gas production systems 1610 of FIG. 16. A s illustrated, in certain embodiments, the system 2410 may include various sub-systems 2411 that are configured to perform certain functionalities that enable the overall functions of the system 2410 as a whole. It will be appreciated that many of the types of equipment 2412 that are described herein may, in certain embodiments, be production equipment 2412 configured to accomplish production goals for a production system 2410. For example, FIGS. 16 and 17 illustrate a specific example of an oil and gas production system 2410 comprising various types of oilfield equipment 2412. However, it should be noted that the techniques described herein may be extended to any conceivable type of system 2410 that utilizes myriad equipment 2412 to achieve objectives of the system 2410. For example, the techniques described herein may be utilized in product manufacturing systems 2410 utilizing various product manufacturing equipment 2412, maintenance systems 2410 utilizing various maintenance-related equipment 2412, and so forth.

Now with reference to FIG. 16, as described in greater detail herein, data relating to various pieces of production equipment 2412 at each of the locations illustrated in FIG. 24 may be analyzed to determine RUL of the production equipment 2412 using the techniques described herein. Furthermore, the analytic techniques described herein may be extended to other types of systems 2410 other than the oil and gas production systems 1610 of FIG. 16.

With reference to FIG. 17 in conjunction with FIG. 24, in certain embodiments, the computer-executable instructions of the one or more analysis modules 1736, when executed by the one or more processors 1738, may cause the one or more processors 1738 to generate one or more models. Such models may be used by the analysis and control system 1734 to predict the RUL of equipment 2412 despite the fact that certain relatively important data, such as ground truth data and true RUL data, may not be available, as described in greater detail herein. In addition, the models may also be used to evaluate the accuracy of such RUL prediction for the equipment 2412, as described in greater detail herein.

Over time, performance of the equipment 2412 may change, for example, as the equipment 2412 gets older. In addition, systems 2410 of which the equipment 2412 area part may change, for example, when other equipment 2412 is added or removed from the systems 2410, when production (or other productivity) targets for the systems 2410 change, and so forth. As such, the models used to evaluate the performance of the equipment 2412 may need to adapt to such changes that occur over time. Therefore, the evaluation of the RUL prediction described herein may be based on the continually-adapted models. Indeed, the one or more analysis modules 38 may be configured to determine when the models of the equipment 2412 need to be modified to enable more accurate RUL prediction, as described in greater detail herein. In certain embodiments, the models may be modified when prompted by an operator (e.g., interacting with graphical user interfaces, as described in greater detail herein). However, in other embodiments, the models may be automatically (e.g., without human intervention) modified by the one or more analysis modules 1736 when the RUL prediction is evaluated to not be acceptable, as described in greater detail herein.

As such, the embodiments described herein enable the determination of RUL of equipment 2412 (e.g., the equipment 1756, 1758 illustrated in FIG. 17, as well as the various equipment illustrated in FIG. 16) based on models that are adapted (e.g., automatically, in certain embodiments) when degradations of the models of the equipment 2412 are detected (e.g., automatically, in certain embodiments). In certain embodiments, the models may be hybrid models (e.g., a combination of: (1) a physics-based definition of the equipment 2412 and/or system 2410 of which the equipment 2412 is part and (2) data collected relating to the equipment 2412 and/or system 2410 of which the equipment 2412 is part). The embodiments described herein may be extended to any applications requiring the use of RUL. Integrating the proposed techniques in such applications may help enhance the overall effectiveness of the applications.

In certain embodiments, the one or more processors 1738 may include a microprocessor, a microcontroller, a processor module or subsystem, a programmable integrated circuit, a programmable gate array, a digital signal processor (DSP), or another control or computing device. In certain embodiments, the one or more processors 1738 may include machine learning and/or artificial intelligence (AI) based processors, which may be used to train the models described herein to be capable of both predicting RUL of equipment 2412 as well as evaluating the accuracy of such RUL prediction (and, in certain embodiments, adjusting models of the equipment 2412 when the RUL prediction is evaluated as being unacceptable), as described in greater detail herein.

As described above, the embodiments described herein both enable the prediction of RUL of equipment 2412 using predictive maintenance algorithms as well as ascertaining how well the predictive maintenance algorithms predict the RUL of the equipment 2412 over time, for example, as changes occur with respect to the equipment 2412 and/or a system 2410 of which the equipment 2412 is part.

FIG. 25 illustrates a workflow 2500 for predicting RUL of equipment 2412 as well as evaluating the accuracy of the RUL prediction. For example, a particular piece of equipment 2412 (that may for example correspond to production equipment 1756, 1758 illustrated in FIG. 17, as well as the various equipment illustrated in FIG. 16) may have sensor data associated with operation of the equipment 2412, which may be collected over time (e.g., by the sensors 1744, 1746 illustrated in FIG. 17) and, for example, stored in a database (e.g., block 2468). As used herein, sensor data from X sensors (e.g., the sensors 1744, 1746, described with reference to FIG. 17) are named SN₁, SN₂, . . . , SNₓ for sensors 1 through X, and are taken at different time steps T₂, T₂, . . . , T_{N} for time steps 1 through N. In addition, as used herein, the measured values are denoted as vals[SNᵢ][Tⱼ] for sensor SNᵢ at time Tⱼ. In addition, in certain embodiments, an optional value of a health indicator threshold at each time Tⱼ, denoted as meas_threshold[Tⱼ], may also be stored.

In addition, an RUL prediction algorithm 2570 may be used to generate prognosis data, which may also be stored in a database (e.g., at block 2572). For example, similar to the sensor data that is collected, the prognosis data may be generated at prediction time steps TP₁, TP₂, . . . , TP_{Q} for each sensor SNᵢ. The values estimated by the RUL prediction algorithm 2570 at the various time steps are denoted as RUL prediction vals[SN][TPⱼ]. Other data that may be optionally stored include variances of these predictions (e.g., denoted by vars[SNᵢ][TPⱼ]). In addition, for each time step TPⱼ, the predicted RUL values (e.g., denoted by RULᵥₐₗ[TPⱼ]) may be stored. AIso, in certain embodiments, variances of the predicted RUL values (e.g., denoted by RULᵥₐᵣ[TPⱼ]) and a health indicator value (e.g., denoted by health_indicator[Tⱼ]) may be optionally stored.

In addition, as described in greater detail herein, a predictive health monitoring (PHM) evaluation algorithm 2574 may use the sensor data and the prognosis data (e.g., stored in blocks 2568, 2572) to generate at least three outputs at a particular time of evaluation 2576, namely, measurement-based PHM evaluation results 2578, RUL-based PHM evaluation results 2580, and a service-level indicator 2582 that summarizes the overall performance of the RUL prediction algorithm 2570 (e.g., the accuracy of the prediction of RUL for the equipment 2412). As described in greater detail herein, each of these outputs may be presented to an operator via a live, online-enabled dashboard displayed, for example, on a graphical user interface via computing system 2562 (e.g., as illustrated in FIG. 17).

In general, a “look-back” evaluation window may first be defined, during which the performance of the RUL prediction algorithm 2570 may be evaluated. The look-back evaluation window may include a set number of prediction data points (e.g., denoted as N_{lookback}) that were generated during a time window looking back from a current time of evaluation 2576 (e.g., the time window being denoted as W_{lookback}). In general, W_{lookback} may be converted into N_{lookback} if the prediction is performed at fixed time intervals of r time units (e.g., that N_{lookback}=W_{lookback}/τ). However, in certain embodiments, the time intervals may vary and, indeed, may be manually or automatically adjusted, as described in greater detail herein.

Using this approach, three such look-back windows may be defined: (1) a first look-back window for determining measurement-based PHM evaluation results 2578 (e.g., denoted by W_{lookback_meas}), (2) a second look-back window for computing RUL-based PHM evaluation resultsv80 (e.g., denoted by W_{lookback_RUL}), and a third look-back window for computing the service level indicator (e.g., denoted by W_{lookback_sLI}). The usage of these three look-back windows will be described in greater detail below.

### Measurement-Based PHM Evaluation

For the measurement-based PHM evaluation 2578, the current time may be denoted as t, and zₜ(t) may denote the true value of sensor z made at time t. At each time step t, look-backs at t_{meas_eval}∈N_{lookback_meas} predictions may be made. Now, if zₜ(t_{meas_eval})≤±error_bound_meas, then zₜ(t_{meas_eval})∈{acceptable_points}, else, zₜ(t_{meas_eval})∈{unacceptable_points}. In other words, for each time step t where true values of a particular sensor z are within a measurement error bounding value (e.g., error_bound_meas), the data points may be considered acceptable. Otherwise, the data points may be considered unacceptable. Then, eval_verdict_meas may be computed using a weighting function based on the acceptable_points and the unacceptable_points. For example, an example weighting function may be eval_verdict_meas=weighting_function({acceptable_points}∪{unacceptable_points}).

FIG. 26 illustrates a graph 2600 of example results of the measurement-based PHM performance evaluation 2578 (e.g., using the PHM evaluation algorithm 2574). In the illustrated example, the flux (e.g., flow rate) associated with a particular piece of equipment, e.g., the equipment 2412 of FIG. 24, 25, at five time steps t (e.g., 80 days, 100 days, 120 days, 140 days, and 160 days) relative to a time of evaluation (e.g., 160 days) are considered. As illustrated, the prediction of the flux at each of the look-back prediction data points are evaluated as being acceptable (e.g., within error_bound_meas). Therefore, in the illustrated example, eval_verdict_meas would be equal to 1.0 insofar as all of the data points are considered acceptable_points (as indicated by element number 2686 in FIG. 26). However, if any of the data points had been considered unacceptable_points, then eval_verdict_meas would be less than 1.0 based on which particular weighting function is used.

There are many various types of weighting functions that may be implemented. For example, some example weighing functions may include, but are not limited to: (1) unweighted mean (e.g., where a simple majority of acceptable_points versus unacceptable_points is determined), (2) custom weighted average, (3) nonlinearly increasing weights, (4) linearly increasing weights, and (5) exponentially increasing weights. The goal of having different weighting schemes is to give more weight to nearer predictions (e.g., time steps immediately before the time of evaluation) than predictions made farther back in time. In general, if eval_verdict >=0.5, then the performance is deemed to be acceptable so far. Otherwise, the performance is deemed to be unacceptable.

Table 1 illustrates example details of how the various weighting functions may be used to determine eval_verdict. wᵢ denotes a weighting value at a particular look-back time point i. t^{eval} t^{start}, and t^{end} denote time of evaluation, start time of the look-back window, and end time of the look-back window, respectively. FIG. 27 illustrates example weighting functions. In particular, FIG. 27 illustrates weighting values at various data points for nonlinearly increasing weights, linearly increasing weights, and exponentially increasing weights where the time of evaluation is t=100 days and the look-back window is t=0 days through t=100 days. As illustrated, each weighting function weighs data points nearer to the time of evaluation more than data points further back in time from the time of evaluation. However, the degree to which the weighting functions increase as they are closer to the time evaluation varies.

TABLE 1
Various weighting functions that may be used to determine eval_verdict.

| | |
|---|---|
| Unweighted mean | $eval\_verdict = \frac{\sum acceptable\_points}{\sum acceptable\_points + \sum unacceptable\_points}$ |
| Custom weighted average | $eval\_verdict = \frac{\sum {w}_{i} \times acceptable\_points}{\sum {w}_{i}}$ |
| Nonlinearly increasing weights | ${w}_{i} = \frac{1}{{t}^{current} - {t}_{i}^{eval} + 1 {e}^{- 8}}$ |
| | $eval\_verdict = \frac{\sum {w}_{i} \times acceptable\_points}{\sum {w}_{i}}$ |
| Linearly increasing weights | ${w}_{i} = \frac{{t}_{i}^{eνal}}{{t}^{end} - {t}^{start}}$ |
| | $eval\_verdict = \frac{\sum {w}_{i} \times acceptable\_points}{\sum {w}_{i}}$ |
| Exponentially increasing weights | ${w}_{i} = \frac{{t}^{eνal}}{{t}^{end} - {t}^{start}}$ |
| | $eval\_verdict = \frac{\sum {w}_{i} \times acceptable\_points}{\sum {w}_{i}}$ |

### RUL-Based PHM Evaluation

The RUL-based evaluation scheme evaluates how well the RUL prediction algorithm 2570 predicted the RUL at different times in the past. Since ground truth RUL data is not present, the threshold may be assumed to be the current value of a sensor and a determination may be made as to how well the RUL prediction algorithm 2570 predicted an amount of time that was required at that point in time in the past to reach the current sensor reading value.

If the current time is t and θₑᵥₐₗ=threshold_function(zₜ(t)) is the evaluation threshold computed by a threshold function using sensors (e.g., the sensors 1744, 1746, described with reference to FIG. 17) and state variables at time t. Then, RUL true may be set to t. For each t_{meas_eval}, ∈prog_data[‘times’][−N_{lookback_RUL}):−1], the stored threshold values predicted at time t_{meas_eval}, may be evaluated by the PHM algorithm. These may be either stored beforehand or computer based on {Z(t_{meas_eval}), z(t_{meas_eval}+1), . . . , z(RULₜ(t_{meas_eval})}. Then, RULₜ(t_{meas_eval}) may be found and, if RULₜ(t_{meas_eval})≤±error_bound_RUL, then RULₜ(t_{meas_eval})∈{acceptable_points}; otherwise, RULₜ(t_{meas_eval})∈{unacceptable_points}. Finally, eval_verdict_RUL may be computed as weighting_function({acceptable_points}u {unacceptable_points}). As above with respect to the measurement-based PHM evaluation 2578, in general, if eval_verdict_RUL >=0.5, then the performance is deemed to be acceptable so far. Otherwise, the performance is deemed to be unacceptable.

FIG. 28 illustrates a graph 2800 of example results of the RUL-based PHM evaluation 2580 (e.g., using the RUL prediction algorithm 2570) of FIG. 25. In the illustrated example, the RUL of a particular piece of equipment 2412 of FIGS. 24 and 25, respectively, at five time steps t (e.g., 80 days, 100 days, 120 days, 140 days, and 160 days) relative to a time of evaluation (e.g., 160 days) are considered. As illustrated, the RUL at each of the look-back prediction data points prior to at the time of evaluation are determined to be acceptable (e.g., within error_bound_RUL, illustrated by area 2890). Therefore, in the illustrated example, eval_verdict_RUL would be equal to relatively close to 1.0 insofar as the previous four data points are acceptable_points (as indicated by element number 2886 in FIG. 28), whereas the most recent data point is the only unacceptable_point (as indicated by element number 2892 in FIG. 28).

### Computing a Service-Level Indicator for the PHM Algorithms

Finally, with continued reference to FIG. 25 in conjunction with FIG. 28 a service level indicator (SLI) 2582 for the overall performance of the RUL prediction algorithm may be determined by applying the same weighting schemes described above to either the measurement-based PHM evaluation labels or the RUL-based PHM evaluation labels, as described above. First, the SLI lookback window W_{lookback_SLI}, may be determined. Then, the SLI 2582 may be generated based on whether the measurement-based PHM evaluation labels or the RUL-based PHM evaluation labels are being used as the computing criteria. For example, if the RUL-based PHM evaluation labels are being used as the computing criteria, then eval_verdict SLI may be set equal to weighting_function({eval_verdict_meas}). Otherwise, if the measurement-based PHM evaluation labels are being used as the computing criteria, then eval_verdict SLI may be set equal to weighting_function({eval_verdict_RUL}).

FIG. 29 illustrates a graph 2900 of example results of how measured values 2996 of flux at a plurality of time steps t correlate to either eval_verdict or eval_verdict_RUL, depending on whether the measurement-based PHM performance evaluation 2566 (e.g., using the PHM evaluation algorithm 2574) or the RUL-based PHM evaluation 2580 (e.g., using the RUL prediction algorithm 2570) are used to determine the accuracy of the predictions. In the illustrated example, nine time steps t (e.g., 0 days, 20 days, 40 days, 60 days, 80 days, 100 days, 120 days, 140 days, and 160 days) relative to a time of evaluation (e.g., 160 days) are considered. As illustrated, only the three most recent of the nine total time steps t are considered as acceptable_points (as indicated by element number 2586 in FIG. 29). The SLI 2582 may be determined based on these three acceptable_points and the six other unacceptable points (as indicated by element number 2592 in FIG. 29) depending on which type of weighting function is used.

FIG. 30 illustrates an example of a graphical user interface (GUI) 3000 used to provide the dashboard of relevant graphs and metrics relating to the outputs illustrated in FIGS. 26, 28, and 29. The GUI 3000 may be provided to a computing system, e.g., the computing system 1762 of FIG. 17, used by an operator by the analysis and control system 1734 illustrated in FIG. 17. The GUI 3000 may present various graphs and metrics related to the RUL prediction algorithms and systems described herein, which are determined based on the sensor data stored at block 2568 and prognosis data stored at block 2572 in one or more databases, as described with reference to FIG. 25.

For example, as illustrated in FIG. 30, in certain embodiments, the GUI 3000 may present the graph 2600 of example results of the measurement-based PHM performance evaluation 2578, e.g., using the PHM evaluation algorithm 2574 of FIG. 25, described with reference to FIG. 26, the graph 2800 of example results of the RUL-based PHM evaluation 2580 (e.g., using the RUL prediction algorithm 2570) described with reference to FIG. 25, the graph 2900 of example results of how measured values of flux at a plurality of time steps t correlate to either eval_verdict or eval_verdict_RUL, depending on whether the measurement-based PHM performance evaluation 2578 (e.g., using the PHM evaluation algorithm 2574) or the RUL-based PHM evaluation 2580 (e.g., using the RUL prediction algorithm 2570) are used to determine the accuracy of the predictions, and the SLI 2582 that is calculated.

In addition, the GU 13000 may include an options pane 3001 within which an operator may make select certain options for the analysis of the RUL prediction described herein. As illustrated, the options displayed in the options pane 3001 may include a Time of Evaluation slider 3002 that is used to select the particular time of evaluation from which the look-back windows are determined. In addition, the options displayed in the options pane 3001 may include an SLI Window Length slider 3004 that defines the number of data points that may be used from the time of evaluation as the look-back window for evaluation of the SLI 2582. In addition, the options displayed in the options pane 3001 may include a Weighting Scheme for SLI drop-down box 3006 used to select an SLI weighting scheme used to determine the SLI 2582, the weighting schemes being described in greater detail above.

It is noted that the SLI window length (e.g., selected via the SLI Window Length slider 3004) that defines the number of data points that may be used from the time of evaluation as the look-back window for evaluation of the SLI 2582 may be different than a an evaluation window length (e.g., which may be selected via an Evaluation Window Length slider 3008) that defines the number of data points that may be used from the time of evaluation as the look-back window for evaluation of the RUL based on whether the RUL prediction algorithm 2570 or the PHM evaluation algorithm 2574 are selected, for example, via an SLI Computation Reference drop-down box 3010.

As illustrated in FIG. 30, the options displayed in the options pane 3001 may also include a Weighting Scheme Measurements drop-down box 3012 and an Error Bound on Measurements slider 3014 to enable an operator to select a weighting scheme to be used for the measurements of the evaluation (e.g., the weighting schemes described in greater detail above) and an error bound on the measurements, respectively, if the PHM evaluation algorithm 2574 is used (e.g., when selected via the SLI Computation Reference drop-down box 3010). In addition, the options displayed in the options pane 3001 may also include a Weighting Scheme RUL drop-down box 3016 and an Error Bound on RUL slider 3018 to enable an operator to select a weighting scheme to be used for RUL of the evaluation (e.g., the weighting schemes described in greater detail above) and an error bound on RUL, respectively, if the RUL prediction algorithm 2570 is used (e.g., when selected via the SLI Computation Reference drop-down box 3010). In certain embodiments, the Weighting Scheme Measurements drop-down box 3012, Error Bound on Measurements slider 3014, Weighting Scheme RUL drop-down box 3016, and Error Bound on RUL slider 3018 may only be selectable when the associated evaluation scheme is selected via the SLI Computation Reference drop-down box 3010.

In addition, in certain embodiments, with continued reference to FIG. 30 in conjunction with FIGS. 17 and 24, the GUI 3000 may be configured to accept inputs from an operator when the RUL prediction is determined by the operator to not be acceptable, wherein the inputs may cause the analysis and control system 1734 to adapt models of the equipment 2412 being evaluated as the RUL prediction for the equipment 2412 changes over time, becoming unacceptable. As such, the models may be modified to, for example, take into account changes that occur relating to the equipment 2412 over time. In other embodiments, the analysis and control system 1734 may automatically (e.g., without human intervention) adapt the models of the equipment 2412, for example, when the analysis and control system 1734 automatically (e.g., without human intervention) determines that the models are no longer capable of accurately predicting RUL of the equipment 2412.

With reference now to FIG. 31 in conjunction with FIGS. 17, 24, and 25, FIG. 31 illustrates a flow diagram of a method 3100 for predicting RUL of equipment, e.g., the equipment 2412, and the various equipment 1756, 1758, and evaluating the accuracy of the RUL prediction. In certain embodiments, the method 3100 may include receiving, via the analysis and control system 1734, data relating to operation of equipment 2412 from one or more sensors (e.g., the sensors 1744, 1746) associated with the equipment 2412 (block 3122). In addition, in certain embodiments, the method 3100 may include predicting, via the analysis and control system 1734, an RUL of the equipment, e.g., the equipment 2412 based at least in part on the received data (block 3124). In addition, in certain embodiments, the method 3100 may include evaluating, via the analysis and control system 1734, an accuracy of the predicted RUL of the equipment 2412, during operation of the equipment 2412, (block 3126). As such, the embodiments described herein enable not only the prediction of an RUL of equipment 2412, but also the evaluation of the accuracy of such RUL prediction, during operation of the equipment 2412, in an iterative manner to, for example, enable operators of the equipment 2412, to make decisions to enhance the RUL for the equipment 2412, and/or to adjust operations of a system 2410 of which the equipment 2412, is a part.

In addition, in certain embodiments, the method 3100 may include evaluating, via the analysis and control system 1734, the accuracy of the predicted RUL of the equipment 2412 using measurement-based PHM evaluation algorithms 2578. Alternatively, or in addition to, in certain embodiments, the method 3100 may include evaluating, via the analysis and control system 1734, the accuracy of the predicted RUL of the equipment 2412 using RUL-based PHM evaluation algorithms 2580. Regardless of the particular PHM algorithms 2578, 2580 used, in certain embodiments, the method 3100 may include evaluating, via the analysis and control system 1734, the accuracy of the predicted RUL of the equipment 2412 by analyzing data points in a look-back window measured from a time of evaluation 2576. In addition, in certain embodiments, the method 3100 may include evaluating, via the analysis and control system 34, the accuracy of the predicted RUL of the equipment 2412 by applying a weighting scheme (e.g., the various weighting schemes described with reference to Table 1) to the data points in the look-back window measured from the time of evaluation 2576. For example, in certain embodiments, the weighting scheme is selected by an operator of the equipment 2412.

In addition, in certain embodiments, the method 3100 may include predicting, via the analysis and control system 1734, the RUL of the equipment 2412 based at least in part on a model of the equipment 2412. In addition, in certain embodiments, the method 3100 may include calculating, via the analysis and control system 1734, an SLI 2582 relating to the accuracy of the predicted RUL of the equipment 2412; and adjusting, via the analysis and control system 34, the model of the equipment 2412 in response to determining that the SLI 2582 is below a predetermined threshold (e.g., below 0.5, in certain embodiments). In addition, in certain embodiments, the method 3100 may include automatically (e.g., without human intervention) controlling, via the analysis and control system 1734, one or more operational parameters of the equipment 2412 based at least in part on the predicted RUL of the equipment 2412. As such, the analysis and control system 1734 may be capable of making adjustments to the performance of the equipment 2412 to enhance the RUL of the equipment 2412 during operation of the equipment 2412.

As described herein, the disclosed techniques are capable of evaluating RUL prediction algorithms in the absence of ground-truth failure data. The embodiments described herein have been validated for several different types of equipment 2412 including, but not limited to acid gas separation membranes, power unit bushings, coalescer filter, and hot oil heaters. However, it is believed that the embodiments described herein may be extended to the analysis of any types of equipment 2412 and related systems 2410.

The embodiments described herein enable the presentation of RUL-related metrics, which can demonstrate the accuracy of RUL prediction that is not heretofore available. By providing concrete evidence that long-term RUL predictions for equipment 2412 are scientifically valid, consistent, and valuable, operators of the equipment 2412 can be more confident about business decisions that are made based on such RUL predictions, thereby optimizing their operations and reducing maintenance costs through asset utilization, increased efficiency, and reduced downtime.

All presently known metrics for evaluating the performance of RUL prediction algorithms rely on ground truth RUL (e.g., that are determined after actual failures) to help operators validate the performance of the algorithms. Therefore, these known techniques require such ground truth RUL data to be available. The embodiments described herein can be implemented without the availability of such ground truth RUL information (e.g., during the life of the equipment 2412), thereby enabling operators to assess the quality of the RUL prediction algorithms at any time during operation of the equipment 2412.

### Present Application

### Term Harmonization Between Detailed Descriptions of Applications a-E and with the Detailed Description of Present Application

| | Equivalent Term(s) used in |
|---|---|
| Terms used in Applications A-E | Present Application |
| Target system (in Application B) | System of Interest (SOI) |
| Physical system (Application, C, D) | System of Interest (SOI) |
| Equipment (Application E) | System of Interest (SOI) |
| laboratory or machine shop setting | Laboratory environment |
| (Application C) | |
| field/real-world environment, deployment | Production environment |
| environment, fielded environments | |
| (Application C) | |
| model M₀(Application C) | Simulation model (SM) |
| model M₁(Application C) | Adapted simulation model |
| | (AS model) |

### Detailed Description of Present Application

Aspects of the present disclosure provide apparatuses, methods, processing systems, and computer-readable mediums for an end-to-end AutoPHM framework. End-to-end in regard to PHM and the AutoPHM framework refers to the presence and implementation of core functionalities to enable a PHM system to operate. These core functionalities may include model simulations, anomaly detection, fault isolation, and RUL predictions. The AutoPHM framework may also include model adaptations and evaluations of RUL predictions.

A primary goal of PHM is to anticipate component failure and schedule asset maintenance with a “sense and response” approach for an SOT. Sense and response is where comparisons are made between measurements and desired values, and a system, e.g., an SOI, or its settings are adjusted accordingly. An SOI can be an asset that the PHM system manages, models, or provides outputs for, such as RUL predictions. Typically, RUL is a prediction of time, or remaining time, at which a system or component will no longer function nominally. This may be calculated using sensor measurement data, e.g., by multi-sensor data models. An SOI may include assets, equipment, machines, computing devices, software systems, and mechanical systems and associated components, e.g., a production line system, an oil pipeline, field equipment, etc.

PHM may utilize various data inputs, including sensors, and may compare data inputs to thresholds for detecting and reporting faults. Impending SOI failure information based on sensor detection and PHM algorithm analysis may be used to trigger logistics processes and resources to restore the SOI to full functionality. PHM may send notifications to planners or technicians within an organization to provide repairs or component upgrades.

Implementing PHM with accuracy and reliability usually presents a range of challenges. Failure to correctly design and build any one of the core functionalities of a PHM system may lead to erroneous system predictions and false alarms. If a PHM false alarm rate exceeds certain levels, then functional SOI components may be unnecessarily replaced resulting in additional equipment replacement costs, reduced system availability, e.g., unavailability during maintenance, depletion of spare components pools, and increasing maintenance and servicing workload. Therefore, if PHM is not correctly designed, built, and customized as a synchronized unified system for the specific SOI, with PHM core capabilities correctly integrated, PHM may become more expensive than simply operating the SOI or its components to natural failure. False alarms and PHM unreliability may also lead to human operators ignoring PHM alarms, missing operational faults, and failing to act to adequately maintain the SOI.

Building a performant PHM system involves advanced programming and component integration, both of which use a large amount of human and compute resources. Other technical challenges of building a performant PHM system include difficulties in extrapolating between faults modes (and magnitudes) of SOIs in lab settings and in production environments. This is because lab conditions are generally controlled while production environments are uncontrolled and exposed to uncertainties and unknown variables.

Additionally, developing system degradation and fault progression models for accurate RUL prediction is technically complex due to the large number of interconnected PHM system components used to produce accurate data, e.g., for RUL predictions. Accurate RUL predictions for a particular SOI helps in decision-making by providing necessary information for planning of component or SOI replacement or maintenance activities.

PHM systems may leverage SM s of an SOI. However, calibrating the parameters of SM s is a technically complex and resource intensive process. SM s built using data-driven approaches, e.g., ML models, are heavily dependent on training data quality. Unreliability of an underlying SM can result in failures by the PHM system, which in turn can lead to system or component failures.

Therefore, there is a need for a PHM building framework that overcomes the aforementioned technical challenges to systematically and quickly generate reliable PHM systems. Aspects disclosed herein present an end-to-end generalizable AutoPHM framework to generate, execute, and manage PHM systems. The AutoPHM framework enables the automated and standardized building of customizable PHM systems, which can be created at scale using the AutoPHM framework.

In some aspects, the AutoPHM framework includes at least one of four core frameworks. The first is an automated and generalizable framework for generating new hybrid models, e.g., to model and simulate the SOI. The second is an automated and generalizable framework for generating AD models and fault isolators. The third is an automated model adaptation framework to continually adapt an SM of the SOI to accurately reflect a current state of a production (deployed) SOI. The fourth core framework is a PHM evaluation framework that evaluates the performance of an RUL model.

The disclosed AutoPHM framework also enables methods for automatic PHM implementation. One aspect may include a method for end-to-end PHM that includes receiving by an SM associated with an SOI, SOI data associated with the SOI to generate an SM output; receiving by an AD model, SOI production data from a production SOI to generate an AD model output; receiving by an A S model, at least one of the SM output, the SOI production data from the production SOI, a hypothesized future input, or the AD model output from the AD model to generate an estimated future output; and determining, by an RUL model, an RUL prediction of the production SOI based on the estimated future output. For example, the production SOI may correspond to the oil and gas production system 1610 of FIG. 16.

The technical benefits of the disclosed AutoPHM framework include reducing compute resource usage by standardizing the generation of the various models in the AutoPHM framework to implement the end-to-end PHM system. For example, the AutoPHM framework facilitates automatic standardized generation and execution of the models making up the core components of the automated PHM, e.g., SM, AD, and AS models, by using standardized repeatable automated frameworks to generate each core component of the AutoPHM framework. The standardized frameworks utilized by the AutoPHM framework reduce the amount of testing and use of computational resources dedicated for simulations and evaluations.

Additionally, the standardized frameworks of the AutoPHM framework use pre-designed model combinations that are known to integrate well with each other, reducing processing or computations for model integration. Using standardized frameworks also avoid the use of multiple software packages to build and test models, avoiding the high computational overhead form data transfer and compatibility synchronizations of different software packages.

Beneficially, the presented AutoPHM framework generates output more quickly and reliably than conventional approaches by utilizing hybrid models for one or more of the underlying SM, A S model, AD model, and RUL model. A s described above, hybrid models may generate accurate outputs faster than system models and more reliably than data-driven models (e.g., ML models).

Further, the AutoPHM framework improves the flexibility, adaptability, and accuracy of results in different contexts by adapting the simulation model into an AS model, and continually updating this model using transfer learning algorithms and live production data to generate more accurate results than standard PHM methods.

### Example PHM System

FIG. 32 depicts an example PHM system 3200.

The example PHM system 3200 includes an SM building component 3210, an AD component 3220, a fault isolation component 3230 and an RUL prediction component 3240.

The example PHM system 3200 is used to monitor and evaluate an SOI 3201, e.g., an asset, machine or equipment. The SOI 3201 may receive system inputs 3202, e.g., an input such as a speed of operation setting. The SOI 3201 may produce system outputs 3203, e.g., an output such as temperature production by the asset.

The SM building component 3210 of the example PHM system 3200 may include an SM builder 3204, e.g., using a system model or a data-driven model builder algorithms that receive the system outputs 3203 to generate an ML-based or system-based SM 3205 of the SOI 3201. The SM builder 3204 may receive the same system inputs 3202 as the SOI 3201 and produce estimated outputs 3206, e.g., estimates of the system outputs 3203. The SM builder 3204 expects nominal outputs, and its estimated outputs 3206 are estimated nominal outputs based on the system inputs 3202. A nominal output can refer to an output matching an expected or reference value (or range of values).

In the AD component 3220 of the example PHM system 3200, the system outputs 3203 and the estimated outputs 3206 may be used as inputs into the AD model 3207. The AD model 3207 may produce an AD output 3208, which can include a detected anomaly in the system outputs 3203, based on the system outputs 3203 and the estimated outputs 3206. For example, the expected nominal behaviors as estimated by the estimated outputs 3206 are used as a reference and compared against the system outputs 3203 by the AD model 3207 to detect anomalies in the system outputs 3203. An AD model is generally a binary classifier that classifies data received as nominal or anomalous.

In the fault isolation component 3230 of the example PHM system 3200, a fault isolator 3209 receives the system outputs 3203 and the estimated outputs 3206. In some aspects, the fault isolator 3209 may also receive the AD output 3208. The fault isolator 3209 isolates faults 3211 or identifies a source of the faults 3211, e.g., a faulty component in the SOI 3201, based on the system outputs 3203, the estimated outputs 3206, the AD output 3208, or any combination thereof. If the fault isolator 3209 does not receive the AD output 3208, then it may first perform anomaly detection (similar to the AD model 3207) to determine the existence of anomalies. If an anomaly is detected, the fault isolator 3209 then may use cause-effect relationships to isolate faults 3211. The cause-effect relationships may be learned from data, e.g., using ML to learn to isolate faults based on previous cycles or training. The fault isolator 3209 may also use domain knowledge, e.g., rule-based isolation algorithms hardcoded into the fault isolator 3209, to determine the faults 3211 of an anomaly detected by the AD model 3207. For example, the fault isolator 3209 may use look up tables based on system-based rules to determine the type of faults 3211 present and identify them in the system outputs 3203.

In the RUL prediction component 3240 of the example PHM system 3200, future inputs 3212 are processed by the SM 3205 to generate predicted future outputs 3213. The future inputs 3212 may be based on mathematical calculations, e.g., based on pre-defined operational models, or inputs from a subject matter expert (SM E). The predicted future outputs 3213 are then provided to an RUL model 3214 to generate an RUL prediction 3215. The RUL prediction 3215 may predict a remaining life span of the SOI 3201.

### Example AutoPHM

FIG. 33 depicts an example AutoPHM framework 3300 configured to implement an end-to-end PHM system. The example AutoPHM framework 3300 may include one or more models or frameworks. A framework may generally include tools, models, algorithms, methods, and techniques to automatically generate and execute one or more models. Tools may include programs or applications designed to perform a specific, focused function within a larger workflow. Algorithms may refer to sets of instructions that a computing device or system follows to complete a task or solve a problem. Methods can include blocks of code, e.g., within a class, that define specific actions or behaviors that an object can perform. Techniques can refer to a specific method or approach to design, develop, test, or maintain a software program. Models may be representations of a system, process, or component within a software application. A model may include any type of model, including system models, data-driven models, or hybrid models. One of the objectives of an end-to-end PHM system is to produce accurate data outputs, e.g., RUL predictions for an SOI.

In some aspects, the example AutoPHM framework 3300 includes at least one of four core frameworks. The first is an automated and generalizable framework for generating new hybrid models, e.g., to model and simulate the SOI. The second is an automated and generalizable framework for generating AD models and fault isolators. The third core framework is an automated model adaptation framework to continually adapt an SM of the SOI to accurately reflect the state of a production SOI. The fourth core framework is a PHM evaluation framework that evaluates performance of RUL predictions, e.g., of an RUL model.

In some aspects, an SOI 3301, e.g., equipment or other asset, in a controlled laboratory environment 3340 may receive controlled inputs 3302 and generate controlled outputs 3303. The controlled inputs 3302 and the controlled outputs 3303 are used as inputs in a hybrid modeling framework 3305 to generate a hybrid model. The hybrid modeling framework may correspond to any of the frameworks as described in the U.S. patent application Ser. No. 18/946,097, filed on Nov. 13, 2024, and titled “UNIFIED HYBRID MODELING TOOL FOR SYSTEMS OF INTEREST.” In some aspects, the hybrid modeling framework 3305 is based on a closure learning framework, a mechanistic feature engineering framework, a mechanistic supervision framework, or a mechanistic architecture design or knowledge-informed design framework. The closure learning framework uses a low-fidelity system model in combination with an ML model to learn corrections or error terms, e.g., it is designed to learn corrections to low-fidelity system model(s) in a state-space. The mechanistic feature engineering framework uses an ML model and adds outputs from a low-fidelity system model as additional inputs, e.g., the system model outputs are used as extra input features. The mechanistic supervision framework uses an ML model and adopts a custom loss function, which includes extra penalty terms that enforce certain system-based rules. For example, the mechanistic supervision framework uses custom loss functions for enforcing system-based rules or laws (such as scientific laws) on internal ML models. The mechanistic architecture design or knowledge-informed design framework uses inductive bias and domain knowledge from system models to guide the architecture design of an ML model, often in the form of a state space model or neural differential equations.

Each framework may deploy one or more system models e.g., a system model that describes the SOI 3301, to generate a hybrid model. These system models may be of different levels of abstraction. Listed from highest to lowest levels of abstraction, these can include black-box models, causal-directed acyclic graphs, functional models, and realized models. In addition to different types of system models. The hybrid modeling framework 3305 can utilize observation models, state-space models, neural networks, and corrective models to generate hybrid models. Depending on the system model available, one or more of the aforementioned frameworks may be used to generate hybrid models. The training of these models may rely on a specific model learning approach such as output closure, state closure, parameter closure, mechanistic neural ODE, physics-informed neural networks (that uses functional or black-box models), or physics-guided neural networks (that uses realized models).

The hybrid modeling framework 3305 generates an SM 3306 of the SOI 3301. The hybrid modeling framework 3305 may also use stored models 3304 or stored weights associated with stored models 3304 to generate the SM 3306. This reduces compute resource usage by avoiding the need to train a model from untrained initial weights.

In some aspects, the SM 3306 receives SOI data associated with the SOI to generate SM outputs 3318. For example, the SM 3306 may receive the controlled inputs 3302 or controlled outputs 3303 and produce the SM outputs 3318 that are used as inputs in other frameworks or models of the example AutoPHM framework 3300, e.g., to generate other models. The SM outputs 3318 are based on the controlled inputs 3302, where the SM 3306 simulates the SOI to generate an estimate (the SM outputs 3318) of the controlled outputs 3303. The SM 3306 may correspond with the SM 3205 of FIG. 32. The controlled inputs 3302 or controlled outputs 3303 may correspond to the system inputs 3202 and the estimated outputs 3206 of FIG. 32, respectively.

In some aspects, the controlled inputs 3302, the controlled outputs 3303, and the SM outputs 3318 may be received by an AD framework 3307. The AD framework 3307 may correspond to, and utilize the systems and methods associated with any of the AD frameworks described in the U.S. application Ser. No. 19/073,499, filed on Mar. 7, 2025, and titled “AUTONOMOUS GENERATION OF ANOMALY DETECTION MODELS”. For example, The AD framework 3307 can be a non-residual-based supervised learning (NR-SL) AD framework, a non-residual-based unsupervised learning (NR-UL) AD framework, a residual-based supervised learning (RB-SL) AD framework, and a residual-based unsupervised learning (RB-UL) AD framework.

Each of the aforementioned AD frameworks can use one or more AD training algorithms to generate the AD model 3308. Example AD training algorithm(s) include one-dimensional convolutional neural network-long short-term memory models (CNN1D-LSTM), variational autoencoder-Long short-term memory model (VAE-LSTM), sequence variational autoencoder-Long short-term memory models (SeqVAE-LSTM), variational autoencoder-bi-directional Long short-term memory models (VAE-BiL ST M), sequence variational autoencoder bi-directional Long short-term memory models (SeqVAE-BilSTM), an isolation forest, a one class support vector machine (SVM), Local outlier factor models, Gaussian mixture models, and a Long short-term memory (LSTM) models.

The AD framework(s) used to train the AD model 3308 can be selected through an automated triage process based on data types of available training data. An automated triage process may be utilized to eliminate AD framework(s) not suited to the available data types or to select AD framework(s) to generate the AD model 208. The selected AD frameworks may then be used to generate AD models with their training algorithms. The generated AD models can then be evaluated, and an AD model from those trained is deployed as the AD model 3308. For example, the AD framework 3307 generates an AD model 3308 with at least two of the controlled inputs 3302, the controlled outputs 3303, the SM 3306 outputs, and any available labeled data. The AD model 3308 may detect outliers in data it receives. The AD model 3308 can be used to optimize performance of models, by identifying anomalies in their data output.

The SOI 3301 may be deployed in a production environment 3350 as a production SOI 3310. Unlike the laboratory environment 3340, the production environment 3350 includes a real-world or testing environment that includes uncontrolled or unknown variables or conditions. The production SOI 3310 may receive production inputs 3309 and generate production outputs 3311 (collectively and interchangeably referred to herein as production data). For example, an asset, e.g., the production SOI, may be deployed in the production environment 3350 and generate gear movements, noise, or heat, any of which correspond to the production outputs 3311. The production inputs 3309 may include energy from sources, such as electricity or a hydrocarbon fuel sources. In some aspects, the production outputs 3311 comprise sensor data of the production SOI 3310. For example, a processing system associated with the example AutoPHM framework 3300 may receive current sensor data from the production SOI 3310 and store the current sensor data of the production SOI 3310 in a data repository.

The SM 3306 models the SOI 3301 in the controlled laboratory environment 3340 and cannot be used to accurately estimate the behavior or status of the production SOI 3310. For accurate RUL predictions, the nominal behavior of the production SOI 3310 as well as its progressively degraded behavior is captured. A sufficiently complex model may capture both nominal and degraded system behavior. The model adaptation framework 3312 can create such a model by periodically adapting the model to new system observations so as to reflect the production SOI 3310 accurately.

Thus, the SM 3306 is adapted by a model adaptation framework 3312 to generate an AS model 3313 that accurately simulates the production SOI 3310. The generation of the AS model 3313 may begin with duplicating the SM 3306 into a new model that is to be adapted by the model adaptation framework 3312 to generate the A S model 3313. Both the SM 3306 and the A S model 3313 may be data-driven, system, or hybrid models.

For example, when an AS model 3313 is first generated and deployed, it may model a production SOI 3310 that has just been recently put into the production environment 3350 and has not yet faced a threshold-level of degradation. At this point the production SOI 3310 may be very similar to the SOI 3301 in the controlled laboratory environment 3340. Differences manifest between the SM 3306 and the AS model 3313 as the production SOI 3310 is increasingly used and its outputs are used to adapt the A S model 3313 to reflect the changes of the production SOI 3310. The differences between the SM 3306 and the AS model 3313 would therefore reflect the differences between the SOI 3301 and the production SOI 3310.

A s the production SOI 3310 goes through cycles of use, and subsequent deterioration, the accuracy of the modeling by the AS model 3313 decreases. Traditional approaches retrain the AS model 3313 based on each input and output, a computationally expensive process. By contrast, the model adaptation framework 3312 may include a drift detection algorithm that compares predictions or the outputs of the A S model 3313 to the production outputs 3311 of the production SOI 3310, and only if there is statistically significant drift, then it can attribute this to degradation, e.g., degradations of the production SOI 3310 that are not reflected by the A S model 3313. When a statistically significant drift is detected, the AS model 3313 is then adapted by the model adaptation framework 3312, e.g., by using the production outputs 3311. This process may be repeated at every cycle or at each set number of cycles until another significant deviation is detected and adaptation occurs again. Each cycle may be defined as a period where new data or a certain amount of new data is generated by the production SOI 3310, or received by the model adaptation framework 3312. In some aspects, the detection of deviations is exclusively undertaken by the AD model 3308 that produces the AD output 3314 that may include detected anomalies or fault types. The model adaptation framework 3312 may then determine whether these anomalies or fault types are significant enough to trigger an adaptation of the A S model 3313.

In some aspects, the model adaptation framework 3312 may utilize condition-based model adaptation (CBMA) or continuous model adaptation (CMA) to adapt the A S model 3313. In CBMA data are continuously collected from the production environment 3350, e.g. the production inputs 3309 and the production outputs 3311 but adaptation is only triggered upon some conditions being fulfilled. The AS model 3313 and the production SOI 3310 are constantly monitored, e.g., by the AD model 3308 that receives the production outputs 3311 and any outputs generated by the AS model 3313, e.g., AS outputs 3317. If detected anomalies are above a threshold, e.g., in magnitude or frequency depending on the configuration, then all past information collected prior to the detected anomaly is used to adapt the model. In CMA, the AD model 3308 is not generally used, and whenever production data are received by the model adaptation framework 3312 from the production SOI 3310, it is used to adapt the model. For example, in CMA there is continuous adaptation occurring based on a scheduled basis.

In some aspects, the model adaptation approach utilized by the model adaptation framework 3312 is an offline adaptation approach, e.g., it is human run or based on human intervention. An offline adaptation approach can be applied to both CMA and CBMA. Online adaptation approaches are automated and do not require human intervention. Both CMA and CBMA may also be based on online approaches e.g., in CMA, may be based on live data received on a continuous basis and where all the received data is used to calibrate the AS model 3313 on a schedule. While in CBMA the triggering condition causes the model adaptation to occur automatically. The model adaptation framework 3312 may utilize either online or offline adaptation approaches and may even switch the approach for the same A S model 3313.

Adaptation may be performed using SOI production data collected from the production SOI 3310 (e.g., the production inputs 3309 or the production outputs 3311) to train the AS model 3313. The production data can be collected by sensors associated with the production SOI 3310. In some aspects, corrective terms that will be applied by the model adaptation framework 3312 to adapt the AS model 3313 is determined based on the production data. For example, if a hybrid model is being used, a state observation model may be used as a pass-through function to select the variables, representing the measurement, to be used for model adaptation.

In some aspects, the model adaptation algorithm is a Jacobian feature regression (JFR) algorithm. JFR is an approach to recalibrate model parameters to match model predictions to the newly observed data. A recurring neural network (RNN) is used to model the dynamic system using available measurements. Then, as the system dynamics change, it causes the nominal model to be inaccurate for predicting the observed measurements in the presence of perturbed system dynamics. The core idea of this approach is to adapt an existing RNN model, which was trained on data from a nominal system (performing within expected outcomes), to perturbed system dynamics, not by retraining the model from scratch, but by including an additive correction term to the nominal model's output. This correction term is designed to account for discrepancies between the nominal system and the perturbed system. For example, as unacceptable degradation of the nominal model performance occurs, a transfer learning approach is used to improve the performance of the nominal model in the presence of perturbed system dynamics, where the nominal model is augmented with additive correction terms that are trained on observed perturbed system data. These correction terms are learned through JFR, which is defined in terms of the features spanned by the model's Jacobian concerning its nominal parameters. Efficient model adaptation is achieved by using the JFR in the feature space defined by the Jacobian of the model with respect to its nominal parameters. In some aspects, a non-parametric view that uses the Gaussian process could be used. This could be useful to provide flexibility and efficiency for very large networks or when only a few data points are available.

Efficient model adaptation is achieved by using the JFR algorithm in the feature space defined by the Jacobian of the AS model 3313 with respect to its nominal parameters. Adaptation techniques other than JFR may also be used to adapt the AS model 3313, e.g., dual modifier adaptation algorithms. However, one of the advantages of using a JFR algorithm for model adaptation is the lower compute resource usage compared to standard adaptation techniques. For example, using JFR for model adaptation may consume ten times fewer compute cycles than standard model adaptation techniques. JFR may also be used to determine the corrective terms that will be applied learned through the JFR defined in terms of the features spanned by the AS model 3313's Jacobian with respect to its nominal parameters.

The model adaptation framework 3312 may utilize the systems and methods associated with the adaptation frameworks described in the U.S. patent application Ser. No. 19/170,428, titled “ROBUST REMAINING USEFUL LIFE ESTIMATION BASED ON ADAPTIVE SYSTEM REPRESENTATION USING JACOBIAN FEATURE ADAPTATION”, filed on Apr. 4, 2025, which claims the benefit of and priority to U.S. Provisional Patent Application No. 63/574,942, filed on Apr. 5, 2024 and titled “ROBUST REMAINING USEFUL LIFE ESTIMATION BASED ON ADAPTIVE SYSTEM REPRESENTATION USING JACOBIAN FEATURE ADAPTATION” and U.S. patent application Ser. No. 19/170,560, titled “ROBUST ONLINE AND OFFLINE ADAPTATION OF PRE-TRAINED MODELS TO UNSEEN FIELD DATA” filed on Apr. 4, 2025, which claims the benefit of and priority to U.S. Provisional Patent Application No. 63/574,689, filed Apr. 4, 2024 and titled “ROBUST ONLINE AND OFFLINE ADAPTATION OF PRE-TRAINED MODELS TO UNSEEN FIELD DATA.”

The AS model 3313 may receive inputs 3315, or future inputs 3316. The inputs 3315 may be the same inputs as the production inputs 3309 received by the production SOI 3310. Alternatively, the inputs 3315 may be user inputs, e.g., manually entered into the AS model 3313. The future inputs 3316 may correspond to the future inputs 3212 of FIG. 32, and may be based on mathematical calculations, e.g., based on pre-defined operational models, or inputs from an SM E.

As the AS model 3313 receives the inputs 3315 and uses them to generate AS outputs 3317. The AS outputs 3317 may be estimates of the production outputs 3311 of the production SOI 3310. The AS outputs 3317 may be processed by the AD model 3308, which detects anomalies or isolates faults. The AD model 3308 receives SOI production data from the production SOI 3310, as well as the AS outputs 3317 to generate an AD output 3314. The AD output 3314 can include a detected anomaly, or it could include fault isolation by the AD model 3308, e.g., of faults in the production outputs 3311 based on detected anomalies.

The AS model 3313 also generates predictions 3320 that are based on the future inputs 3316. For example, if the future inputs 3316 are of a future variable associated with the production SOI 3310, e.g., power input into the production SOI 3310, then the predictions 3320 may include a prediction of other variables at the future time based on the future inputs 3316 such as predictions of heat generated based on the power inputs.

In some aspects, the predictions 3320 for future inputs may be entered into or received by an RUL prediction model 3321. The RUL prediction model 3321, based on the predictions 3320 for future inputs, may generate RUL prediction(s) 3322. The RUL prediction(s) 3322 may include a prediction of measurement value(s) at a future time, e.g., a prediction of a measurement value by a sensor of the production SOI 3310, a prediction of time for a measurement value of a sensor to be a certain value, or may be an RUL time period of the production SOI 3310. For example, the RUL prediction model 3321 can express the RUL prediction(s) 3322 as a time component, such as a number of months until the production SOI 3310 stops functioning. The RUL prediction(s) 3322 can also include predictions of sensor measurement values, e.g., predicting that a gas sensor of the production SOI 3310 will measure a higher level of nitrogen oxide as the engine degrades, with RUL predictions of different gas measurement values at different times.

In some aspects, the RUL prediction(s) 3322 may be used by a controller or other computing device or system connected to the production SOI 3310 to automatically control one or more operational parameters of the production SOI 3310 based at least in part on the RUL prediction(s) 3322. For example, power input, or control parameters such as an operational rate of the production SOI 3310 may be automatically adjusted to increase RUL or to meet expected RUL of the production SOI 3310.

In some aspects, a PHM evaluation framework 3323 evaluates the RUL prediction(s) 3322 to determine the efficacy and accuracy of the RUL prediction model 3321. The PHM evaluation framework 3323 may correspond to, and utilize the systems and methods associated with any evaluation framework described in the U.S. application Ser. No. 18/946,435, filed on Nov. 13, 2024, and titled “SYSTEMS AND METHODS FOR EVALUATING REMAINING USEFUL LIFE PREDICTION ALGORITHMS.” The PHM evaluation framework 3323 may generate several evaluation outputs, including a service level indicator (SLI) 3324 that summarizes the overall performance of the RUL prediction model 3321, a measurement-based PHM evaluation, and an RUL-based PHM evaluation, as described in more detail in relation to FIG. 35.

Adjustments may be made to the end-to-end PHM system implemented by the AutoPHM framework 3300 based on the evaluation outputs of the PHM evaluation framework 3323. These tweaks to the PHM system can be made at one or more blocks of the AutoPHM framework 3300. This may include updating the weights of different ML models involved throughout the AutoPHM framework 3300. Adjustments could also involve restarting the AutoPHM framework 3300 with more accurate models. Additionally, hyperparameter tuning could be performed throughout the AutoPHM framework 3300 to generate more accurate RUL predictions.

In some aspects, at least one of the SM 3306, the AD model 3308, the AS model 3313, or the RUL prediction model 3321 comprises a hybrid model. In some aspects, one or more of the aforementioned models are first generated and then they may continually run as part of the PHM system. For example, the AD model 3308 may be generated and then deployed when the production SOI 3310 begins to produce the production outputs 3311.

Note that FIG. 33 is just one example of an AutoPHM and other aspects including fewer, additional, or alternative operations are possible.

FIG. 34 depicts an example architecture of a state-space model 3400 that may be applied in hybrid models and various hybrid modeling framework(s). FIG. 34 corresponds with FIG. 4 of Application A. The example architecture may be one example of an architecture used by the framework(s) 3305, 3307, 3312, and 3323 of FIG. 33, or an architecture used by the models 3304, 3306, 3308, 3313, and 3321 of FIG. 33. The final output (Yₜ) 3421 generated by the state-space model 3400 may represent data generated by a system e.g., it can be used to model outputs generated by an SOI.

The primary components of the state-space model 3400 includes a state-transition model 3405 and an observation model 3410. The state-space model 3400 may be described by the following two example equations:

$${X}_{t} = g ( {X}_{t - 1} , {U}_{t} ; θ ) \qquad Eq . 1.$$

$${Y}_{t} = h ( {X}_{t} , {U}_{t} ) \qquad Eq . 1.1$$

Equation 1.0 represents function (g), and function (g) represents state-transition model 3405, which produces an output of a latent state (Xₜ) 3406. The Equation 1.1 represents function (h), and function (h) represents the observation model 3410, which produces the final output (Yₜ) 3421 using the latent state (Xₜ) 3406 output of Equation 1.0 as input into function (h) of Equation 1.1.

Exogenous input(s) (Uₜ) 3401 represent inputs at discrete time step (t). Function (g), with model parameters (θ) 3403 represents the evolution of the latent state (Xₜ) 3406 over time under the influence of the exogenous input(s) (Uₜ) 3401. The prior state input(s) (Xₜ₋₁) 3402 represents a prior state of the state-transition model at discrete time step (t−1) which is input into the function (g) to generate the state-transition model 3405's latent state (Xₜ) 3406. Latent state (Xₜ) 3406 is an output generated by the function (g) and represents the state-transition model 3405's latent state (Xₜ) 3406 at time (t). The exogenous input(s) (Uₜ) 3401 and the prior state input(s) (Xₜ₋₁) 3402 may correspond to the data obtained/received by the various frameworks or models of FIG. 33 as described above.

The final output (Yₜ) 3421 represents measured outputs at time (t) based on the exogenous input(s) (Uₜ) 3401 and the latent state (Xₜ) 3406. Model parameters (θ) 3403 represents model parameters and may be predefined by a system model, e.g., a system models associated with the SOI 3301 of FIG. 33.

In certain aspects, both functions (g) and (h) may comprise deep neural networks, which are examples of data-driven models. In other aspects, functions (g) and (h) may comprise explicit functional forms, which are examples of system models (e.g., mechanistic models). Either of the state-transition model 3405 and the observation model 3410 may be a data-driven model or a system model. Assigning one of the state-transition model 3405 and the observation model 3410 as a data-driven model and the other as a system model creates a hybrid model. The frameworks and models described herein may utilize purely system models (where both of 3405 and 3410 are system models), data-driven models (where both of 3405 and 3410 are data-driven), or hybrid models (where one of 3405 and 3410 is a system model and the other data-driven).

FIG. 35 depicts an example 3500 of evaluating a RUL prediction model 3503, by a PHM evaluation framework 3505. The PHM evaluation framework 3505 may correspond to the PHM evaluation framework 3323 of FIG. 33.

RUL predictions of an RUL prediction model, e.g., RUL prediction(s) 3322 of the RUL prediction model 3321 of FIG. 33, are data outputs that can be calculated and expressed based on a time component, e.g., a number of months until the SOI stops functioning. As described herein RUL is the amount of time remaining before the system reaches its end-of-useful life (EOL) (e.g., to perform nominally). This EOL is determined when certain operation conditions are met, e.g., the temperature of the motor being higher than T degrees Celsius. The RUL can be based on sensor measurement values, or “hidden variables” estimated using the measured sensor values.

RUL predictions can also be calculated and expressed based on sensor measurement values, e.g., predictions of sensor values at different times, such as a gas sensor detecting a higher level of nitrogen oxide as an engine degrades; or estimates of unobserved “hidden” variables that can be estimated using the sensor measurement values. For example, at a first time stamp, the RUL prediction(s) may include a prediction of a sensor measurement value for a future second time stamp. The RUL prediction(s) may also include predictions of time for a sensor measurement value to reach a certain value. A sensor measurement value may correspond to a specific RUL time measurement, e.g., gas measurement above a threshold can indicates a leak of a certain magnitude may be linked to an amount of time left for a lifespan of a valve.

The PHM evaluation framework 3505 does not require ground-truth failure data to determine the accuracy of the RUL predictions of an RUL prediction model, and instead assumes current sensor values as ground-truth, e.g., sensor measurement values of an SOI. This allows the PHM evaluation framework 3505 to evaluate how well the RUL prediction model predicts current sensor measurement values (based on its past measurement predictions), as well as to evaluate how well the RUL prediction model predicts the time to reach current sensor measurement values.

The SOI 3501 may correspond to the SOI 3201 of FIG. 32, the SOI 3301, or the production SOI 3310 of FIG. 33 and may include sensors that produce sensor data collected over time and stored in a database at block 3502. An RUL prediction model 3503 may be used to generate RUL prediction data. The RUL prediction data may correspond to the RUL prediction(s) 222 of FIG. 33. The RUL prediction data may include any prediction made by the RUL prediction model 3503, and this data may be stored in a database at block 3504.

The PHM evaluation framework 3505 may use the sensor data and the RUL prediction data that were stored in a database at blocks 3502 and 3504 to generate outputs at a particular time of evaluation 3506. These outputs may include measurement-based PHM evaluation 3507 results, RUL-based PHM evaluation 3508 results, and a service-level indicator (SLI) 3509 that summarizes the overall performance of the RUL prediction model 3503.

In general, a “look-back” evaluation window may first be defined during which the performance of the RUL prediction model 3503 may be evaluated. The look-back evaluation window may be defined by a set number of prediction data points that were generated, or by a time window looking back from a time of evaluation 3506. For example, the time of evaluation 3506 may be a present time. In general, the window looking back may be converted into the set number of prediction data points if the prediction is performed at fixed time intervals.

### Measurement-Based PHM Evaluation

Measurement-based PHM evaluation 3507 evaluates how well an RUL model predicts measurements, e.g., sensor measurements. For example, the measurement-based PHM evaluation 3507 may determine how accurately the RUL prediction model 3503 predicts sensor measurements, based on past sensor measurement predictions of the RUL prediction model 3503. For example, the measurement-based PHM evaluation 3507 evaluates the accuracy of predictions of future sensor measurements at multiple earlier timestamps.

### RUL-Based PHM Evaluation

The RUL-based PHM evaluation 3508 evaluates how well the RUL prediction model 3503 predicts the RUL at different past time steps. RUL may be defined as the amount of time necessary to reach certain sensor measurement value, e.g., a sensor measurement value of a non-functional SOI. The threshold (or ground-truth) may be assumed to be the current value of a sensor and a determination may be made as to how well the RUL prediction model 3503 predicted an amount of time that was required at a past point in time to reach the current sensor reading value. For example, the RUL-based PHM evaluation 3508 evaluates the accuracy of predictions of the time to reach the current sensor measurement values (at multiple earlier timestamps).

### Computing a Service-Level Indicator for the PHM Algorithms

The SLI 3509 provides a user-defined metric to summarize the overall performance of the RUL prediction model 3503. This could be performed by applying one or more weighting schemes to either the measurement-based PHM evaluation 3507 results or the RUL-based PHM evaluation 3508 results. First, a lookback window for the SLI 3509 may be defined based on whether it includes RUL-based or measurement-based PHM evaluation results. Then, a weighting scheme to generate the SLI 3509 may be applied based on whether the results are from the measurement-based PHM evaluation 3507 or the RUL-based PHM evaluation 3508. The possible weighting functions applied to generate the SL 13509 may include any of the weighting functions described in the U.S. application Ser. No. 18/946,435, titled “Systems And Methods For Evaluating Remaining Useful Life Prediction Algorithms.” filed on Nov. 13, 2024.

### Example Methods for AutoPHM

FIG. 36 shows a method 3600 for AutoPHM.

The method 3600 begins at block 3602 with receiving by an SM associated with a system of interest (SOI), SOI data associated with the SOI to generate an SM output. Block 3602 may correspond to the SM 3306 of FIG. 33 receiving the controlled inputs 3302 or the controlled outputs 3303, e.g., via the hybrid modeling framework 3305. The SOI may correspond to the SOI 3301 of FIG. 33.

The method 3600 then proceeds to block 3604 with receiving by an AD model, SOI production data from a production SOI to generate an AD model output. Block 3604 may correspond to the AD model 3308 receiving the production output 3311 to generate the AD output 3314 of FIG. 33. The AD model may correspond to the AD model 3308 of FIG. 33.

The method 3600 then proceeds to block 3606 with receiving by an AS model, at least one of the SM output, the SOI production data from the production SOI, a hypothesized future input, or the AD model output from the AD model to generate an estimated future output. Block 3606 may correspond to the AS model 3313 of FIG. 33 receiving the output from the SM 3306, e.g., via the model adaptation framework 3312, the production data (3309, 3311), the future inputs 3316, or the AD output 3314.

The method 3600 then proceeds to block 3608 to determine, by an RUL model, an RUL prediction of the production SOI based on the estimated future output. Block 3608 may correspond to the RUL prediction model 3321 of FIG. 33 generating the RUL prediction(s) 3322. The RUL model may correspond to the RUL prediction model 3321 of FIG. 33.

The method 3600 facilitates automatic standardized generation and execution of the models making up the core components of the automated PHM, e.g., SM, AD, and AS models, by using standardized repeatable automated frameworks to generate each core component of the AutoPHM framework. The standardized frameworks utilized by the AutoPHM framework reduce the amount of testing and use of computational resources dedicated for simulations and evaluations.

In some aspects, method 3600 further includes automatically controlling one or more operational parameters of the production SOI based at least in part on the RUL prediction.

In some aspects, method 3600 further includes evaluating a performance of the RUL model, by a PHM evaluation algorithm.

In some aspects, method 3600 further includes defining at least one look-back window by the PHM evaluation algorithm, wherein the look-back window comprises look-back data points comprising at least one of past SOI production data or past RUL predictions, and wherein the at least one look-back window is a past time period measured from a time of evaluation; and determining at least one evaluation metric using the look-back data points in the at least one look-back window by at least one of a measurement-based PHM evaluation, an RUL-based PHM evaluation, or an SLI.

In some aspects, the measurement-based PHM evaluation determines acceptable measurement error bounding values relative to values of the past SOI production data, the RUL-based PHM evaluation determines accuracy of the past RUL predictions relative to current SOI production data, and where the SLI provides a summary of performance metrics of the RUL model based on at least one of the measurement-based PHM evaluation or the RUL-based PHM evaluation.

In some aspects, method 3600 further includes receiving current sensor data from the production SOI; and storing the current sensor data of the production SOI in a data repository.

In some aspects, method 3600 further includes generating, by the AD model, the AD model output based on at least one of the SOI production data or an A S model output.

In some aspects, method 3600 further includes generating, by the AS model, the estimated future output based on the hypothesized future input; and receiving, by the RUL model, the estimated future output from the AS model for the determining of the RUL prediction.

In some aspects, method 3600 further includes receiving, by the AD model, the AS model output; and generating the AD model output, based on at least one of the AS model output or the SOI production data, wherein the AD model output comprises at least one of one or more anomaly classifications or one or more fault isolations.

In some aspects, method 3600 further includes adapting the A S model based on the AD model output by performing an online model adaptation technique.

In some aspects, method 3600 further includes generating the SM based on the SOI data; generating the AD model based on the SOI data; and generating the AS model based on at least one of the SM output, the SOI production data, or the AD model output.

In some aspects, the adapting comprises performing a Jacobian feature regression technique.

In some aspects, the SM is based on trained weights associated with at least one stored model.

In some aspects, the time of evaluation is a present time.

In some aspects, the estimated future output comprises a prediction of an SOI production data output.

In some aspects, the SOI production data comprises at least one of an SOI production data input or an SOI production data output.

In some aspects, at least one of the SM, the AD model, the AS model, or the RUL model comprises a hybrid model, and the hybrid model comprises a combination of a data-driven model and a system model.

In some aspects, method 3600, or any aspect related to it, may be performed by an apparatus, such as processing system 3800 of FIG. 38, which includes various components operable, configured, or adapted to perform the method 3600.

Note that FIG. 36 is just one example of a method, and other methods including fewer, additional, or alternative operations are possible consistent with this disclosure.

### Example Methods

FIG. 37 shows a method 3700 for AutoPHM.

Method 3700 begins at block 3702 to SOI data associated with an SOI to generate an SM output. Block 3702 may correspond to the SM 3306 of FIG. 33 receiving the controlled inputs 3302 or the controlled outputs 3303, e.g., via the hybrid modeling framework 3305.

Method 3700 then proceeds to block 3704 to receive the SOI production data from a production SOI to generate an AD model output. Block 3704 may correspond to the AD model 3308 receiving the production output 3311 to generate the AD output 3314 of FIG. 33.

Method 3700 then proceeds to block 3706 to receive at least one of the SM output, the SOI production data, a hypothesized future input, or the AD model output to generate an estimated future output. Block 3706 may correspond to the AS model 3313 of FIG. 33 receiving the SM output 3318 from the SM 3306, e.g., via the model adaptation framework 3312, the production data (3309, 3311), the future inputs 3316, or the AD output 3314.

Method 3700 then proceeds to block 3708 to determine, an RUL prediction of the production SOI based on the estimated future output. Block 508 may correspond to the RUL prediction model 3321 of FIG. 33 generating the RUL prediction(s) 3322.

The method 3700 facilitates automatic standardized generation and execution of the functionalities making up the core components of the automated PHM, e.g., simulation of an SOI, Anomaly detection, and adapting the simulation of the SOI, by using standardized repeatable automated frameworks to produce core functions of a PHM system. The standardized frameworks utilized by the AutoPHM framework reduce the amount of testing and use of computational resources dedicated for simulations and evaluations.

In some aspects, method 3700 further includes evaluating a performance of the RUL prediction.

In some aspects, method 3700, or any aspect related to it, may be performed by an apparatus, such as processing system 3800 of FIG. 38, which includes various components operable, configured, or adapted to perform the method 3700.

Note that FIG. 37 is just one example of a method, and other methods including fewer, additional, or alternative operations are possible consistent with this disclosure.

### Example Processing System for an AutoPHM

FIG. 38 depicts an example processing system 3800 configured to perform various aspects described herein for any of FIGS. 1-37, including, for example, methods 3600 and 3700 as described above with respect to FIG. 36 and FIG. 37.

The processing system 3800 is generally an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, the processing system 3800 includes one or more processors 3802, one or more input/output devices 3804, one or more display devices 3806, one or more network interfaces 3808 through which processing system 3800 is connected to one or more networks (e.g., a local network, an intranet, the Internet, or any other group of processing systems communicatively connected to each other), and computer-readable medium 3812. In the depicted example, the aforementioned components are coupled by a bus 3810, which may generally be configured for data exchange amongst the components. Bus 3810 may be representative of multiple buses, while only one is depicted for simplicity.

The processor(s) 3802 are generally configured to retrieve and execute instructions stored in one or more memories, including local memories like computer-readable medium 3812, as well as remote memories and data stores. Similarly, processor(s) 3802 are configured to store application data residing in local memories like the computer-readable medium 3812, as well as remote memories and data stores. M ore generally, bus 3810 is configured to transmit programming instructions and application data among the processor(s) 3802, display device(s) 3806, network interface(s) 3808, and/or computer-readable medium 3812. In certain embodiments, processor(s) 3802 are representative of a one or more central processing units (CPUs), graphics processing unit (GPUs), tensor processing unit (TPUs), accelerators, and other processing devices.

Input/output device(s) 3804 may include any device, mechanism, system, interactive display, and/or various other hardware and software components for communicating information between processing system 3800 and a user of processing system 3800. For example, input/output device(s) 3804 may include input hardware, such as a keyboard, touch screen, button, microphone, speaker, and/or other device for receiving inputs from the user and sending outputs to the user.

Display device(s) 3806 may generally include any sort of device configured to display data, information, graphics, user interface elements, and the like to a user. For example, display device(s) 3806 may include internal and external displays such as an internal display of a tablet computer or an external display for a server computer or a projector. Display device(s) 3806 may further include displays for devices, such as augmented, virtual, and/or extended reality devices. In various embodiments, display device(s) 3816 may be configured to display a graphical user interface.

Network interface(s) 3808 provide processing system 3800 with access to external networks and thereby to external processing systems. Network interface(s) 3808 can generally be any hardware and/or software capable of transmitting and/or receiving data via a wired or wireless network connection. Accordingly, network interface(s) 3808 can include a communication transceiver for sending and/or receiving any wired and/or wireless communication.

Computer-readable medium 3812 may be a volatile memory, such as a random access memory (RAM), or a nonvolatile memory, such as nonvolatile random access memory (NV RA M), or the like. In this example, computer-readable medium 3812 includes a receiving component 3871, a determining component 3873, an evaluating component 3875, a controlling component 3877, a defining component 3879, a storing component 3881, an isolating component 3883, a detecting component 3885, an adapting component 3887, a generating component 3889, and a performing component 3891. The computer-readable medium 3812 also includes receiving data 3872, determining data 3874, evaluating data 3876, controlling data 3878, defining data 3880, storing data 3882, isolating data 3884, detecting data 3886, adapting data 3888, generating data 3890, and performing data 3892.

In certain embodiments, the receiving component 3871 is configured to receive SOI data associated with an SOI to generate an SM output; receive the SOI production data from a production SOI to generate an AD model output; and receive at least one of the SM output, the SOI production data, a hypothesized future input, or the AD model output to generate an estimated future output.

In certain embodiments, the determining component 3873 is configured to determine, an RUL prediction of the production SOI based on the estimated future output.

Note that FIG. 38 is just one example of a processing system consistent with aspects described herein, and other processing systems having additional, alternative, or fewer components are possible consistent with this disclosure.

### An Example for Robust RUL Prediction Using Jacobian Feature Regression-Based Model Adaptation

This section incorporates additional details of one example experiment utilizing JFR-based model adaptation, from the article entitled “Robust Remaining Useful Life Prediction Using Jacobian Feature Regression-Based Model Adaptation” by Prasham Sheth and Indranil Roychoudhury, incorporated herein by reference in its entirety, to demonstrate JFR-based model adaptation.

The example includes a digital synthetic oilfield testbed (testbed) that mimics real-life oilfields. The testbed has three DC motor pumps attached to three flowmeters. Each DC motor pump pumps water (used in place of oil) from the well to an eventual storage. The flowmeters measure the flow exiting the pumps. A fourth flowmeter is attached to calculate the aggregated flow from the three pumps. Single and persistent faults are injected into each of the pumps to represent the loss of efficiency. An EOL condition for each pump is defined as the state when any pump's output flow dips below 0.15 units. The controllable input in the case of each pump is the pump speed, and the output measurement from the flowmeter would be the flowrate. Since the input voltage determines the pump speed, the voltage is considered the equivalent input variable for each of the pumps. Based on the internal structure of each pump, a state-space model is designed for the testbed, considering the rotational speed and electric current as the state variables. After defining the established conditions to represent the system parameters, this state-space model for the testbed is used to simulate the operation of the three pumps in the oilfield. An SOI as described above may be made up of a combination of the three pumps. Alternatively, in some aspects, a pump may correspond to an SOI.

Equations (7.1-7.6) summarize the representation of this digital synthetic oilfield testbed:

$$d {ω}_{1} / {d}_{t} = 1 / L 1 ( {V}_{1} - {R}_{1} {i}_{1} - {k}_{1} {ω}_{1} ) \qquad Eq . 7.1$$

$${di}_{1} / {d}_{t} = 1 / {J}_{1} ( {k}_{1} {i}_{1} - {B}_{1} {ω}_{1} ) \qquad Eq . 7.2$$

$$d {ω}_{2} / {d}_{t} = 1 / {L}_{2} ( {V}_{2} - {R}_{2} {i}_{2} - {k}_{2} {ω}_{2} ) \qquad Eq . 7.3$$

$${di}_{2} / {d}_{t} = 1 / {J}_{2} ( {k}_{2} {i}_{2} - {B}_{2} {ω}_{2} ) \qquad Eq . 7.4$$

$$d {ω}_{3} / {d}_{t} = 1 / {L}_{3} ( {V}_{3} - {R}_{3} {i}_{3} - {k}_{3} {ω}_{3} ) \qquad Eq . 7.5$$

$${di}_{3} / {d}_{t} = 1 / {J}_{3} ( {k}_{3} {i}_{3} - {B}_{3} {ω}_{3} ) \qquad Eq . 7.6$$

Vₚ for pump p∈[1, 2, 3] represents the voltage and hence the controlled pump speed for each pump respectively (controllable inputs); (yₚ=ωₚ, p∈[1, 2, 3]) represents the flow rate of each pump respectively (system measurements); and the hidden state variables include (Wₚ, p ∈[1, 2, 3]) that represents the angular momentum of each pump respectively, (iₚ, p∈[1, 2, 3]) that represents the current drawn for each pump respectively. The inductance L p, resistance Rₚ, and back electromotive force constant kₚ for pump p∈[1, 2, 3] are the system parameters.

There are multiple ways to model such systems, e.g., FIGS. 4-9. Neural statespace formulation is one such approach that could be used to model the system. This approach uses a couple of neural networks (NNs) to model state-transition and state-observation models. The neural statespace formulation may correspond to the models in FIG. 5. The neural statespace formulation could be represented using equations 8.1 and 8.2 below (that may correspond with equations 1.0 and 1.1 above) where the function f represents the state-transition model and function g represents the state-observation model. In this neural state space formulation, once the model is trained, a forward Euler method is used to walk forward and make a closed-loop prediction for the next steps. AIso note we are denoting the controllable inputs to the system by x, the hidden state variables by h, and the observed system measurements by y. The subscript t represents the time step to which these values correspond.

$${h}_{t} = f ( {x}_{t - 1} , {h}_{t - 1} ) \qquad Eq . 8.1$$

$${y}_{t} = g ( {x}_{t} , {h}_{t} ) \qquad Eq . 8.2$$

The described example includes three pumps as the SOI's core components. Each of these three pumps includes one controllable input and one measurement (output), and then internally, contains two state variables. Three major combinations are used for these different variables. The first being one controllable input, one measurement, and three state variables: This setting enables independent representation of each pump. The second being three controllable inputs, one measurement, and seven state variables: In this setting, each pump's measurement is modeled independently but still consider all the input and underlying state variables. This setting enables consideration of all system dynamics together and learning the dependence of each pump's output on the entire system. The third combination is three controllable inputs and three measurements. In this setting, the entire system is modeled using a single model that considers all the input variables and tries to learn the entire system by itself.

In the first two settings, since the available information for the state variables may be utilized, a neural state space approach is used to model the system. There are existing approaches that model the state-transition and state-observation function separately using two independent networks and in a joint setting where two networks are connected to each other. In this setting, these functions are represented using NN as described above, e.g., as described in relation to Application A. The measurement can be considered to be an unknown hidden state variable that needs to be estimated. In this way, the state observation model becomes a pass-through function to select the state variable representing the measurement. Hence, the state-observation function could be omitted, as represented in Equation 9.0:

$${h}_{t} ⋃ {y}_{t} = N N ( {x}_{t} , {h}_{t - 1} , {y}_{t - 1} ) \qquad Eq . 9.$$

This particular method helps condition the model in such a way that it has to produce the correct combination of the state variables as well as the measurement. By penalizing the wrong predictions, the model is regularized to adhere to the internal relations between state variables and the measurements. This could also be thought of as the state variables providing the regularization to the original model that is penalized for any sort of inconsistencies between the state variables and the measurement.

The first two settings differ in the variables used by the NN to represent the state-space formulation. Equations 10.0 and 11.0 represent the two settings, respectively:

$${h}_{t}^{i} ⋃ {y}_{t}^{i} = NN ( {x}_{t}^{i} , {h}_{t - 1}^{i} , {y}_{t - 1}^{i} ) , {}^{i} ∈ \{ 1 , 2 , 3 \} \qquad Eq . 10.$$

$${h}_{t}^{i} ⋃ {y}_{t}^{i} = NN ( {x}_{t}^{1} , {x}_{t}^{2} , {x}_{t}^{3} , {h}_{t - 1}^{1} , {h}_{t - 1}^{2} , {h}_{t - 1}^{3} , {y}_{t - 1}^{i} ) , {}^{i} ∈ \{ 1 , 2 , 3 \} \qquad Eq . 11.$$

The superscripted ⁱ represents the pump number to which different values correspond.

In the third setting, since the system is modeled as a whole, an LSTM network is used to model the system, and all the time dependence is captured through the LSTM network and can be represented as shown in Equation 12.0:

$${y}_{t}^{1} , {y}_{t}^{2} , {y}_{t}^{3} = LSTM ( {x}_{t}^{1} , {x}_{t}^{2} , {x}_{t}^{3} ) \qquad Eq . 12.$$

For all three settings, online and offline adaptation techniques are integrated to adapt the model. A threshold value could be used to predict RUL. For example, the time when the flow value for any pump goes below the threshold could be considered as the RUL for the system.

### Example Clauses

### Example Clauses from Application A

Implementation examples are described in the following numbered clauses:

Clause 1: A method, comprising: obtaining one or more hybrid modeling frameworks based on the model, each hybrid modeling framework comprising one or more hybrid models; performing triage to select a hybrid modeling framework of the one or more hybrid modeling frameworks that is applicable to the system of interest based on associated metrics and the input data; training each respective hybrid model of the one or more hybrid models of the hybrid modeling framework based on the input data to obtain one or more trained hybrid models configured to model behavior of the system of interest; and determining a rank order of the one or more trained hybrid models based on a benchmark set of data associated with the system of interest.

Clause 2: The method of Clause 1, further comprising: displaying a user interface on a display device that enables a user to input data associated with a system of interest and select a model associated with the system of interest.

Clause 3: The method of any of Clauses 1-2, further comprising: displaying the one or more trained hybrid models and corresponding rank in the user interface on the display device.

Clause 4: The method of any one of Clauses 1-3, wherein the user interface enables the user to select and run a trained hybrid model that is configured to model behavior of the system of interest.

Clause 5: The method of any one of Clauses 1-4, wherein each hybrid model of one or more hybrid models comprises a physics-based model and a data-driven model.

Clause 6: The method of any one of Clauses 1-5, wherein the obtaining of the one or more hybrid modeling frameworks based on the model comprises: obtaining an output closure framework and a state closure framework when the model selected by the user is a realized model; obtaining an output closure framework, a state closure framework, and a parameter closure framework when the model selected by the user is a functional model; obtaining an output closure framework, a state closure framework, a parameter closure framework, and a mechanistic neural ODE when the model selected by the user is a causal graph; or obtaining an output closure framework, a state closure framework, a parameter closure framework, a mechanistic neural ODE, and a mechanistic feature engineering framework when the model selected by the user is a black box.

Clause 7: The method of any one of Clauses 1-6, wherein training each respective hybrid model of the one or more hybrid models comprises at least one of: performing parameter closure learning on the respective hybrid model to obtain a parameter closure model applicable to the system of interest; performing state closure learning on the respective hybrid model to obtain a state closure model applicable to the system of interest; performing output closure learning on the respective hybrid model to obtain an output closure model applicable to the system of interest; performing mechanistic neural ODE learning on the respective hybrid model to obtain a mechanistic neural ODE model applicable to the system of interest; and performing black-box neural ODE learning on the respective hybrid model to obtain a black-box neural ODE model applicable to the system of interest, wherein the parameter closure model, the state closure model, the output closure model, and the mechanistic neural ODE model are the trained hybrid models, and wherein training is performed using a loss function with one or more penalty terms configured to enforce mechanistic rules.

Clause 8: The method of any one of Clauses 1-7, wherein the parameter closure model comprises: a state transition model configured to receive as input a state value and an exogenous value and output a latent state value; a neural network configured to update parameters of the state transition model; and an observation model configured to receive as input the state value and output an observed value.

Clause 9: The method of any one of Clauses 1-8, wherein the state closure model comprises: a state transition model configured to receive a state value and an exogenous value and output a latent state value; a neural network configured to receive the state value and output a updated state value; and an observation model configured to receive the updated state value and output an observed value.

Clause 10: The method of any one of Clauses 1-9, wherein the state closure model comprises: a state transition model configured to receive a state value and an exogenous value and output an intermediate state value; a neural network configured to receive the intermediate state value and the exogenous value and output a parameter; a corrective model configured to receive the state value and the parameter and output a latent state value; and an observation model configured to receive the latent state value and the exogenous value and output an observed value.

Clause 11: The method of any one of Clauses 1-10, wherein the output closure model comprises: a low-fidelity model configured to receive a state value and an exogenous value and output an intermediate observed value; a first neural network configured to receive the state value, the exogenous value, and the intermediate observed value and output a parameter; an addition model configured to receive the state value and the parameter and output a latent state value; and a second neural network configured to receives the latent state value and output an observed value.

Clause 12: The method of any one of Clauses 1-11, wherein the mechanistic neural ODE model comprises: a causal graph configured to receive a state value and an exogenous value and outputs a causal value; a set of neural networks configured to receive the causal value and output a set of latent state values; and a neural network configured to receive the exogenous value and the set of latent state values and output an observed value.

Clause 13: The method of any one of Clauses 1-12, wherein the black-box neural ODE model comprises: a first neural network configured to receive a state value and an exogenous value and output a parameter; an additional model configured to receive the parameter and the state value and output a latent state value; and a second neural network configured to receive the latent state value and the exogenous value and output an observed value.

Clause 14: The method of any one of Clauses 1-13, wherein determining the rank order of the one or more trained hybrid models for each respective trained hybrid model to the one or more trained hybrid models comprises: inputting the input data to the respective trained hybrid model; obtaining, as output from the respective trained hybrid model, observed data; and determining an error associated with a trained hybrid model based on the observed data and ground truth data associated with the system of interest; and rank ordering the one or more trained hybrid models based on associated errors.

Clause 15: One or more processing systems, comprising: one or more memories comprising computer-executable instructions; and one or more processors configured to execute the computer-executable instructions and cause the one or more processing systems to perform a method in accordance with any one of Clauses 1-14.

Clause 16: One or more processing systems, comprising means for performing a method in accordance with any one of Clauses 1-14.

Clause 17: One or more non-transitory computer-readable media comprising instructions that, when executed by one or more processors of a computing system, cause the computing system to perform the operations of any one of Clauses 1-14.

Clause 18: One or more computer program products embodied on one or more computer-readable storage media comprising code for performing a method in accordance with any one of Clauses 1-14.

### Example Clauses from Application B

Implementation examples are described in the following numbered clauses:

Clause 1: A method for generating anomaly detection models comprising: obtaining data comprising at least one input and at least one output, the at least one input and the at least one output associated with a target system; performing triage to select an anomaly detection (AD) algorithm framework (AD framework) from a set of AD frameworks, wherein the AD framework is based on the at least one input and the at least one output and wherein the AD framework comprises one or more AD training algorithms; training one or more AD models based on the one or more AD training algorithms of the AD framework; and rank ordering the one or more AD models based on at least one of a benchmark set of data associated with the target system, pre-set metrics, or user-defined values.

Clause 2: The method of Clause 1, further comprising: obtaining a selection of an AD model of the one or more AD models from a user; and executing the AD model on at least one data input associated with the target system.

Clause 3: The method of any one of Clauses 1-2, further comprising: obtaining one or more stored AD models from a knowledge base, wherein the method comprises obtaining at least one of the at least one input or the at least one output from the one or more stored AD models.

Clause 4: The method of any one of Clauses 1-3, wherein performing the triage comprises: classifying one or more subsets of the data as a data type of data types, wherein the data types comprise an input type, an output type, a label type, or a predicted output type, wherein the one or more subsets comprise the at least one input and the at least one output, wherein the at least one input is classified as the input type, and the at least one output is classified as the output type; selecting the AD framework based on the data types the one or more subsets are classified into; and selecting the one or more AD algorithms associated with the AD framework to train the one or more AD models according to the one or more AD algorithms, wherein the one or more AD algorithms utilize non-residual based unsupervised learning, non-residual based supervised learning, residual based unsupervised learning, or residual based supervised learning.

Clause 5: The method of Clause 4, wherein the one or more subsets further comprise at least one label, wherein the at least one label is classified as the label type.

Clause 6: The method of Clause 4, wherein the one or more subsets further comprise at least one predicted output, wherein the at least one predicted output is classified as the predicted output type.

Clause 7: The method of Clause 4, wherein the AD framework is associated with one of: the input type and the output type and with the one or more AD algorithms that utilize the non-residual based unsupervised learning; the input type, the output type, and the label type and with the one or more AD algorithms that utilize the non-residual based supervised learning; the input type, the output type, and the predicted output type, and with the one or more AD algorithms that utilize the residual based unsupervised learning; or the input type, the output type, the label type, the predicted output type, and with the one or more AD algorithms that utilize the residual based supervised learning.

Clause 8: The method of any one of Clauses 1-7, wherein: the one or more AD training algorithms are configured to utilize non-residual based unsupervised learning, and the AD framework is configured to be associated with the at least one input and the at least one output.

Clause 9: The method of any one of Clauses 1-8, wherein the data further comprises one or more of at least one label or at least one predicted output.

Clause 10: The method of Clause 9, wherein the at least one predicted output is associated with a simulation model related to the target system.

Clause 11: The method of Clause 10, wherein one or more processors are further configured causing the apparatus to: determine a residual value associated with the predicted output, wherein the residual value comprises a difference between the at least one predicted output and the at least one output.

Clause 12: The method of Clause 10, wherein: the one or more AD training algorithms utilize non-residual based supervised learning, and the AD framework is configured to be associated with the at least one input and the at least one output and the at least one label.

Clause 13: The method of Clause 10, wherein: the one or more AD training algorithms utilize residual based unsupervised learning, and the AD framework is configured to be associated with the at least one input, the at least one output and the at least one predicted output.

Clause 14: The method of Clause 10, wherein: the one or more AD training algorithms utilize residual based supervised learning, and the AD framework is configured to be associated with the at least one input, the at least one output, the at least one predicted output, and the at least one label.

Clause 15: The method of any one of Clauses 1-14, wherein obtaining the data comprises obtaining the data from a user.

Clause 16: One or more processing systems, comprising: one or more memories comprising computer-executable instructions; and one or more processors configured to execute the computer-executable instructions and cause the one or more processing systems to perform a method in accordance with any one of Clauses 1-15.

Clause 17: One or more processing systems, comprising means for performing a method in accordance with any one of Clauses 1-15.

Clause 18: One or more non-transitory computer-readable media comprising instructions that, when executed by one or more processors of a computing system, cause the computing system to perform the operations of any one of Clauses 1-15.

Clause 19: One or more computer program products embodied on one or more computer-readable storage media comprising code for performing a method in accordance with any one of Clauses 1-15.

### Example Clauses from Application C

Implementation examples are described in the following numbered clauses:

Clause 1: A method, comprising initially training, via an analysis and control system, a model of a physical system, wherein the model of the physical system comprises a data-driven model or a hybrid model that comprises a combination of a physics-based definition of the physical system and data collected relating to the physical system; utilizing, via the analysis and control system, transfer learning or adaptation techniques of the model of the physical system to adapt the model of the physical system; and deploying, via the analysis and control system, the adapted model of the physical system to a deployment environment to enable prediction of one or more operational parameters of the physical system.

Clause 2: The method of Clause 1, comprising utilizing, via the analysis and control system, Jacobian Feature Regression (JFR) of the model of the physical system to adapt the model of the physical system.

Clause 3: The method of Clause 1, comprising automatically controlling, via the analysis and control system, the one or more operational parameters of the physical system based at least in part on the adapted model of the physical system.

Clause 4: The method of Clause 1, comprising utilizing, via the analysis and control system, the transfer learning or adaptation techniques on a state-space formulation of the hybrid model of the physical system to adapt the model of the physical system.

Clause 5: The method of Clause 1, wherein the model of the physical system comprises a recurrent neural network (RNN).

Clause 6: The method of Clause 1, comprising utilizing, via the analysis and control system, the transfer learning or adaptation techniques on a state-space formulation of the model of the physical system based at least in part on data detected from the physical system that changes during operations of the physical system to adapt the model of the physical system.

Clause 7: The method of Clause 6, comprising utilizing, via the analysis and control system, the transfer learning or adaptation techniques on the state-space formulation of the model of the physical system based at least in part on data detected in a controlled environment separate from the physical system to adapt the model of the physical system.

Clause 8: An analysis and control system, comprising: one or more processors configured to execute processor-executable instructions stored in memory of the analysis and control system, wherein the processor-executable instructions, when executed by the one or more processors, cause the analysis and control system to: initially train a model of a physical system, wherein the model of the physical system comprises a data-driven model or a hybrid model that comprises a combination of a physics-based definition of the physical system and data collected relating to the physical system; utilize transfer learning or adaptation techniques of the model of the physical system to adapt the model of the physical system; and deploy the adapted model of the physical system to a deployment environment to enable prediction of one or more operational parameters of the physical system.

Clause 9: The analysis and control system of Clause 8, wherein the processor-executable instructions, when executed by the one or more processors, cause the analysis and control system to utilize Jacobian Feature Regression (JFR) of the model of the physical system to adapt the model of the physical system.

Clause 10: The analysis and control system of Clause 8, wherein the processor-executable instructions, when executed by the one or more processors, cause the analysis and control system to automatically control the one or more operational parameters of the physical system based at least in part on the adapted model of the physical system.

Clause 11: The analysis and control system of Clause 8, wherein the processor-executable instructions, when executed by the one or more processors, cause the analysis and control system to utilize the transfer learning or adaptation techniques on a state-space formulation of the model of the physical system to adapt the model of the physical system.

Clause 12: The analysis and control system of Clause 8, wherein the model of the physical system comprises a recurrent neural network (RNN).

Clause 13: The analysis and control system of Clause 8, wherein the processor-executable instructions, when executed by the one or more processors, cause the analysis and control system to utilize the transfer learning or adaptation techniques on a state-space formulation of the model of the physical system based at least in part on data detected from the physical system that changes during operations of the physical system to adapt the model of the physical system.

Clause 14: The analysis and control system of Clause 13, wherein the processor-executable instructions, when executed by the one or more processors, cause the analysis and control system to utilize the transfer learning or adaptation techniques on the state-space formulation of the model of the physical system based at least in part on data detected in a controlled environment separate from the physical system to adapt the model of the physical system.

Clause 15: A non-transitory computer readable medium, comprising processor-executable instructions, which when executed by one or more processors of an analysis and control system, cause the analysis and control system to initially train a model of a physical system, wherein the model of the physical system comprises a data-driven model or a hybrid model that comprises a combination of a physics-based definition of the physical system and data collected relating to the physical system; utilize transfer learning or adaptation techniques of the model of the physical system to adapt the model of the physical system; and deploy the adapted model of the physical system to a deployment environment to enable prediction of one or more operational parameters of the physical system.

Clause 16: The non-transitory computer readable medium of Clause 15, wherein the processor-executable instructions, when executed by the one or more processors of the analysis and control system, cause the analysis and control system to utilize Jacobian Feature Regression (JFR) of the model of the physical system to adapt the model of the physical system.

Clause 17: The non-transitory computer readable medium of Clause 15, wherein the processor-executable instructions, when executed by the one or more processors of the analysis and control system, cause the analysis and control system to automatically control the one or more operational parameters of the physical system based at least in part on the adapted model of the physical system.

Clause 18: The non-transitory computer readable medium of Clause 15, wherein the processor-executable instructions, when executed by the one or more processors of the analysis and control system, cause the analysis and control system to utilize the transfer learning or adaptation techniques on a state-space formulation of the model of the physical system to adapt the model of the physical system.

Clause 19: The non-transitory computer readable medium of Clause 15, wherein the processor-executable instructions, when executed by the one or more processors of the analysis and control system, cause the analysis and control system to utilize the transfer learning or adaptation techniques on a state-space formulation of the model of the physical system based at least in part on data detected from the physical system that changes during operations of the physical system to adapt the model of the physical system.

Clause 20: The non-transitory computer readable medium of Clause 19, wherein the processor-executable instructions, when executed by the one or more processors of the analysis and control system, cause the analysis and control system to utilize the transfer learning or adaptation techniques on the state-space formulation of the model of the physical system based at least in part on data detected in a controlled environment separate from the physical system to adapt the model of the physical system.

### Example Clauses from Application D

Implementation examples are described in the following numbered clauses:

Clause 1: A method, comprising: initially training, via an analysis and control system, a model of a physical system, wherein the model of the physical system comprises a data-driven model or a hybrid model that comprises a combination of a physics-based definition of the physical system and data collected relating to the physical system; detecting, via the analysis and control system, deviations of one or more outputs of the model of the physical system relative to data collected by one or more sensors associated with the physical system during operation of the physical system; determining, via the analysis and control system, that degradation in an ability of the model of the physical system to estimate performance of the physical system has occurred based at least in part on the detected deviations; utilizing, via the analysis and control system, transfer learning or adaptation techniques of the model of the physical system to adapt the model of the physical system; and estimating, via the analysis and control system, a Remaining Useful Life (RUL) of the physical system based on the adapted model of the physical system.

Clause 2. The method of Clause 1, comprising utilizing, via the analysis and control system, Jacobian Feature Regression (JFR) of the model of the physical system to adapt the model of the physical system.

Clause 3. The method of Clause 1, comprising automatically controlling, via the analysis and control system, one or more operational parameters of the physical system based at least in part on the estimated RUL of the physical system.

Clause 4. The method of Clause 1, comprising determining, via the analysis and control system, that the degradation in the ability of the model of the physical system to estimate the performance of the physical system has occurred, in response to detecting that the deviations of the one or more outputs of the model of the physical system relative to the data collected by the one or more sensors associated with the physical system are greater than predetermined thresholds.

Clause 5. The method of Clause 1, comprising continuously monitoring, via the analysis and control system, the one or more sensors to automatically detect the deviations of the one or more outputs of the model of the physical system relative to the data collected by the one or more sensors associated with the physical system during operation of the physical system.

Clause 6. The method of Clause 1, comprising utilizing, via the analysis and control system, the transfer learning or adaptation techniques on a state-space formulation of the model of the physical system to adapt the model of the physical system.

Clause 7. The method of Clause 1, wherein the model of the physical system comprises a recurrent neural network (RNN).

Clause 8. An analysis and control system, comprising: one or more processors configured to execute processor-executable instructions stored in memory of the analysis and control system, wherein the processor-executable instructions, when executed by the one or more processors, cause the analysis and control system to: initially train a model of a physical system, wherein the model of the physical system comprises a data-driven model or a hybrid model that comprises a combination of a physics-based definition of the physical system and data collected relating to the physical system; detect deviations of one or more outputs of the model of the physical system relative to data collected by one or more sensors associated with the physical system during operation of the physical system; determine that degradation in an ability of the model of the physical system to estimate performance of the physical system has occurred based at least in part on the detected deviations; utilize transfer learning or adaptation techniques of the model of the physical system to adapt the model of the physical system; and estimate a Remaining Useful Life (RUL) of the physical system based on the adapted model of the physical system.

Clause 9. The analysis and control system of Clause 8, wherein the processor-executable instructions, when executed by the one or more processors, cause the analysis and control system to utilize Jacobian Feature Regression (JFR) of the model of the physical system to adapt the model of the physical system.

Clause 10. The analysis and control system of Clause 8, wherein the processor-executable instructions, when executed by the one or more processors, cause the analysis and control system to automatically control one or more operational parameters of the physical system based at least in part on the estimated RUL of the physical system.

Clause 11. The analysis and control system of Clause 8, wherein the processor-executable instructions, when executed by the one or more processors, cause the analysis and control system to determine that the degradation in the ability of the model of the physical system to estimate the performance of the physical system has occurred, in response to detecting that the deviations of the one or more outputs of the model of the physical system relative to the data collected by the one or more sensors associated with the physical system are greater than predetermined thresholds.

Clause 12. The analysis and control system of Clause 8, wherein the processor-executable instructions, when executed by the one or more processors, cause the analysis and control system to continuously monitor the one or more sensors to automatically detect the deviations of the one or more outputs of the model of the physical system relative to the data collected by the one or more sensors associated with the physical system during operation of the physical system.

Clause 13. The analysis and control system of Clause 8, wherein the processor-executable instructions, when executed by the one or more processors, cause the analysis and control system to utilize the transfer learning or adaptation techniques on a state-space formulation of the model of the physical system to adapt the model of the physical system.

Clause 14. The analysis and control system of Clause 8, wherein the model of the physical system comprises a recurrent neural network (RNN).

Clause 15. A non-transitory computer readable medium, comprising: processor-executable instructions, which when executed by one or more processors of an analysis and control system, cause the analysis and control system to: initially train a model of a physical system, wherein the model of the physical system comprises a data-driven model or a hybrid model that comprises a combination of a physics-based definition of the physical system and data collected relating to the physical system; detect deviations of one or more outputs of the model of the physical system relative to data collected by one or more sensors associated with the physical system during operation of the physical system; determine that degradation in an ability of the model of the physical system to estimate performance of the physical system has occurred based at least in part on the detected deviations; utilize transfer learning or adaptation techniques of the model of the physical system to adapt the model of the physical system; and estimate a Remaining Useful Life (RUL) of the physical system based on the adapted model of the physical system.

Clause 16. The non-transitory computer readable medium of Clause 15, wherein the processor-executable instructions, when executed by the one or more processors of the analysis and control system, cause the analysis and control system to utilize Jacobian Feature Regression (JFR) of the model of the physical system to adapt the model of the physical system.

Clause 17. The non-transitory computer readable medium of Clause 15, wherein the processor-executable instructions, when executed by the one or more processors of the analysis and control system, cause the analysis and control system to automatically control one or more operational parameters of the physical system based at least in part on the estimated RUL of the physical system.

Clause 18. The non-transitory computer readable medium of Clause 15, wherein the processor-executable instructions, when executed by the one or more processors of the analysis and control system, cause the analysis and control system to determine that the degradation in the ability of the model of the physical system to estimate the performance of the physical system has occurred, in response to detecting that the deviations of the one or more outputs of the model of the physical system relative to the data collected by the one or more sensors associated with the physical system are greater than predetermined thresholds.

Clause 19. The non-transitory computer readable medium of Clause 15, wherein the processor-executable instructions, when executed by the one or more processors of the analysis and control system, cause the analysis and control system to continuously monitor the one or more sensors to automatically detect the deviations of the one or more outputs of the model of the physical system relative to the data collected by the one or more sensors associated with the physical system during operation of the physical system.

Clause 20. The non-transitory computer readable medium of Clause 15, wherein the processor-executable instructions, when executed by the one or more processors of the analysis and control system, cause the analysis and control system to utilize the transfer learning or adaptation techniques on a state-space formulation of the model of the physical system to adapt the model of the physical system.

### Example Clauses from Application E

Implementation examples are described in the following numbered clauses:

Clause 1. A method, comprising: receiving, via an analysis and control system, data relating to operation of equipment from one or more sensors associated with the equipment; predicting, via the analysis and control system, a remaining useful life (RUL) of the equipment based at least in part on the received data; and evaluating, via the analysis and control system, an accuracy of the predicted RUL of the equipment during operation of the equipment.

Clause 2. The method of Clause 1, comprising evaluating, via the analysis and control system, the accuracy of the predicted RUL of the equipment using measurement-based predictive health monitoring (PHM) evaluation algorithms.

Clause 3. The method of Clause 2, comprising evaluating, via the analysis and control system, the accuracy of the predicted RUL of the equipment by analyzing data points in a look-back window measured from a time of evaluation.

Clause 4. The method of Clause 3, comprising evaluating, via the analysis and control system, the accuracy of the predicted RUL of the equipment by applying a weighting scheme to the data points in the look-back window measured from the time of evaluation, wherein the weighting scheme is selected by an operator of the equipment.

Clause 5. The method of Clause 1, comprising evaluating, via the analysis and control system, the accuracy of the predicted RUL of the equipment using RUL-based predictive health monitoring (PHM) evaluation algorithms.

Clause 6. The method of Clause 5, comprising evaluating, via the analysis and control system, the accuracy of the predicted RUL of the equipment by analyzing data points in a look-back window measured from a time of evaluation.

Clause 7. The method of Clause 6, comprising evaluating, via the analysis and control system, the accuracy of the predicted RUL of the equipment by applying a weighting scheme to the data points in the look-back window measured from the time of evaluation, wherein the weighting scheme is selected by an operator of the equipment.

Clause 8. The method of Clause 1, comprising predicting, via the analysis and control system, the RUL of the equipment based at least in part on a model of the equipment.

Clause 9. The method of Clause 8, comprising: calculating, via the analysis and control system, a service level indicator relating to the accuracy of the predicted RUL of the equipment; and adjusting, via the analysis and control system, the model of the equipment in response to determining that the service level indicator is below a predetermined threshold.

Clause 10. The method of Clause 1, comprising automatically controlling, via the analysis and control system, one or more operational parameters of the equipment based at least in part on the predicted RUL of the equipment.

Clause 11. An analysis and control system, comprising: one or more processors configured to execute processor-executable instructions stored in memory of the analysis and control system, wherein the processor-executable instructions, when executed by the one or more processors, cause the analysis and control system to: receive data relating to operation of equipment from one or more sensors associated with the equipment; predict a remaining useful life (RUL) of the equipment based at least in part on the received data; and evaluate an accuracy of the predicted RUL of the equipment during operation of the equipment.

Clause 12. The analysis and control system of Clause 11, wherein the processor-executable instructions, when executed by the one or more processors, cause the analysis and control system to evaluate the accuracy of the predicted RUL of the equipment using measurement-based predictive health monitoring (PHM) evaluation algorithms.

Clause 13. The analysis and control system of Clause 12, wherein the processor-executable instructions, when executed by the one or more processors, cause the analysis and control system to evaluate the accuracy of the predicted RUL of the equipment by analyzing data points in a look-back window measured from a time of evaluation.

Clause 14. The analysis and control system of Clause 13, wherein the processor-executable instructions, when executed by the one or more processors, cause the analysis and control system to evaluate the accuracy of the predicted RUL of the equipment by applying a weighting scheme to the data points in the look-back window measured from the time of evaluation, wherein the weighting scheme is selected by an operator of the equipment.

Clause 15. The analysis and control system of Clause 11, wherein the processor-executable instructions, when executed by the one or more processors, cause the analysis and control system to evaluate the accuracy of the predicted RUL of the equipment using RUL-based predictive health monitoring (PHM) evaluation algorithms.

Clause 16. The analysis and control system of Clause 15, wherein the processor-executable instructions, when executed by the one or more processors, cause the analysis and control system to evaluate the accuracy of the predicted RUL of the equipment by analyzing data points in a look-back window measured from a time of evaluation.

Clause 17. The analysis and control system of Clause 16, wherein the processor-executable instructions, when executed by the one or more processors, cause the analysis and control system to evaluate the accuracy of the predicted RUL of the equipment by applying a weighting scheme to the data points in the look-back window measured from the time of evaluation, wherein the weighting scheme is selected by an operator of the equipment.

Clause 18. The analysis and control system of Clause 11, wherein the processor-executable instructions, when executed by the one or more processors, cause the analysis and control system to predict the RUL of the equipment based at least in part on a model of the equipment.

Clause 19. The analysis and control system of Clause 18, wherein the processor-executable instructions, when executed by the one or more processors, cause the analysis and control system to: calculate a service level indicator relating to the accuracy of the predicted RUL of the equipment; and adjust the model of the equipment in response to determining that the service level indicator is below a predetermined threshold.

Clause 20. A non-transitory computer readable medium, comprising: processor-executable instructions, which when executed by one or more processors of an analysis and control system, cause the analysis and control system to: receive data relating to operation of equipment from one or more sensors associated with the equipment; predict a remaining useful life (RUL) of the equipment based at least in part on the received data; and evaluate an accuracy of the predicted RUL of the equipment during operation of the equipment.

### Example Clauses from Present Application

Implementation examples are described in the following numbered clauses:

Clause 1: A method for PHM comprising: receiving system of interest (SOI) data associated with an SOI to generate a simulation model (SM) output; receiving the SOI production data from a production SOI to generate an AD model output; receiving at least one of the SM output, the SOI production data, a hypothesized future input, or the AD model output to generate an estimated future output; and determining, an RUL prediction of the production SOI based on the estimated future output.

Clause 2: The method of Clause 1 further comprising: evaluating a performance of the RUL prediction.

Clause 3: A method for automatic prognostics and health management (PHM), the method comprising: receiving by an SM associated with a system of interest (SOI), SOI data associated with the SOI to generate an simulation model output; receiving by an anomaly detection (AD) model, SOI production data from a production SOI to generate an AD model output; receiving by an adapted simulation (AS) model, at least one of the simulation model output, the SOI production data from the production SOI, a hypothesized future input, or the AD model output from the AD model to generate an estimated future output; and determining, by an RUL model, an RUL prediction of the production SOI based on the estimated future output.

Clause 4: The method of Clause 3, further comprising automatically controlling one or more operational parameters of the production SOI based at least in part on the RUL prediction.

Clause 5: The method of any of Clauses 3-4, further comprising evaluating a performance of the RUL model, by a PHM evaluation algorithm.

Clause 6: The method of any of Clauses 3-5, wherein the evaluating comprises: defining at least one look-back window by the PHM evaluation algorithm, wherein: the look-back window comprises look-back data points comprising at least one of past SOI production data or past RUL predictions, and the at least one look-back window is a past time period measured from a time of evaluation; and determining at least one evaluation metric using the look-back data points in the at least one look-back window by at least one of a measurement-based PHM evaluation, an RUL-based PHM evaluation, or an SLI.

Clause 7: The method of any of Clauses 3-6, wherein the measurement-based PHM evaluation determines acceptable measurement error bounding values relative to values of the past SOI production data, the RUL-based PHM evaluation determines accuracy of the past RUL predictions relative to current SOI production data, and wherein the SLI provides a summary of performance metrics of the RUL model based on at least one of the measurement-based PHM evaluation or the RUL-based PHM evaluation.

Clause 8: The method of any of Clauses 3-7, wherein the time of evaluation is a present time.

Clause 9: The method of any of Clauses 3-8, further comprising: receiving current sensor data from the production SOI; and storing the current sensor data of the production SOI in a data repository.

Clause 10: The method of any of Clauses 3-9, further comprising generating, by the AD model, the AD model output based on at least one of the SOI production data or an A S model output.

Clause 11: The method of any of Clauses 3-10, further comprising: generating, by the AS model, the estimated future output based on the hypothesized future input; and receiving, by the RUL model, the estimated future output from the AS model for the determining of the RUL prediction.

Clause 12: The method of any of Clauses 3-11, wherein the SOI production data comprises at least one of an SOI production data input or an SOI production data output.

Clause 13: The method of any of Clauses 3-12, wherein at least one of the simulation model, the AD model, the A S model, or the RUL model comprises a hybrid model, and the hybrid model comprises a combination of a data-driven model and a system model.

Clause 14: The method of any of Clauses 3-13, wherein the simulation model is based on trained weights associated with at least one stored model.

Clause 15: The method of any of Clauses 3-14, further comprising: receiving, by the AD model, the A S model output; and generating the AD model output, based on at least one of the A S model output or the SOI production data, wherein the AD model output comprises at least one of one or more anomaly classifications or one or more fault isolations.

Clause 16: The method of any of Clauses 3-15, further comprising adapting the AS model based on the AD model output by performing an online model adaptation technique.

Clause 17: The method of any of Clauses 3-16, wherein the adapting comprises performing a Jacobian feature regression technique.

Clause 18: The method of any of Clauses 3-17, further comprising: generating the simulation model based on the SOI data; generating the AD model based on the SOI data; and generating the A S model based on at least one of the simulation model output, the SOI production data, or the AD model output.

Clause 19: The method of any of Clauses 3-18, wherein the estimated future output comprises a prediction of an SOI production data output.

Clause 20: One or more processing systems, comprising: one or more memories comprising computer-executable instructions; and one or more processors configured to execute the computer-executable instructions and cause the one or more processing systems to perform a method in accordance with any one of Clauses 1-19.

Clause 21: One or more processing systems, comprising means for performing a method in accordance with any one of Clauses 1-19.

Clause 22: One or more non-transitory computer-readable media comprising instructions that, when executed by one or more processors of a computing system, cause the computing system to perform the operations of any one of Clauses 1-19.

Clause 23: One or more computer program products embodied on one or more computer-readable storage media comprising code for performing a method in accordance with any one of Clauses 1-19.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. AIso, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, unless stated otherwise, the term “or” is used in an inclusive sense. This inclusive usage of or is equivalent to “and/or”. Thus, when options are delineated using “or,” it permits the selection of one or more of the enumerated options concurrently. For example, if the document stipulates that a component may comprise option A or option B, it shall be understood to mean that the component may comprise option A, option B, or both option A and option B, and does not mean, unless stated expressly that the component includes either option A or option B. This inclusive interpretation ensures that all potential combinations of the options are permissible, rather than restricting the choice to a singular, exclusive option.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for end-to-end prognostics and health management (PHM), the method comprising:
receiving by a simulation model (SM) associated with a system of interest (SOI), SOI data associated with the SOI to generate an SM output;
receiving by an anomaly detection (AD) model, SOI production data from a production SOI to generate an AD model output;
receiving by an adapted simulation (AS) model, at least one of the SM output, the SOI production data from the production SOI, a hypothesized future input, or the AD model output from the AD model to generate an estimated future output; and
determining, by a remaining useful life (RUL) model, an RUL prediction of the production SOI based on the estimated future output.

2. The method of claim 1, further comprising automatically controlling one or more operational parameters of the production SOI based at least in part on the RUL prediction.

3. The method of claim 1, further comprising evaluating a performance of the RUL model, by a PHM evaluation algorithm.

4. The method of claim 3, wherein the evaluating comprises:
defining at least one look-back window by the PHM evaluation algorithm, wherein:
the look-back window comprises look-back data points comprising at least one of past SOI production data or past RUL predictions, and
the at least one look-back window is a past time period measured from a time of evaluation; and
determining at least one evaluation metric using the look-back data points in the at least one look-back window by at least one of a measurement-based PHM evaluation, an RUL-based PHM evaluation, or a service-level indicator (SLI).

5. The method of claim 4, wherein:
the measurement-based PHM evaluation determines acceptable measurement error bounding values relative to values of the past SOI production data,
the RUL-based PHM evaluation determines accuracy of the past RUL predictions relative to current SOI production data, and
wherein the SLI provides a summary of performance metrics of the RUL model based on at least one of the measurement-based PHM evaluation or the RUL-based PHM evaluation.

6. The method of claim 4, wherein the time of evaluation is a present time.

7. The method of claim 1, further comprising:
receiving current sensor data from the production 501; and
storing the current sensor data of the production SOI in a data repository.

8. The method of claim 1, further comprising generating, by the AD model, the AD model output based on at least one of the SOI production data or an A S model output.

9. The method of claim 1, further comprising:
generating, by the A S model, the estimated future output based on the hypothesized future input; and
receiving, by the RUL model, the estimated future output from the AS model for the determining of the RUL prediction.

10. The method of claim 1, wherein the SOI production data comprises at least one of a SOI production data input or a SOI production data output.

11. The method of claim 1, wherein:
at least one of the SM, the AD model, the A S model, or the RUL model comprises a hybrid model, and
the hybrid model comprises a combination of a data-driven model and a system model.

12. The method of claim 1, wherein the SM is based on trained weights associated with at least one stored model.

13. The method of claim 1, further comprising:
receiving, by the AD model, the AS model output; and
generating the AD model output, based on at least one of the AS model output or the SOI production data, wherein the AD model output comprises at least one of one or more anomaly classifications or one or more fault isolations.

14. The method of claim 13, further comprising adapting the A S model based on the AD model output by performing an online model adaptation technique.

15. The method of claim 14, wherein the adapting comprises performing a Jacobian feature regression technique.

16. The method of claim 1, further comprising:
generating the SM based on the SOI data;
generating the AD model based on the SOI data; and
generating the AS model based on at least one of the SM output, the SOI production data, or the AD model output.

17. The method of claim 1, wherein the estimated future output comprises a prediction of a SOI production data output.

18. A processing system, comprising:
a memory comprising computer-executable instructions; and
a processor configured to execute the computer-executable instructions and cause the processing system to:
receive system of interest (SOI) data associated with an SOI to generate a simulation model (SM) output;
receive SOI production data from a production SOI to generate an AD model output;
receive at least one of the SM output, the SOI production data, a hypothesized future input, or the AD model output to generate an estimated future output; and
determine, an RUL prediction of the production SOI based on the estimated future output.

19. The processing system of claim 18, wherein the processor is further configured to cause the processing system to evaluate a performance of the RUL prediction.

20. A non-transitory computer-readable medium comprising instructions that, when executed by one or more processors of a computing system, cause the computing system to perform operations for end-to-end prognostics and health management, the operations comprising:
receiving by a simulation model (SM) associated with a system of interest (SOI), SOI data associated with the SOI to generate an SM output;
receiving by an anomaly detection (AD) model, SOI production data from a production SOI to generate an AD model output;
receiving by an adapted simulation (AS) model, at least one of the SM output, the SOI production data from the production SOI, a hypothesized future input, or the AD model output from the AD model to generate an estimated future output; and
determining, by a remaining useful life (RUL) model, an RUL prediction of the production SOI based on the estimated future output.
